(19) United States
(12) Patent Application Publication
(10) Pub. No.: US 2016/0117076 A1
(43) Pub. Date: Apr. 28, 2016

(54) MOBILE TERMINAL AND CONTROL METHOD THEREOF

(71) Applicant: LG ELECTRONICS INC., Seoul (KR)

(72) Inventors: Changmok KIM, Seoul (KR); Sangwoon LEE, Seoul (KR); Eunjin KIM, Seoul (KR); Wook SHIN, Seoul (KR); Janghwan JEON, Seoul (KR); Younhwa CHOI, Seoul (KR); Minkyoung CHANG, Seoul (KR); Jungmin PARK, Seoul (KR); Jinhae CHOI, Seoul (KR)

(73) Assignee: LG ELECTRONICS INC., Seoul (KR)

(21) Appl. No.: 14/918,385

(22) Filed: Oct. 20, 2015

(30) Foreign Application Priority Data
Oct. 22, 2014 (KR) 10-2014-0143252
Dec. 30, 2014 (KR) 10-2014-0193394

(51) Int. Cl. G06F 3/0488; H04W 76/06; H04N 5/225; G06F 3/0486; G06F 3/0482; G06F 3/0484

(52) U.S. Cl. CPC G06F 3/0488; G06F 3/0482; G06F 3/04842; H04N 5/225; G06F 3/0486; H04W 76/06

(57) ABSTRACT

A mobile terminal includes a display unit, a wireless communication unit, and a controller. The controller displays a my device object corresponding to the mobile terminal, at least one first external device object corresponding to at least one first external device connected to the mobile terminal with wireless communication through the wireless communication unit, and at least one connectable second external device object in correspondence to at least one second external device connectable to the mobile terminal with wireless communication through the wireless communication unit. The controller displays a line indicating that wireless communication is connected between the my device object and the first external device object when the mobile terminal and the first external device are connected to each other through wireless communication.

### CROSS-REFERENCE TO RELATED APPLICATIONS

Pursuant to 35 U.S.C. §119(a), this application claims the benefit of earlier filing date and right of priority to Korean Patent Application Nos. 10-2014-0143252, filed on Oct. 22, 2014 and 10-2014-0193394, filed on Dec. 30, 2014, the contents of which are all hereby incorporated by reference herein in their entirety.

### BACKGROUND

The present disclosure relates to a mobile terminal capable of implementing terminal usage by further considering a user's convenience.

Depending on whether terminals are movable, the terminals are divided into mobile/portable terminals and stationary terminals. Again, the mobile terminals may be divided into handheld terminals and vehicle mounted terminals depending on whether users can carry the mobile terminals personally.

Functions of the mobile terminals become diversified. For example, the functions include data and voice communication, picture capturing and video recording through a camera, voice recording, music file playback through a speaker system, and image or video output to a display unit. Some terminals may have an additional electronic game play function or a multimedia player function. Especially, recent mobile terminals may receive multicast signals for providing visual contents such as broadcasts and video or television programs.

As functions of a terminal are diversified, such a terminal may be implemented in a form of a multimedia player with multi-functions, for example, photo or video capturing, playback of music or video files, game plays, and broadcast reception.

In order to support and increase functions of such a terminal, it is considered to improve structural part and/or software part of a terminal.

On the other hand, a mobile terminal may be connected to various external terminals through various communication methods. For example, a mobile terminal may transmit/receive pictures or music files as connected to another mobile terminal through Bluetooth and may perform various tasks as connected to a notebook through WiFi.

However, when a mobile terminal controls an external terminal connected thereto, since its access path and management method are different according to the external terminal, it is impossible to easily set a connection with a desired external terminal or control a connected external terminal. Accordingly, regardless of a communication technique for connecting an external terminal or the type of an external terminal, it is necessary to provide an environment in which a mobile terminal connects and manages an external terminal integrally.

Additionally, in order to share content in a first terminal with a second terminal, a short range communication method may be used or a long range communication method such as cloud service may be used. However, in order for a user to allow a second terminal to receive content of a first terminal, a procedure for short range communication connection may be set by manipulating a menu each time or the download URL address of the content uploaded in a cloud server may be obtained.

### SUMMARY

Embodiments provide a mobile terminal configured to be easily connected to a plurality of external terminals through a wireless communication method.

Embodiments also provide a mobile terminal configured to easily check or control a state of a plurality of external terminals connected to the mobile terminal through a wireless communication method.

Embodiments also provide a mobile terminal configured to connect one external terminal and another external terminal by using the mobile terminal through a wireless communication method.

Embodiments also provide a mobile terminal configured to easily set a function of the mobile terminal and an external terminal in order to allow one function of the mobile terminal to be executed in the external terminal.

Embodiments also provide a mobile terminal configured to perform a control to receive content when at least one external terminal for sharing the content is around as the external terminal switches into a short range communication mode and perform a control to download the content when the external terminal is not around as the external terminal switches to a long range communication mode such as cloud service.

In one embodiment, a mobile terminal includes a display unit, a wireless communication unit, and a controller.

The controller may display a my device object corresponding to the mobile terminal, at least one first external device object corresponding to at least one first external device, and at least one connectable second external device object corresponding to at least one second external device, the at least one first external device connected to the mobile terminal through the wireless communication unit and the at least one second external device connectable to the mobile terminal through the wireless communication unit. The controller may display a line indicating that wireless communication is connected between the my device object and the first external device object when the mobile terminal and the first external device are connected to each other through wireless communication. The controller may perform a control to allow a line connected between the my device object and the first external device object to be drawn and cut off and then disappear when a drag touch is input in a specific direction and perform a control to disconnect wireless communication between the mobile terminal and the external device.

The details of one or more embodiments are set forth in the accompanying drawings and the description below. Other features will be apparent from the description and drawings, and from the claims.

### BRIEF DESCRIPTION OF THE DRAWINGS

FIG. 1 is a block diagram illustrating a mobile terminal according to an embodiment of the present invention.

FIG. 2 is a view illustrating a mobile terminal and a control method thereof according to an embodiment of the present invention.

FIGS. 3, 4, 5, 6 and 7 are views illustrating a method of entering a control center in a mobile terminal.

FIGS. 8 and 9 are views illustrating a control center in a mobile terminal and a control method thereof according to an embodiment of the present invention.

FIG. 10 is a view illustrating a my device area in a mobile terminal and a control method thereof according to an embodiment of the present invention.

FIGS. 11, 12 and 13 are views illustrating an integrated device area in a mobile terminal and a control method thereof according to an embodiment of the present invention.

FIGS. 14, 15, 16, 17, 18 and 19 are views illustrating an external terminal area in a mobile terminal and a control method thereof according to an embodiment of the present invention.

FIGS. 20, 21 and 22 are views illustrating the execution of a control center in a mobile terminal and a control method thereof according to an embodiment of the present invention.

FIGS. 23 and 24 are views illustrating the execution of a control center in a mobile terminal and a control method thereof according to another embodiment of the present invention.

FIGS. 25 and 26 are views illustrating the execution of a control center in a mobile terminal and a control method thereof according to another embodiment of the present invention.

FIGS. 27, 28 and 29 are views illustrating the execution of a control center in a mobile terminal and a control method thereof according to another embodiment of the present invention.

FIGS. 30, 31, 32, 33 and 34 are views of connecting an external terminal and a mobile terminal through a WiFi communication method in a mobile terminal and a control method thereof according to an embodiment of the present invention.

FIG. 35 is a view illustrating a control center in a mobile terminal and a control method thereof according to an embodiment of the present invention.

FIGS. 36, 37 and 38 are views illustrating searching external terminals through a control center in a mobile terminal and a control method thereof according to an embodiment of the present invention.

FIGS. 39, 40 and 41 are views illustrating a plurality of objects in a mobile terminal and a control method thereof according to an embodiment of the present invention.

FIG. 42 is a view when a plurality of objects are displayed on a control center in a mobile terminal and a control method thereof according to an embodiment of the present invention.

FIGS. 43, 44 and 45 are views of connecting a my device object with a connectable external terminal object through wireless communication in a mobile terminal and a control method thereof according to an embodiment of the present invention.

FIGS. 46 and 47 are views illustrating performing a control to connect external terminal objects each other through wireless communication in a mobile terminal and a control method thereof according to an embodiment of the present invention.

FIGS. 48, 49 and 50 are views of disconnecting a connection through wireless communication between a my device object and an external terminal object in a mobile terminal and a control method thereof according to an embodiment of the present invention.

FIGS. 51 and 52 are views of transferring some functions of a mobile terminal that is my device to an external terminal in a mobile terminal and a control method thereof according to an embodiment of the present invention.

FIGS. 53 and 54 are views illustrating pinch-in touch input and pinch-out touch input through a control center in a mobile terminal and a control method thereof according to an embodiment of the present invention.

FIGS. 55 and 56 are views illustrating pinch-in touch input and pinch-out touch input through a control center in a mobile terminal and a control method thereof according to another embodiment of the present invention.

FIG. 57 is a flowchart illustrating a control process of a mobile terminal according to an embodiment of the present invention.

FIGS. 58, 59, 60, 61, 62, 63, 64, 65, 66, 67, 68, 69, 70, 71, 72, 73 and 74 are views illustrating a control process of a mobile terminal according to an embodiment of the present invention.

### DETAILED DESCRIPTION OF THE EMBODIMENTS

Hereinafter, embodiments of the present invention are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and, do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present invention is not limited thereto. It should be understood that all of variations, equivalents or substitutes contained in the concept and technical scope of the present invention are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

The terms of a singular form may include plural forms unless they have a clearly different meaning in the context.

Additionally, in this specification, the meaning of “include,” “comprise,” “including,” or “comprising,” specifies a property, a region, a fixed number, a step, a process, an element and/or a component but does not exclude other properties, regions, fixed numbers, steps, processes, elements and/or components.

Mobile terminals described in this specification may include mobile phones, smartphones, laptop computers, terminals for digital broadcast, personal digital assistants (PDAs), portable multimedia players (PMPs), navigation systems, slate PCs, tablet PCs, ultrabooks, and wearable devices (for example, smartwatchs, smart glasses, and head mounted displays (HMDs)).

However, it is apparent to those skilled in the art that configurations according to embodiments of the present invention disclosed in this specification are applicable to stationary terminals such as digital TVs, desktop computers, and digital signage, except for the case applicable to only mobile terminals.

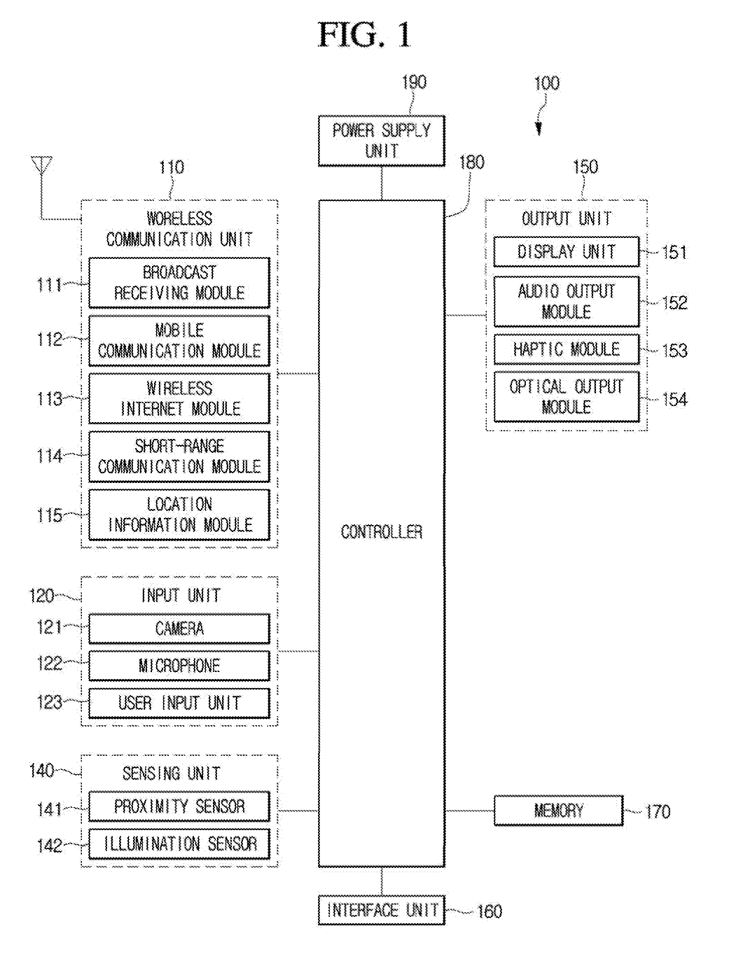

FIG. 1 is a block diagram illustrating a mobile terminal according to an embodiment of the present invention.

Referring to FIG. 1, the mobile terminal 100 may include a wireless communication unit 110, an input unit 120, a sensing unit 140, an output unit 150, an interface unit 160, a memory 170, a controller 180, and a power supply unit 190. In implementing a mobile terminal, components shown in FIG. 1 are not necessary, so that a mobile terminal described in this specification may include components less or more than the components listed above.

In more detail, the wireless communication unit 110 in the components may include at least one module allowing wireless communication between the mobile terminal 100 and a wireless communication system, between the mobile terminal 100 and another mobile terminal 100, or between the mobile terminal 100 and an external server. Additionally, the wireless communication unit 110 may include at least one module connecting the mobile terminal 100 to at least one network.

The wireless communication unit 110 may include at least one of a broadcast receiving module 111, a mobile communication module 112, a wireless internet module 113, a short-range communication module 114, and a location information module 115.

The input unit 120 may include a camera 121 or an image input unit for image signal input, a microphone 122 or an audio input unit for audio signal input, and a user input unit 123 (for example, a touch key and a mechanical key)) for receiving information from a user. Voice data or image data collected by the input unit 120 are analyzed and processed as a user's control command.

The sensing unit 140 may include at least one sensor for sensing at least one of information in a mobile terminal, environmental information around a mobile terminal, and user information. For example, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (for example, the camera 121), a microphone (for example, the microphone 122), a battery gauge, an environmental sensor (for example, a barometer, a hygrometer, a thermometer, a radiation sensor, a thermal sensor, and a gas sensor), and a chemical sensor (for example, an electronic noise, a healthcare sensor, and a biometric sensor). Moreover, a mobile terminal disclosed in this specification may combines information sensed by at least two or more sensors among such sensors and may then utilize it.

The output unit 150 is used to generate a visual, auditory, or haptic output and may include at least one of a display unit 151, a sound output unit 152, a haptic module 153, and an optical output unit 154. The display unit 151 may be formed with a mutual layer structure with a touch sensor or formed integrally, so that a touch screen may be implemented. Such a touch screen may serve as the user input unit 123 providing an input interface between the mobile terminal 100 and a user and an output interface between the mobile terminal 100 and a user at the same time.

The interface unit 160 may serve as a path to various kinds of external devices connected to the mobile terminal 100. The interface unit 160 may include at least one of a wired/wireless headset port, an external charger port, a wired/wireless data port, a memory card port, a port connecting a device equipped with an identification module, an audio Input/Output (I/O) port, a video I/O port, and an earphone port. In correspondence to that an external device is connected to the interface unit 160, the mobile terminal 100 may perform an appropriate control relating to the connected external device.

Additionally, the memory 170 may store data supporting various functions of the mobile terminal 100. The memory 170 may store a plurality of application programs (for example, application programs or applications) running on the mobile terminal 100 and also data and commands for operations of the mobile terminal 100. At least part of such an application program may be downloaded from an external server through a wireless communication. Additionally, at least part of such an application program may be included in the mobile terminal 100 from the time of shipment in order to perform a basic function (for example, an incoming call, a transmission function, and a message reception) of the mobile terminal 100. Moreover, an application program may be stored in the memory 170 and installed on the mobile terminal 100, so that it may run to perform an operation (or a function) of the mobile terminal 100 by the controller 180.

The controller 180 may control overall operations of the mobile terminal 100 generally besides an operation relating to the application program. The controller 180 may provide appropriate information or functions to a user or process them by processing signals, data, and information input/output through the above components or executing application programs stored in the memory 170.

Additionally, in order to execute an application program stored in the memory 170, the controller 180 may control at least part of the components shown in FIG. 1. Furthermore, in order to execute the application program, the controller 180 may combine at least two of the components in the mobile terminal 100 and may then operate it.

The power supply unit 190 may receive external power or internal power under a control of the controller 180 and may then supply power to each component in the mobile terminal 100. The power supply unit 190 includes a battery and the battery may be a built-in battery or a replaceable battery.

At least part of the each component may operate cooperatively in order to implement operations, controls, or control methods of a mobile terminal 100 according to various embodiments of the present invention described below. Additionally, the operations, controls, or control methods of a mobile terminal 100 may be implemented on the mobile terminal 100 by executing at least one application program stored in the memory 170.

Hereinafter, prior to examining various embodiments implemented through the mobile terminal 100, the above-listed components are described in more detail with reference to FIG. 1.

First, in describing the wireless communication unit 110, the broadcast receiving module 111 of the wireless communication unit 110 may receive a broadcast signal and/or broadcast related information from an external broadcast management server through a broadcast channel. The broadcast channel may include a satellite channel and a terrestrial channel. At least two broadcast receiving modules for simultaneous broadcast reception for at least two broadcast channels or broadcast channel switching may be provided to the mobile terminal 100.

The mobile communication module 112 may transmit/receive a wireless signal to/from at least one of a base station, an external terminal, and a server on a mobile communication network established according to the technical standards or communication methods for mobile communication (for example, Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), and Long Term Evolution-Advanced (LTE-A)).

The wireless signal may include various types of data according to a voice call signal, a video call signal, or text/multimedia message transmission.

The wireless internet module 113 refers to a module for wireless internet access and may be built in or external to the mobile terminal 100. The wireless internet module 113 may be configured to transmit/receive a wireless signal in a communication network according to wireless internet technologies.

The wireless internet technology may include Wireless LAN (WLAN), Wireless-Fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A) and the wireless internet module 113 transmits/receives data according at least one wireless internet technology including internet technology not listed above.

From the viewpoint that wireless internet access by WiBro, HSDPA, HSUPA, GSM, CDMA, WCDMA, LTE, and LTE-A is achieved through a mobile communication network, the wireless internet module 113 performing wireless internet access through the mobile communication network may be understood as one type of the mobile communication module 112.

The short-range communication module 114 may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The short-range communication module 114 may support wireless communication between the mobile terminal 100 and a wireless communication system, between the mobile terminal 100 and another mobile terminal 100, or between networks including the mobile terminal 100 and another mobile terminal 100 (or an external server) through wireless area networks. The wireless area networks may be wireless personal area networks.

Here, the other mobile terminal 100 may be a wearable device (for example, a smart watch, a smart glass, and an HMD) that is capable of exchanging data (or interworking) with the mobile terminal 100. The short-range communication module 114 may detect (or recognize) a wearable device around the mobile terminal 100, which is capable of communicating with the mobile terminal 100 Furthermore, if the detected wearable device is a device authenticated to communicate with the mobile terminal 100, the controller 180 may transmit at least part of data processed in the mobile terminal 100 to the wearable device through the short-range communication module 114. Accordingly, a user of the wearable device may use the data processed in the mobile terminal 100 through the wearable device. For example, according thereto, when a call is received by the mobile terminal 100, a user may perform a phone call through the wearable device or when a message is received by the mobile terminal 100, a user may check the received message.

The location information module 115 is a module for obtaining the location (or the current location) of a mobile terminal and its representative examples include a global positioning system (GPS) module or a Wi-Fi module. For example, the mobile terminal may obtain its position by using a signal transmitted from a GPS satellite through the GPS module. As another example, the mobile terminal may obtain its position based on information of a wireless access point (AP) transmitting/receiving a wireless signal to/from the Wi-Fi module, through the Wi-Fi module. If necessary, the position information module 115 may perform a function of another module in the wireless communication unit 110 in order to obtain data on the location of the mobile terminal substitutionally or additionally. The location information module 115 is a module for obtaining the position (or the current position) of the mobile terminal and is not limited to a module directly calculating and obtaining the position of the mobile terminal.

Then, the input unit 120 is used for inputting image information (or signal), audio information (or signal), data, or information input from a user and the mobile terminal 100 may include at least one camera 121 in order for inputting image information. The camera 121 processes image frames such as a still image or a video obtained by an image sensor in a video call mode or a capturing mode. The processed image frame may be displayed on the display unit 151 or stored in the memory 170. Moreover, a plurality of cameras 121 equipped in the mobile terminal 100 may be arranged in a matrix structure and through the camera 121 having such a matrix structure, a plurality of image information having various angles or focuses may be input to the input terminal 100. Additionally, the plurality of cameras 121 may be arranged in a stereo structure to obtain the left and right images for implementing a three-dimensional image.

The microphone 122 processes external sound signals as electrical voice data. The processed voice data may be utilized variously according to a function (or an application program being executed) being performed in the mobile terminal 100. Moreover, various noise canceling algorithms for removing noise occurring during the reception of external sound signals may be implemented in the microphone 122.

The user input unit 123 is to receive information from a user and when information is input through the user input unit 123, the controller may control an operation of the mobile terminal 100 to correspond to the input information. The user input unit 123 may include a mechanical input means (or a mechanical key, for example, a button, a dome switch, a jog wheel, and a jog switch at the front, back or side of the mobile terminal 100) and a touch type input means. As one example, a touch type input means may include a virtual key, a soft key, or a visual key, which is displayed on a touch screen through software processing or may include a touch key disposed at a portion other than the touch screen. Moreover, the virtual key or visual key may have various forms and may be disposed on a touch screen and for example, may include graphic, text, icon, video, or a combination thereof.

Moreover, the sensing unit 140 may sense at least one of information in a mobile terminal, environmental information around a mobile terminal, and user information and may then generate a sensing signal corresponding thereto. Based on such a sensing signal, the controller 180 may control the drive or control of the mobile terminal 100 or may perform data processing, functions, or operations relating to an application program installed in the mobile terminal 100. Representative sensors among various sensors included in the sensing unit 140 will be described in more detail.

First, the proximity sensor 141 refers to a sensor detecting whether there is an object approaching a predetermined detection surface or whether there is an object around by using the strength of an electromagnetic field or infrared, without mechanical contact. The proximity sensor 141 may disposed in an inner area of a mobile terminal surrounded by the touch screen or around the touch screen.

Examples of the proximity sensor 141 may include a transmission-type photoelectric sensor, a direct reflective-type photoelectric sensor, a mirror reflective-type photoelectric sensor, a high-frequency oscillation-type proximity sensor, a capacitive-type proximity sensors, a magnetic-type proximity sensor, and an infrared proximity sensor. If the touch screen is a capacitive type, the proximity sensor 141 may be configured to detect the proximity of an object by changes in an electric field according to the proximity of the object having conductivity. In this case, the touch screen (or a touch sensor) itself may be classified as a proximity sensor.

Moreover, for convenience of description, an action for recognizing the position of an object on the touch screen as the object is close to the touch screen without contacting the touch screen is called “proximity touch” and an action that the object actually contacts the touch screen is called “contact touch”. A position that an object is proximity-touched on the touch screen is a position that the object vertically corresponds to the touch screen when the object is proximity-touched. The proximity sensor 141 may detect a proximity touch and a proximity touch pattern (for example, a proximity touch distance, a proximity touch direction, a proximity touch speed, a proximity touch time, a proximity touch position, and a proximity touch movement state). Moreover, the controller 180 processes data (for information) corresponding to a proximity touch operation and a proximity touch pattern, detected through the proximity sensor 141, and furthermore, may output visual information corresponding to the processed data on the touch screen. Furthermore, according to whether a touch for the same point on the touch screen is a proximity touch or a contact touch, the controller 180 may control the mobile terminal 100 to process different operations or data (or information).

The touch sensor detects a touch (or a touch input) applied to the touch screen (or the display unit 151) by using at least one of various touch methods, for example, a resistive film method, a capacitive method, an infrared method, an ultrasonic method, and a magnetic field method.

For example, the touch sensor may be configured to convert a pressure applied to a specific portion of the touch screen or changes in capacitance occurring at a specific portion into electrical input signals. The touch sensor may be configured to detect a position and area that a touch target applying a touch on the touch screen touches the touch sensor, a pressured when touched, and a capacitance when touched. Here, the touch target, as an object applying a touch on the touch sensor, may be a finger, a touch pen, a stylus pen, or a pointer, for example.

In such a manner, when there is a touch input on the touch sensor, signal(s) corresponding thereto are sent to a touch controller. The touch controller processes the signal(s) and then transmits corresponding data to the controller 180. Therefore, the controller 180 may recognize which area of the display unit 151 is touched. Herein, the touch controller may be an additional component separated from the controller 180 or may be the controller 180 itself.

Moreover, the controller 180 may perform different controls or the same control according to types of a touch target touching the touch screen (or a touch key equipped separated from the touch screen). Whether to perform different controls or the same control according to types of a touch target may be determined according to a current operation state of the mobile terminal 100 or an application program in execution.

Moreover, the above-mentioned touch sensor and proximity sensor are provided separately or combined and may thus sense various types of touches, for example, short (or tap) touch), long touch, multi touch, drag touch, flick touch, pinch-in touch, pinch-out touch, swipe touch, and hovering touch for the touch screen.

The ultrasonic sensor may recognize position information of a detection target by using ultrasonic waves. Moreover, the controller 180 may calculate the position of a wave source through information detected by an optical sensor and a plurality of ultrasonic sensors. The position of the wave source may be calculated by using the property that light is much faster than ultrasonic wave, that is, a time that light reaches an optical signal is much shorter than a time that ultrasonic wave reaches an ultrasonic sensor. In more detail, the position of the wave source may be calculated by using a time difference with a time that ultrasonic wave reaches by using light as a reference signal.

Moreover, the camera 121 described as a configuration of the input unit 120 may include at least one of a camera sensor (for example, CCD and CMOS), a photo sensor (or an image sensor), and a laser sensor.

The camera 121 and the laser sensor may be combined to detect a touch of a detection target for a three-dimensional image. The photo sensor may be stacked on a display device and is configured to scan a movement of a detection target close to the touch screen. In more detail, the photo sensor mounts a photo diode and a transistor (TR) in a row/column and scans content disposed on the photo sensor by using an electrical signal changing according to an amount of light applied to the photo diode. That is, the photo sensor may calculate the coordinates of a detection target according to the amount of change in light and through this, may obtain the position information of the detection target.

The display unit 151 may display (output) information processed in the mobile terminal 100. For example, the display unit 151 may display execution screen information of an application program running on the mobile terminal 100 or user interface (UI) and graphic user interface (GUI) information according to such execution screen information.

Additionally, the display unit 151 may be configured as a three-dimensional display unit displaying a three-dimensional image.

A three-dimensional display method, for example, a stereoscopic method (a glasses method), an autostereoscopic (no glasses method), a projection method (a holographic method) may be applied to the three-dimensional display unit

The sound output unit 152 may output audio data received from the wireless communication unit 110 or stored in the memory 170 in a call signal reception or call mode, a recording mode, a voice recognition mode, or a broadcast reception mode. The sound output unit 152 may output a sound signal relating to a function (for example, a call signal reception sound and a message reception sound) performed by the mobile terminal 100. The sound output unit 152 may include a receiver, a speaker, and a buzzer.

The haptic module 153 generates various haptic effects that a user can feel. A representative example of a haptic effect that the haptic module 153 generates is vibration. The intensity and pattern of vibration generated by the haptic module 153 may be controlled by a user's selection or a setting of a controller. For example, the haptic module 153 may synthesize and output different vibrations or output different vibrations sequentially.

The haptic module 153 may generate various haptic effects, for example, effects by a pin arrangement moving vertical to a contact skin surface, injection power or suction power of air through an injection port or a suction port, rubbing a skin surface, electrode contact, stimulus of electrostatic force and effects by the reproduction of cold/warm sense by using a device absorbing or emitting heat.

The haptic module 153 may be implemented to deliver a haptic effect through a direct contact and also allow a user to feel a haptic effect through a muscle sense such as a finger or an arm. The haptic module 153 may be more than two according to a configuration aspect of the mobile terminal 100.

The optical output unit 154 outputs a signal for notifying event occurrence by using light of a light source of the mobile terminal 100. An example of an event occurring in the mobile terminal 100 includes message reception, call signal reception, missed calls, alarm, schedule notification, e-mail reception, and information reception through an application.

A signal output from the optical output unit 154 is implemented as a mobile terminal emits single color of multi-color to the front or the back. The signal output may be terminated when a mobile terminal detects user's event confirmation.

The interface unit 160 may serve as a path to all external devices connected to the mobile terminal 100. The interface unit 160 may receive data from an external device, receive power and deliver it to each component in the mobile terminal 100, or transmit data in the mobile terminal 100 to an external device. For example, the interface unit 160 may include a wired/wireless headset port, an external charger port, a wired/wireless data port, a memory card port, a port connecting a device equipped with an identification module, an audio I/O port, a video I/O port, and an earphone port.

Moreover, the identification module, as a chip storing various information for authenticating usage authority of the mobile terminal 100, may include a user identity module (UIM), a subscriber identity module (SIM), and a universal subscriber identity module (USIM). A device equipped with an identification module (hereinafter referred to as an identification device) may be manufactured in a smart card form. Accordingly, the identification device may be connected to the terminal 100 through the interface unit 160.

Additionally, when the mobile terminal 100 is connected to an external cradle, the interface unit 160 may become a path through which power of the cradle is supplied to the mobile terminal 100 or a path through which various command signals input from the cradle are delivered to the mobile terminal 100 by a user. The various command signals or the power input from the cradle may operate as a signal for recognizing that the mobile terminal 100 is accurately mounted on the cradle.

The memory 170 may store a program for an operation of the controller 180 and may temporarily store input/output data (for example, a phone book, a message, a still image, and a video). The memory 170 may store data on various patterns of vibrations and sounds output during a touch input on the touch screen.

The memory 170 may include at least one type of storage medium among flash memory type, hard disk type, Solid State Disk (SSD) type, Silicon Disk Drive (SDD) type, multimedia card micro type, card type memory (for example, SD or XD memory type), random access memory (RAM) type, static random access memory (SRAM) type, read-only memory (ROM) type, electrically erasable programmable read-only memory (EEPROM) type, programmable read-only memory (PROM) type, magnetic memory type, magnetic disk type, and optical disk type. The mobile terminal 100 may operate in relation to a web storage performing a storage function of the memory 170 on internet.

Moreover, as mentioned above, the controller 180 may control operations relating to an application program and overall operations of the mobile terminal 100 in general. For example, if a state of the mobile terminal 100 satisfies set conditions, the controller 180 may execute or release a lock state limiting an output of a control command of a user for applications.

Additionally, the controller 180 may perform a control or processing relating to a voice call, data communication, and a video call may perform pattern recognition processing for recognizing handwriting input or drawing input on the touch screen as a text and an image, respectively. Furthermore, the controller 180 may use at least one or a combination of the above components to perform a control in order to implement various embodiments described below on the mobile terminal 100.

The power supply unit 190 may receive external power or internal power under a control of the controller 180 and may then supply power necessary for an operation of each component. The power supply unit 190 includes a battery. The battery is a rechargeable built-in battery and may be detachably coupled to a terminal body in order for charging.

Additionally, the power supply unit 190 may include a connection port and the connection port may be configured as one example of the interface unit 160 to which an external charger supplying power for charging of the battery is electrically connected.

As another example, the power supply unit 190 may be configured to charge a battery through a wireless method without using the connection port. In this case, the power supply unit 190 may receive power from an external wireless power transmission device through at least one of an inductive coupling method based on a magnetic induction phenomenon, and a magnetic resonance coupling method based on an electromagnetic resonance phenomenon.

Moreover, various embodiments below may be implemented in a computer or device similar thereto readable medium by using software, hardware, or a combination thereof.

Hereinafter, embodiments relating to a control method implemented in such a configured mobile terminal are described with reference to the accompanying drawings. It is apparent to those skilled in the art that the present invention may be specified in a different specific form without departing from the scope and essential features of the present invention.

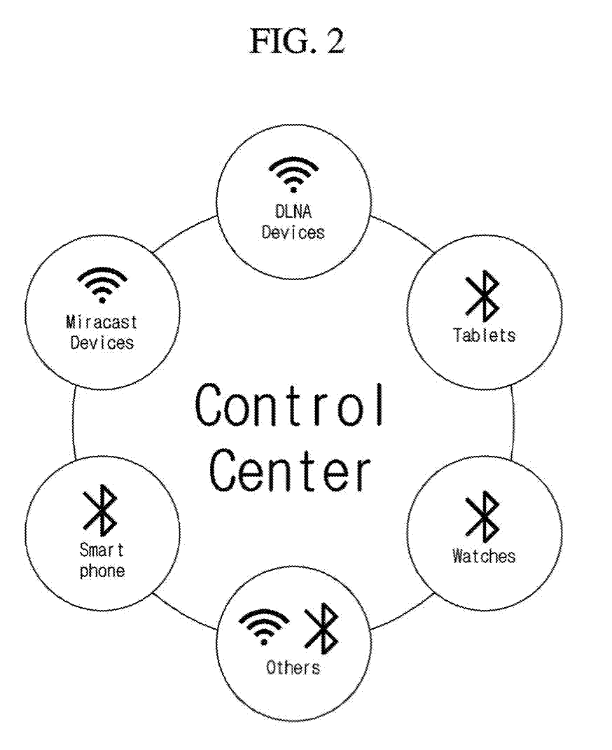

FIG. 2 is a view illustrating a mobile terminal and a control method thereof according to an embodiment of the present invention.

Referring to FIG. 2, a mobile terminal and a control method thereof according to an embodiment of the present invention provide a control center for integrally controlling external terminals as connected to a plurality of external terminals.

The control center provides a screen for allowing a user to check and control a state of an external terminal on the display unit 151 of the mobile terminal 100.

Objects corresponding to external terminals connected to the mobile terminal 100 through WiFi, Bluetooth, or infrared communication may be displayed on the control center and for example, a plurality of external terminals may include smartphones, Miracast devices, DLNA devices, tablets, and smart watches. Additionally, although not shown in the drawings, the plurality of external terminals may include refrigerators, washing machines, and cars.

The control center may provide a screen for simultaneously displaying objects corresponding to a plurality of external terminals connected to the mobile terminal 100 and as shown in FIG. 2, a plurality of objects may be disposed along one circle as shown in FIG. 2. When one object is selected by touching or dragging, the control center may provide state information of an external terminal corresponding to a corresponding object, providing a screen for controlling an external terminal, or executing an application.

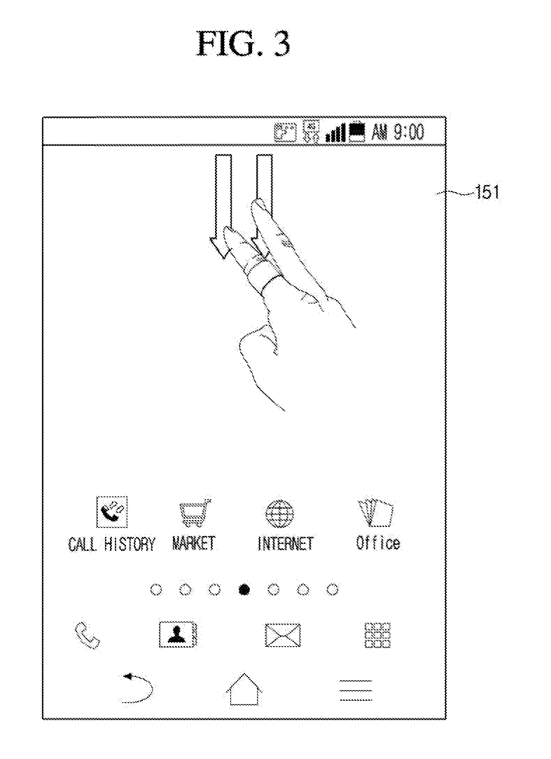

FIGS. 3 to 7 are views illustrating a method of entering a control center in a mobile terminal.

Referring to FIG. 3, as a first embodiment of entering a control center, if a user inputs drag touch in the bottom direction from the top while touching the display unit 151 by two fingers, the control center may be displayed on the display unit 151.

The display unit 151 may be a touch panel and when drag touch is input in the bottom direction from two points in the top direction of the display unit 151, the controller 180 may perform a control to display the control center. Herein, the bottom refers to a lower part having a relatively low height as looking at the display unit 151 while a mobile terminal is in an upright position.

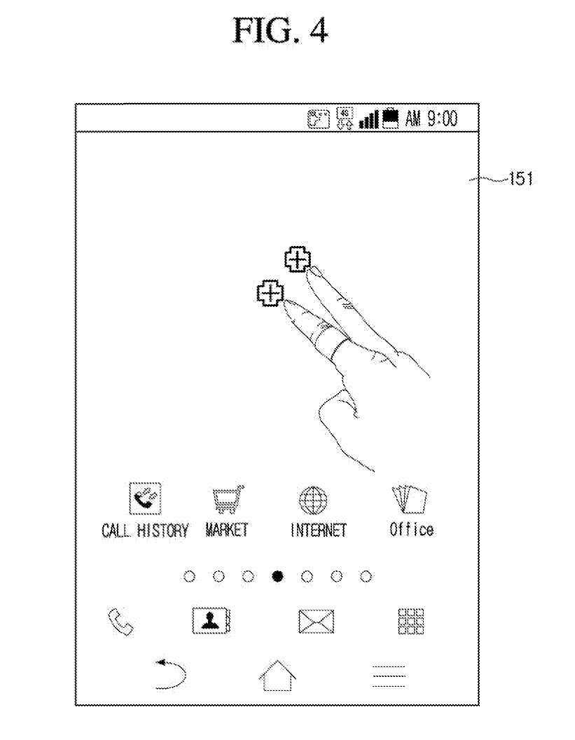

Referring to FIG. 4, as a second embodiment of entering a control center, if a user touches the display unit 151 two times by two fingers, the control center may be executed and displayed on the display unit 151. When a signal relating to two-times touching at two points of the display unit 151 is input, the controller 180 may perform a control to display the control center.

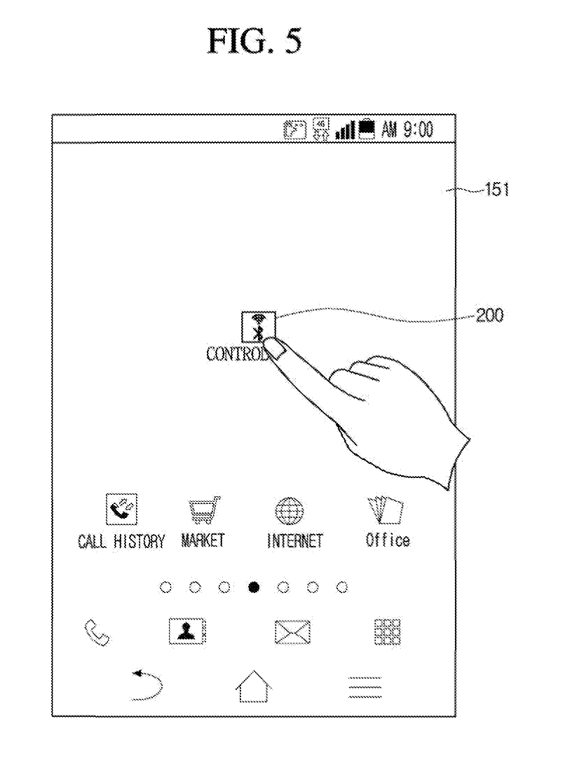

Referring to FIG. 5, as a third embodiment of entering a control center, the control center is provided in an application form and when a user touches an object 200 corresponding to the control center disposed on the display unit 151, the controller 180 may perform a control to execute and display the control center on the display unit 151.

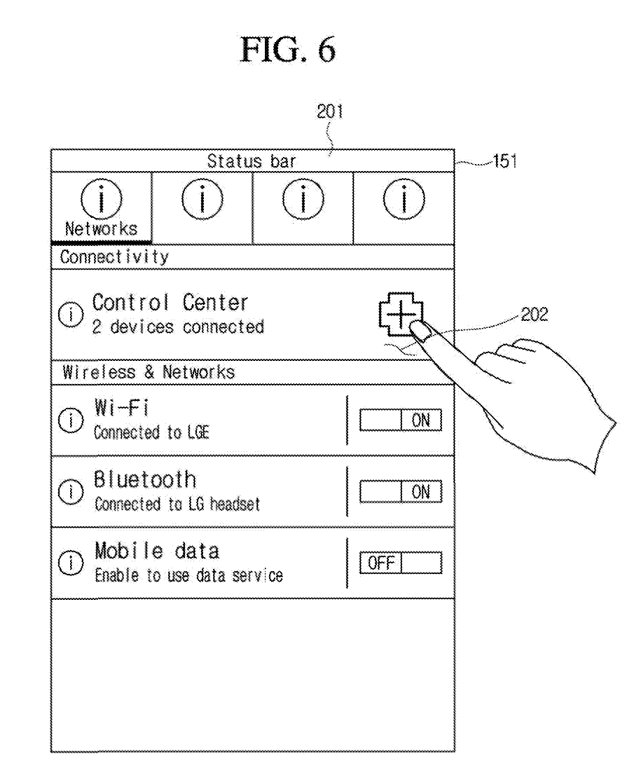

Referring to FIG. 6, as a fourth embodiment of entering a control center, when a control center area 202 for entering the control center may be provided to a part in a notification center or a notification panel screen 201 that displayed when a user drag touches the top of the display unit in the bottom direction by one finger, and when a user touches the control center area 202, the controller 180 may perform a control to execute and display a control center on the display unit 151.

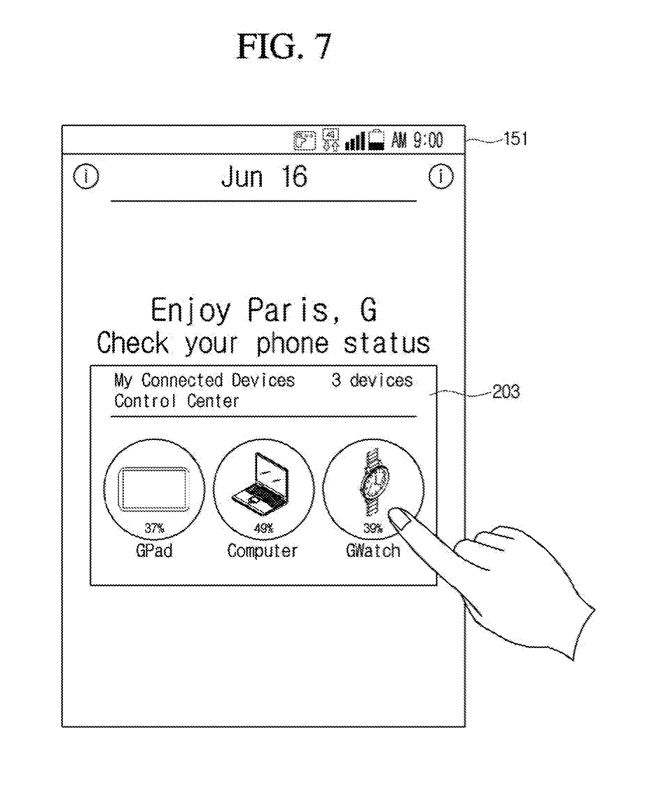

Referring to FIG. 7, as fifth embodiment of entering a control center, a control center widget 203 may be displayed on the display unit 151 and when a user touches the control center widget 203, a detail screen for checking and controlling a state of an external terminal may be provided.

Moreover, although not shown in FIGS. 3 to 7, when a user takes a specific gesture, the camera 121 or the sensing unit 140 of the mobile terminal 100 may detect this and the controller 180 may perform a control to execute a control center.

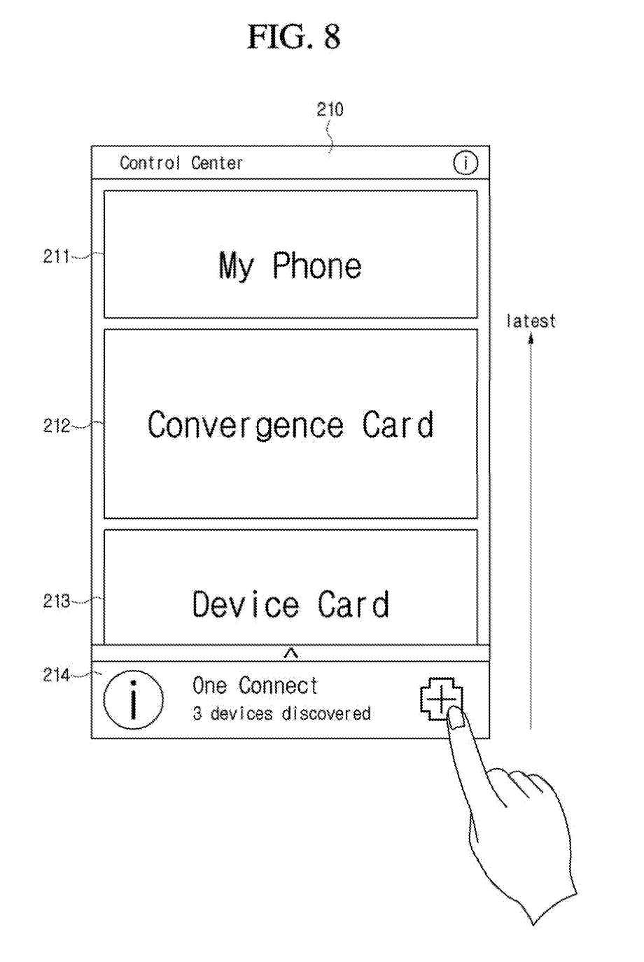

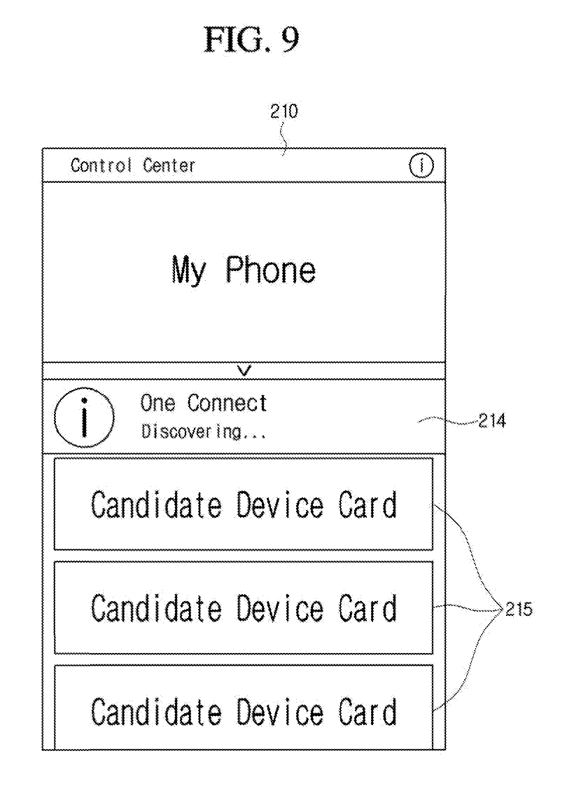

FIGS. 8 and 9 are views illustrating a control center in a mobile terminal and a control method thereof according to an embodiment of the present invention.

Referring to FIG. 8, a control center 210 may be displayed in a rectangular form according to the form of the display unit 151 and may include a my device area 211, an integrated device area 212, an external terminal area 213, and a search area 214.

The my device area 211 may be displayed as My Phone and information of the mobile terminal 100, a connection state with an external terminal, and a simple control function may be displayed on the my device area 211.

The integrated device area 212 may be displayed as Convergence Card; objects corresponding to the mobile terminal 100 and external terminals may be displayed; and functions for generating synergy effects between the mobile terminal 100 and a connected external terminal, may be displayed.

The external terminal area 213 may be displayed as Device Card and information of an external terminal connected to the mobile terminal 100, a connection state with an external terminal, and a simple control function may be displayed. The external terminal area 213 may allow the external terminal area 213 corresponding to the recently accessed external terminal to be disposed at the top.

The search area 214 may display a key for a connection state with external terminals and an additional connection.

As described with reference to FIGS. 3 to 7, when a user enters the control center 210, the controller 180 may perform a control to turn on a WiFi module, a Bluetooth module, and an infrared module by checking a state of the wireless communication unit 110.

Accordingly, even when a WiFi module, a Bluetooth module, and an infrared module are in an off state, if they are switched to an on state, previously connected external terminals may be connected automatically or searched or external terminals that are not connected automatically before but are currently connection available may be searched.

Referring to FIGS. 8 and 9, when a user touches and selects the search area 214, the controller 180 may search for external terminals that are currently connection available with the mobile terminal 100 and may display connection available external terminal areas 215 corresponding to the external terminals. When a user touches and selects at least one of the connection available external terminal areas 215 corresponding to the external terminals, connection with the selected external terminals may be established.

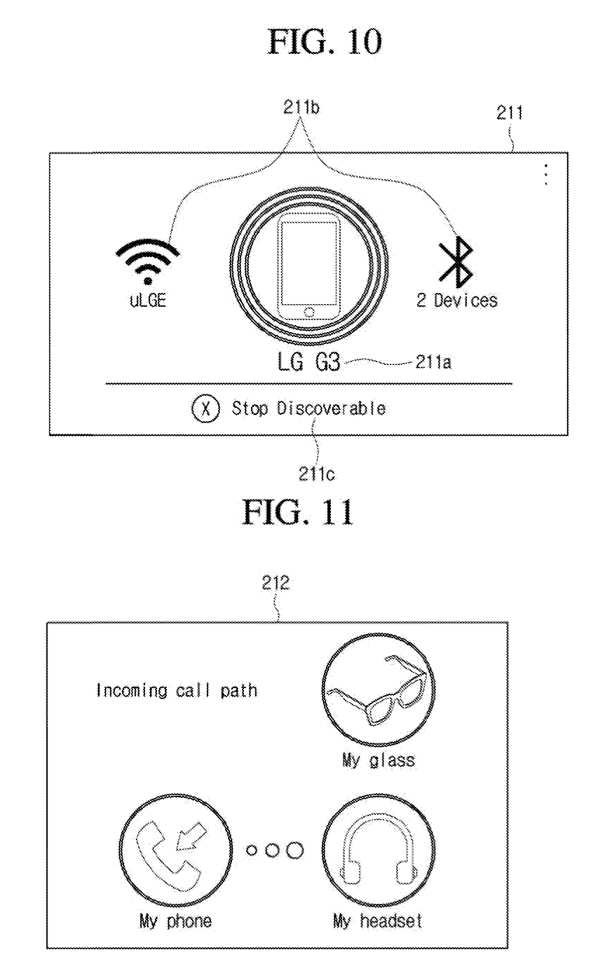

FIG. 10 is a view illustrating a my device area in a mobile terminal and a control method thereof according to an embodiment of the present invention.

Referring to FIG. 10, the my device area 211 may display information 211a of the mobile terminal 100, a connection state 211b with an external terminal, and a simple control function 211c.

As shown in FIG. 10, LG G3, that is the name of a mobile terminal, is displayed as the mobile terminal information 211a; a WiFi type and the number of devices connected through Bluetooth are displayed as the connection state 211b with an external terminal; and a key for blocking a connection state with an external terminal is displayed as the simple control function 211c.

Accordingly, a user may check a connection state with external terminals and control a connection state at a time through the my device area 211.

FIGS. 11 and 13 are views illustrating an integrated device area in a mobile terminal and a control method thereof according to an embodiment of the present invention.

Referring to FIG. 11, the integrated device area 212 may display a screen for selecting an external terminal to connect a received phone call. A user may simply set which external terminal is to receive a received phone call through a drag operation for connecting an object in a phone form displayed as My phone to an object of a headset form displayed as My headset or an object in a glass form displayed as My glass.

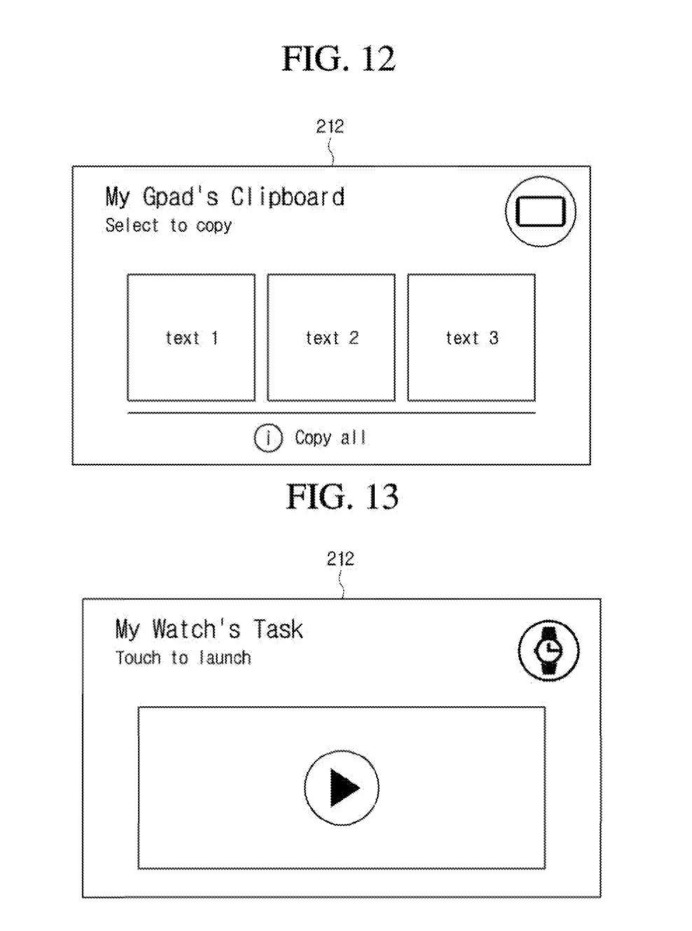

Referring to FIG. 12, the integrated device area 212 may display a screen for selecting content stored in the clipboard of a connected external terminal and storing this in the clipboard of the mobile terminal 100. A user may select and copy stored clipboard content stored in a G pad that is a tablet connected to the mobile terminal 100.

Referring to FIG. 13, the integrated device area 212 may display a screen for allowing a task being performed by a connected external terminal to be continuously performed by the mobile terminal 100. A user may continuously play the video playback being performed by a smart watch connected to the mobile terminal 100, in the mobile terminal 100.

In such a way, in order to generate synergy effects between the mobile terminal 100 and a connected external terminal, the integrated device area 212 may display a screen for selecting an external terminal for vicariously performing a function performed by the mobile terminal 100, or a screen for displaying content stored in an external terminal connected to the mobile terminal 100 and storing the content in the mobile terminal as a user selects the content, or a screen for performing a task performed by an external terminal connected to the mobile terminal 100 to be continuously performed by the mobile terminal 100. The controller 180 controls this.

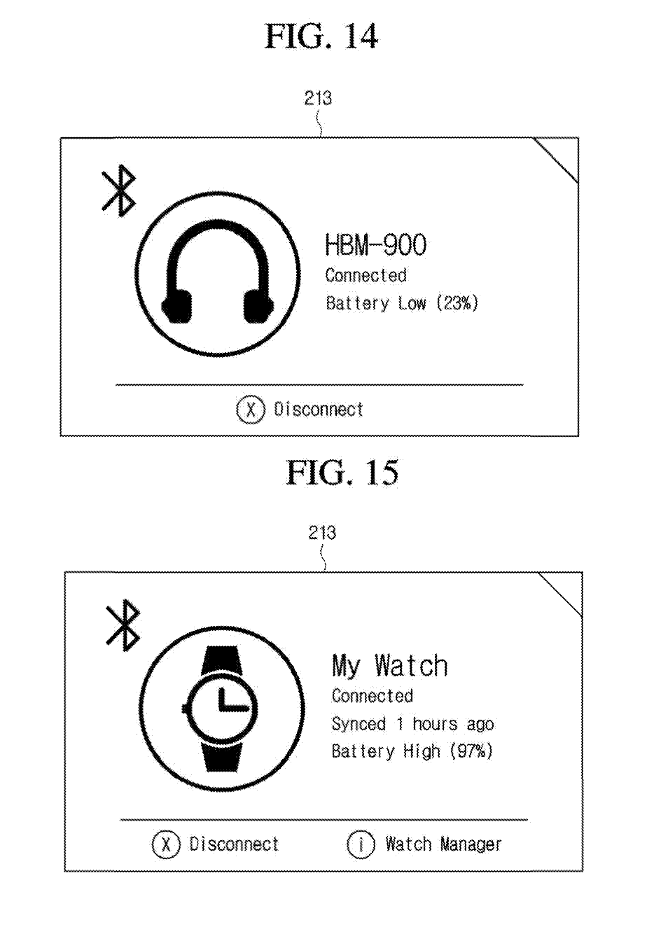

FIGS. 14 and 19 are views illustrating an external terminal area in a mobile terminal and a control method thereof according to an embodiment of the present invention.

Referring to FIG. 14, a headset is displayed as an external terminal connected to the mobile terminal 100 in the external terminal area 213; HBM-900, that is the name of the headset, and the battery remaining 23% are displayed as information of the headset; and Bluetooth is displayed as a connection state. Additionally, as a simple control function, Disconnect is displayed as a key for disconnecting connection.

Referring to FIG. 15, a smart watch is displayed as an external terminal connected to the mobile terminal 100 in the external terminal area 213; My Watch, that is the name of the smart watch, the battery remaining 97%, and the fact that synchronization is made one hour ago are displayed as information of the headset; and Bluetooth is displayed as a connection state. Additionally, as a simple control function, Disconnect is displayed as a key for disconnecting connection and Watch Manager for executing a control screen to control the smart watch is displayed. Although not shown in the drawings, a kids band worn by children may be displayed as an external terminal and in this instance, the current location and reception state may be displayed as information of the kids band.

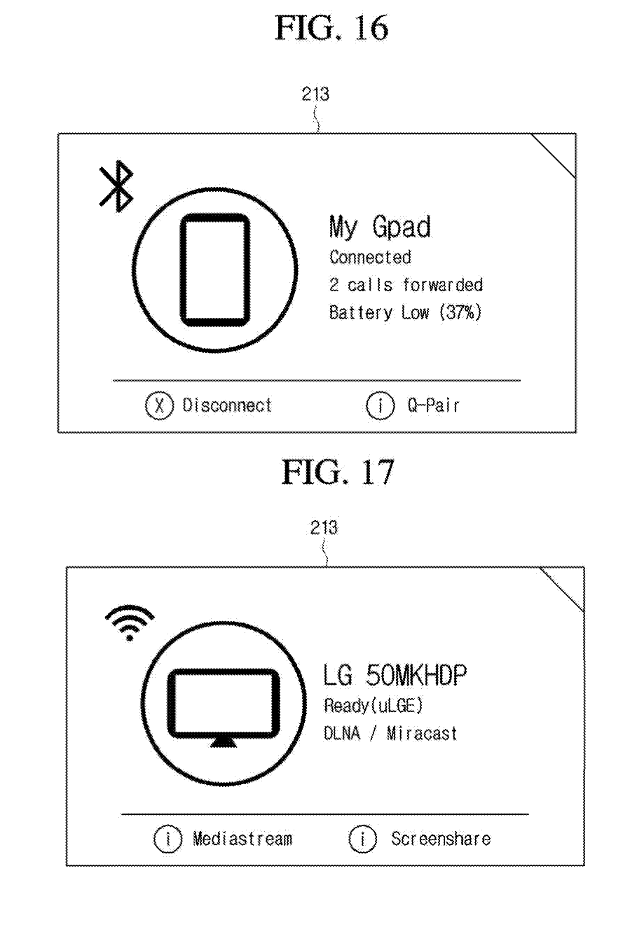

Referring to FIG. 16, a tablet is displayed as an external terminal connected to the mobile terminal 100 in the external terminal area 213; My Gpad, that is the name of the tablet, the battery remaining 37%, and the fact that two phone calls are delivered are displayed as information of the tablet; and Bluetooth is displayed as a connection state. Additionally, as a simple control function, Disconnect is displayed as a key for disconnecting connection and Q-Pair for executing a function that links data is displayed.

Referring to FIG. 17, a TV is displayed as an external terminal connected to the mobile terminal 100 in the external terminal area 213; LG 50MKHDP, that is the name of the TV, is displayed as information of the TV; and DLNA/Miracast connection through WiFi is displayed as a connection state. Additionally, Mediastream for executing a function for transmitting media content and Screenshare for executing a function for providing the same screen are displayed as a simple control function.

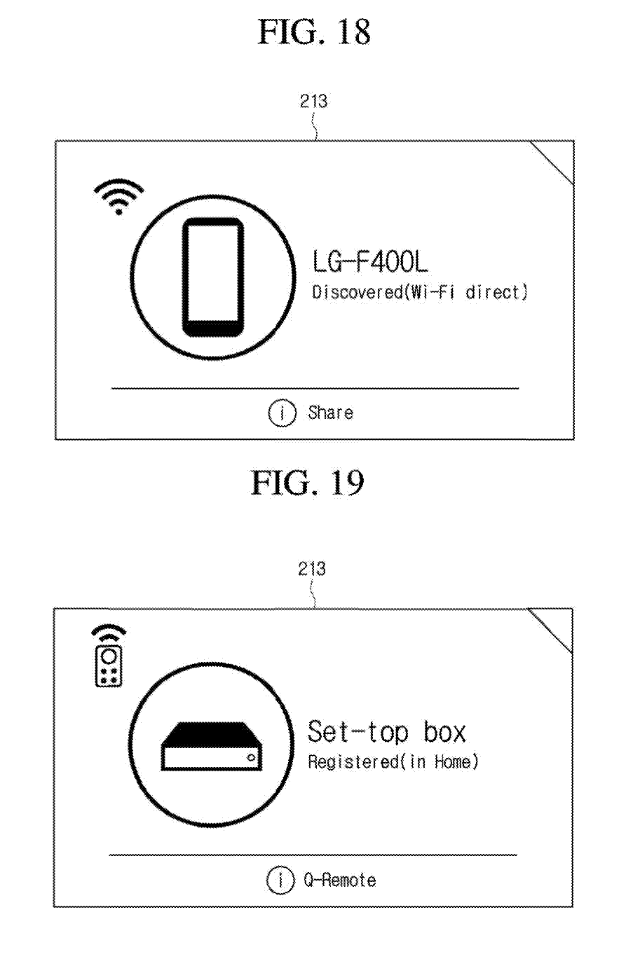

Referring to FIG. 18, a smartphone is displayed as an external terminal connected to the mobile terminal 100 in the external terminal area 213; LG-F400L, that is the name of the smartphone is displayed as information of the smartphone; and connection through WiFi is displayed as a connection state. Additionally, Share for executing a function for sharing content is displayed as a simple control function.

Referring to FIG. 19, a settop box is displayed as an external terminal registered in the mobile terminal 100 in the external terminal area 213, and Q-Remote for displaying the fact that control is made remotely through infrared is displayed.

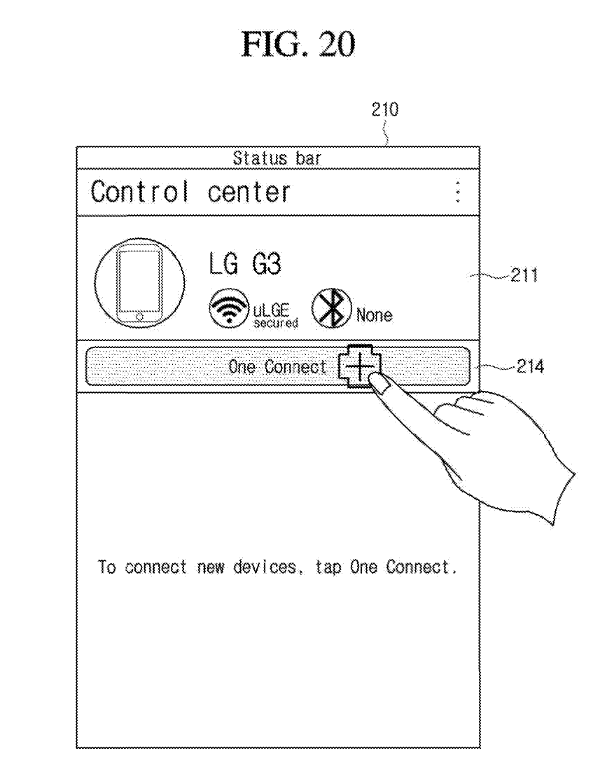

FIGS. 20 to 22 are views illustrating the execution of a control center in a mobile terminal and a control method thereof according to an embodiment of the present invention.

Referring to FIG. 20, as described with reference to FIGS. 3 to 7, when a user enters the control center 210, the my device area 211 including information of the mobile terminal 100, a connection state with an external terminal, and a simple control function is displayed and the search area 214 is displayed at the bottom of the my device area 211.

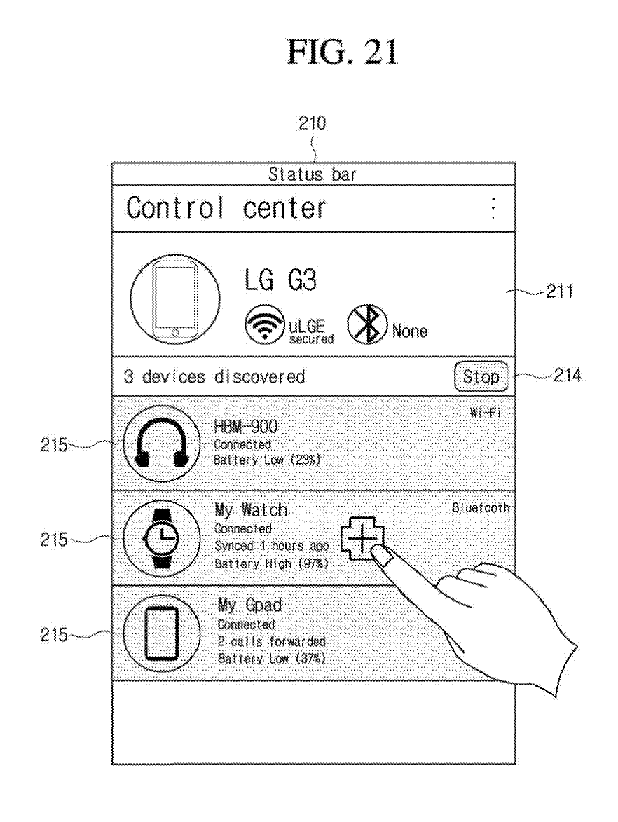

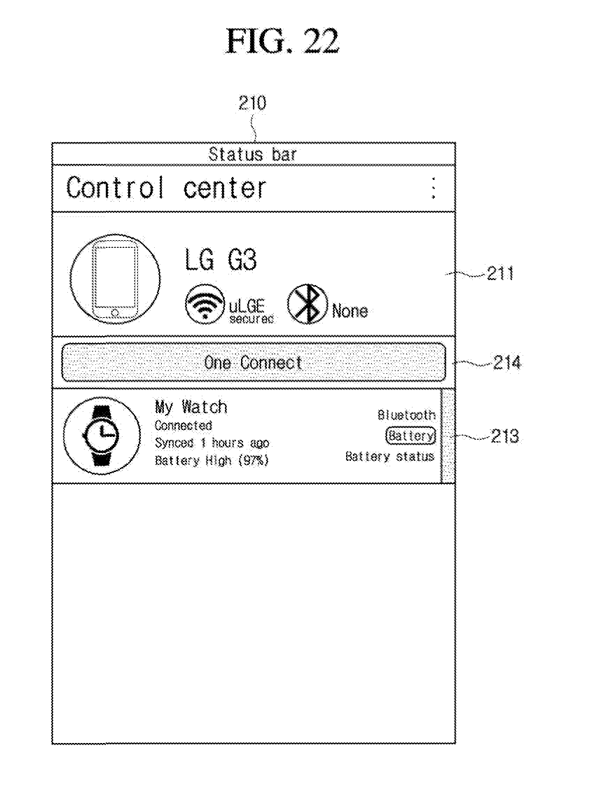

Referring to FIG. 21, when a user makes an input by touching the search area 214, connectable external terminals found through WiFi or Bluetooth are displayed. When a user selects one external terminal in the connectable external terminal area 215, as shown in FIG. 22, the selected external terminal is displayed in the external terminal area 213.

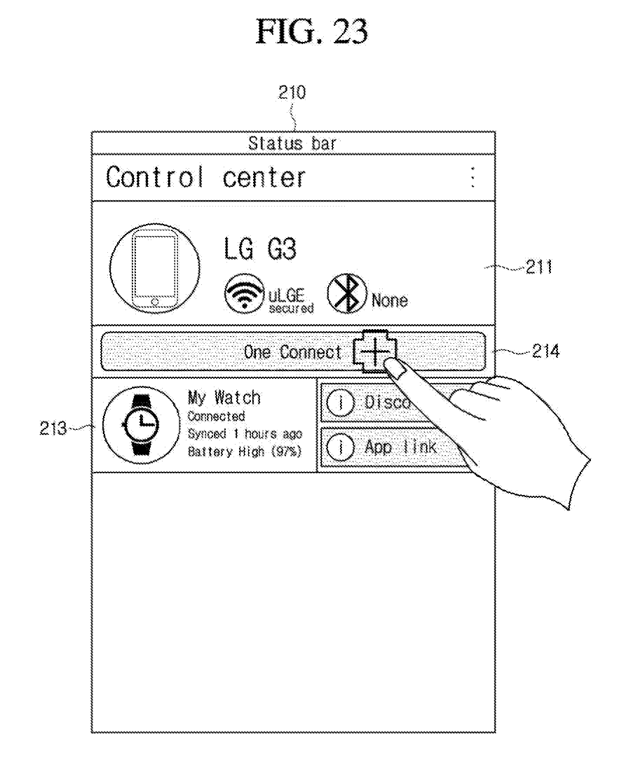

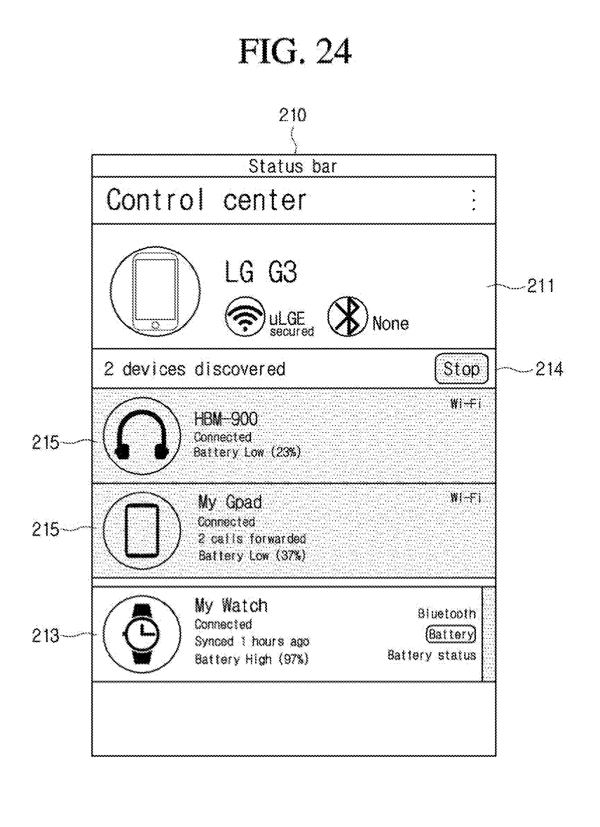

FIGS. 23 and 24 are views illustrating the execution of a control center in a mobile terminal and a control method thereof according to another embodiment of the present invention.

Referring to FIG. 23, as described with reference to FIGS. 3 to 7, when a user enters the control center 210, the my device area 211 including information of the mobile terminal 100, a connection state with an external terminal, and a simple control function is displayed; the search area 214 is displayed at the bottom of the my device area 211; and the external terminal area 213 is displayed at the bottom of the search area 214.

As an external terminal that is previously connected to the mobile terminal 100, an external terminal corresponding to the external terminal area 213 may be automatically connected through WiFi or Bluetooth at the same time when the control center 210 is executed or may be automatically connected even before the control center 210 is executed.

Referring to FIG. 24, when a user makes an input by touching the search area 214, a connectable external terminal area 215 corresponding to a connectable external terminal found through WiFi or Bluetooth is displayed.

Although it is shown according to an embodiment of the present invention that the connectable external terminal area 215 is disposed at the top of the external terminal area 213, the external terminal area 213 may be disposed at the top of the connectable external terminal area 215.

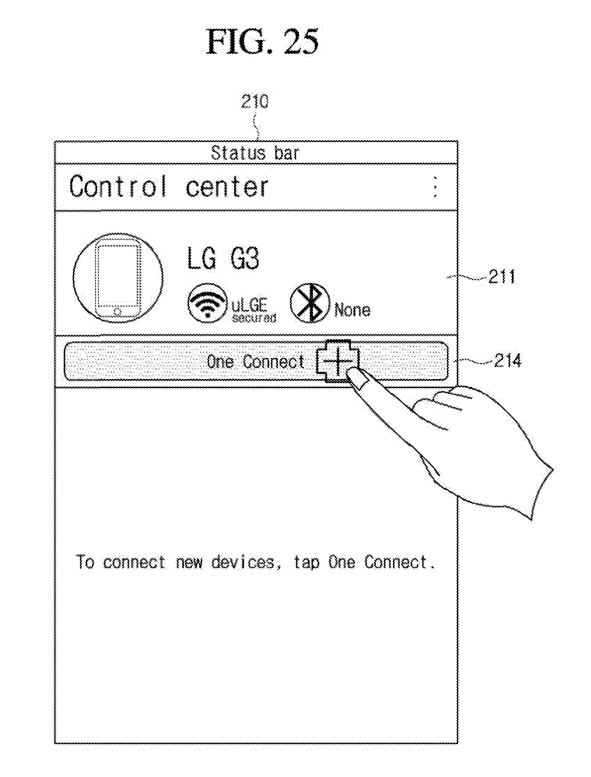

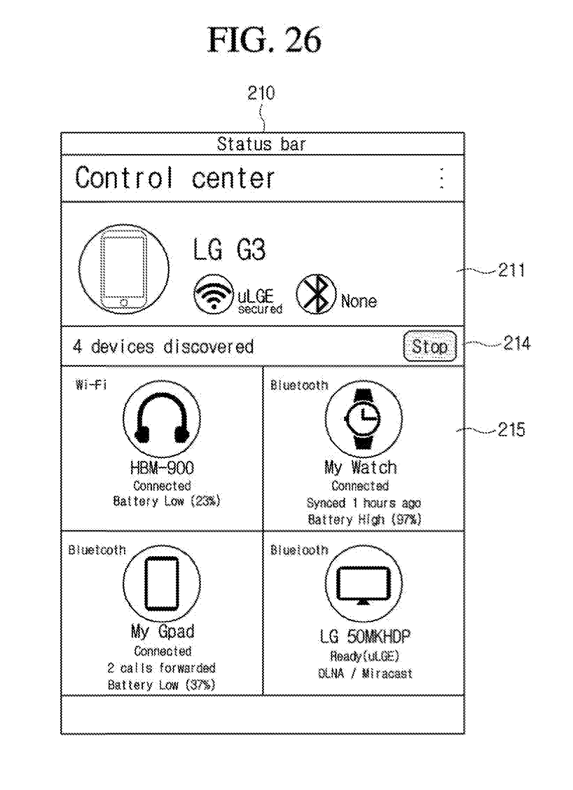

FIGS. 25 and 26 are views illustrating the execution of a control center in a mobile terminal and a control method thereof according to another embodiment of the present invention.

Referring to FIG. 25, as described with reference to FIGS. 3 to 7, when a user enters the control center 210, the my device area 211 including information of the mobile terminal 100, a connection state with an external terminal, and a simple control function is displayed and the search area 214 is displayed at the bottom of the my device area 211.

Referring to FIG. 26, when a user makes an input by touching the search area 214, a connectable external terminal area 215 corresponding to a connectable external terminal found through WiFi or Bluetooth is displayed.

Although it is shown in FIGS. 22 and 24 that the connectable external terminal area 215 is disposed one by one from the top direction to the bottom direction according to an external terminal, it is shown in FIG. 26 that the connectible external terminal area 215 is disposed in a grid. That is, in the drawings, two connectable external terminal areas 215 are disposed and two connectable external terminal areas 215 are disposed at the bottom thereof. Such an arrangement may be applied to the already connected external terminal area 213 and may be applied to the external terminal area 213 and the connectible external terminal area 215.

On the other hand, the connectable external terminal area 215, or the external terminal area 213, or the connectable external terminal area 215 and the external terminal area 213 may be disposed in a circular form as described with reference to FIG. 2.

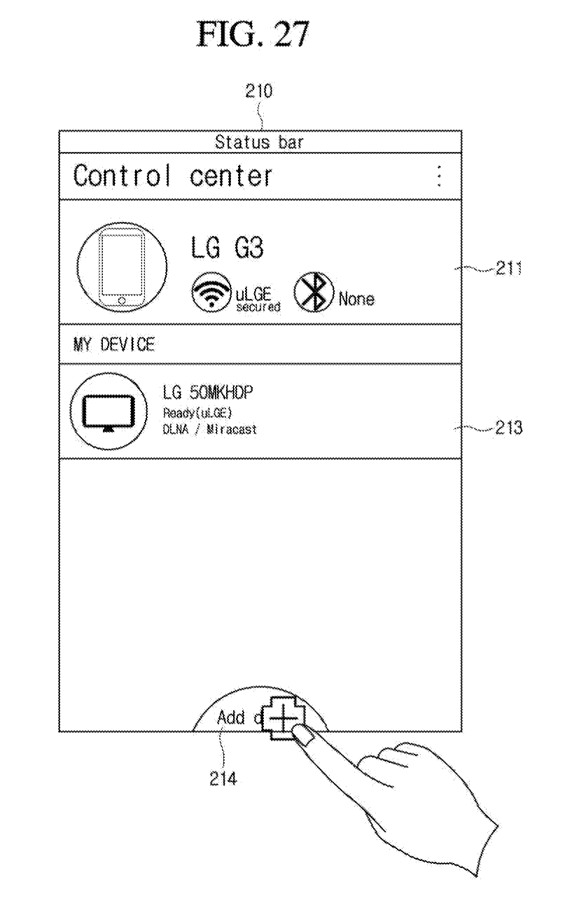

FIGS. 27 to 29 are views illustrating the execution of a control center in a mobile terminal and a control method thereof according to another embodiment of the present invention.

Referring to FIG. 27, as described with reference to FIGS. 3 to 7, when a user enters the control center 210, the my device area 211 including information of the mobile terminal 100, a connection state with an external terminal, and a simple control function is displayed; the external terminal area 213 is displayed at the bottom of the may device area 211; and the search area 214 is displayed at the bottom of the external terminal area 213. The search area 214 may be disposed to contact the bottom edge of the display unit 151 and in this instance, while a user grips the mobile terminal 100 by one hand, it is easy to touch, slide, or drag the search area 214 by using the thumb.

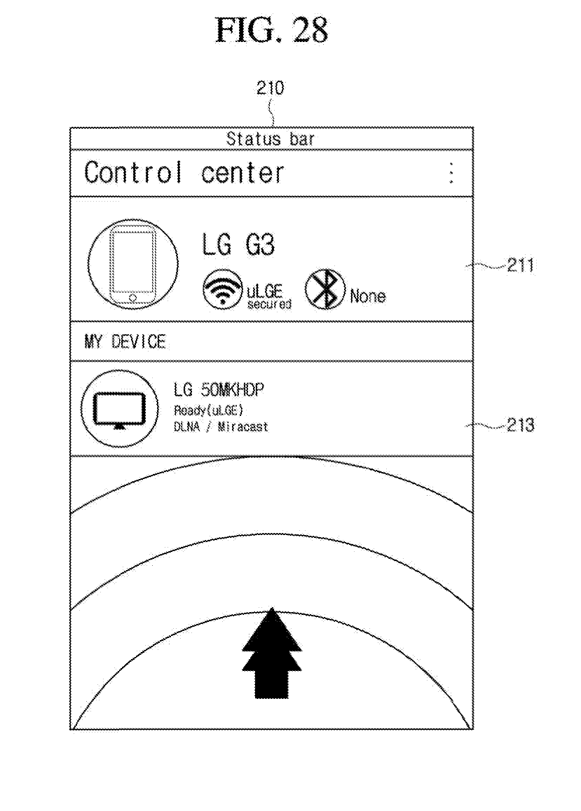

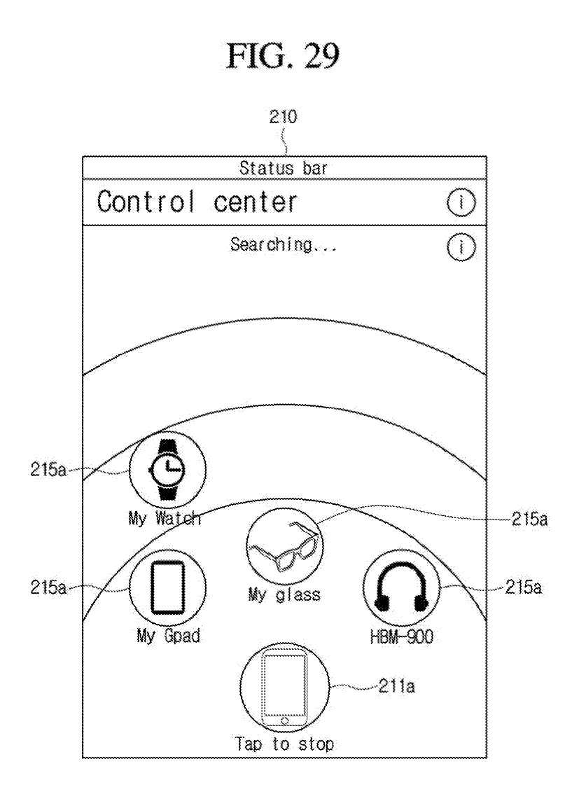

Referring to FIGS. 28 and 29, when a user makes an input by touching or dragging the search area 214, as an image of a form in which the search area 214 is enlarged in the outer direction of a semi-circle as shown in FIG. 28 is displayed, a my device object 211a corresponding to my device and a connectable external terminal object 215a corresponding to a connectable external terminal are displayed as shown in FIG. 29.

As described above, when a user enters the control center 210, the controller 180 searches for an external terminal through automatic background execution, and when a user makes an input by touching, sliding, or dragging the search area 214, previously found external terminals are displayed sequentially according to the rules. For example, the connectible external terminal objects 215a corresponding to a connectible external terminal may be displayed from the left to the right and from the bottom to the top, and may be displayed in the order of BLE (Bluetooth Low Energy), Bluetooth, and WiFi according to a communication connection method. The object 215a corresponding to the external terminal may be disposed along a concentric circle.

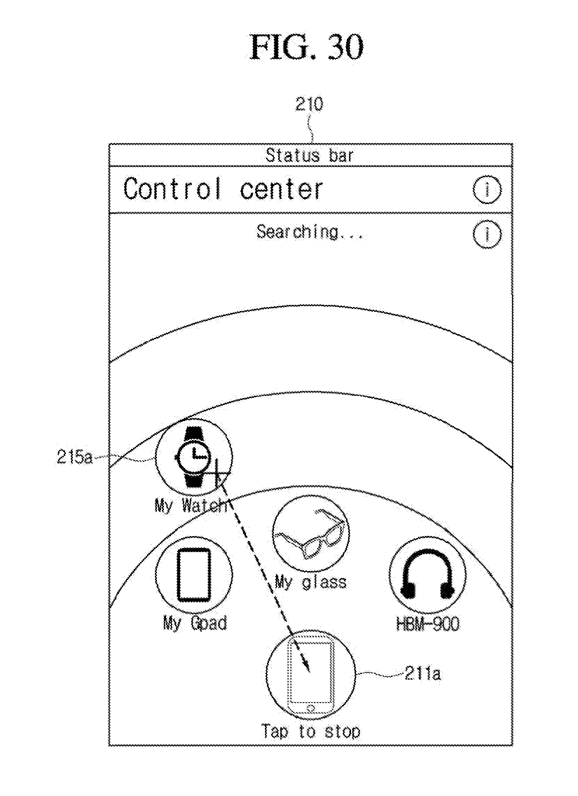

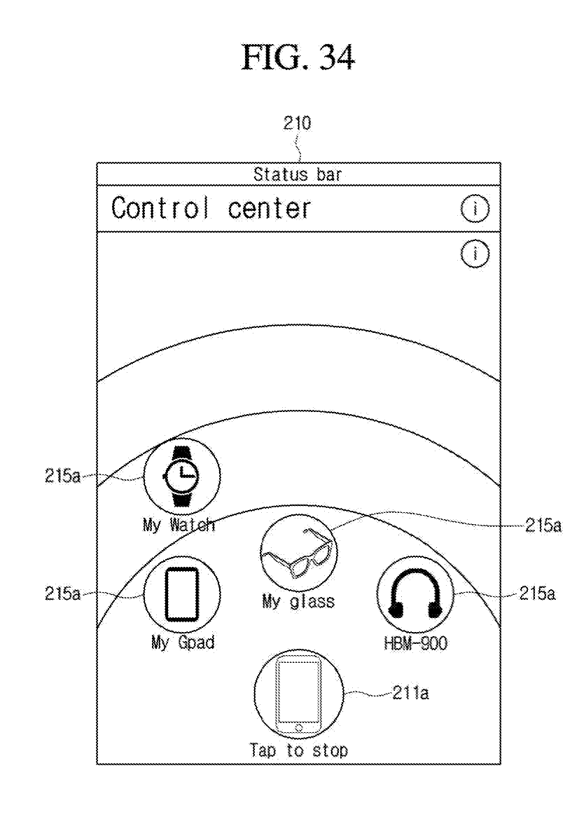

FIGS. 30 and 34 are views of connecting an external terminal and a mobile terminal through a WiFi communication method in a mobile terminal and a control method thereof according to an embodiment of the present invention.

Referring to FIG. 30, when a drag input from the connectable external terminal object 215a to the my device object 211a is made or when a drag input from the my device object 211a to the connectible external terminal object 215a is made, the mobile terminal 100 and an external terminal are connected through a WiFi communication method. Of course, when an additional connection operation is required according to another network connection method, a connection operation may be added.

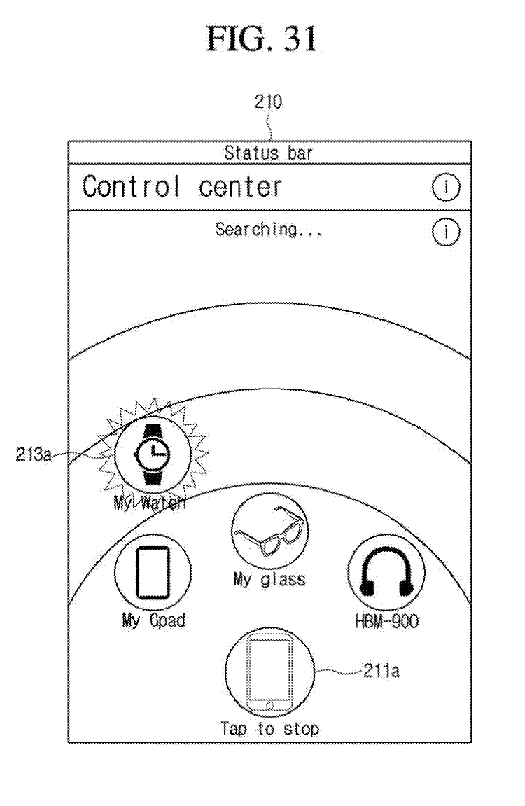

Referring to FIG. 31, once connection is made with the mobile terminal 100, the connectable external terminal object 215a is highlighted and displayed as the external terminal object 213a corresponding to a connected external terminal.

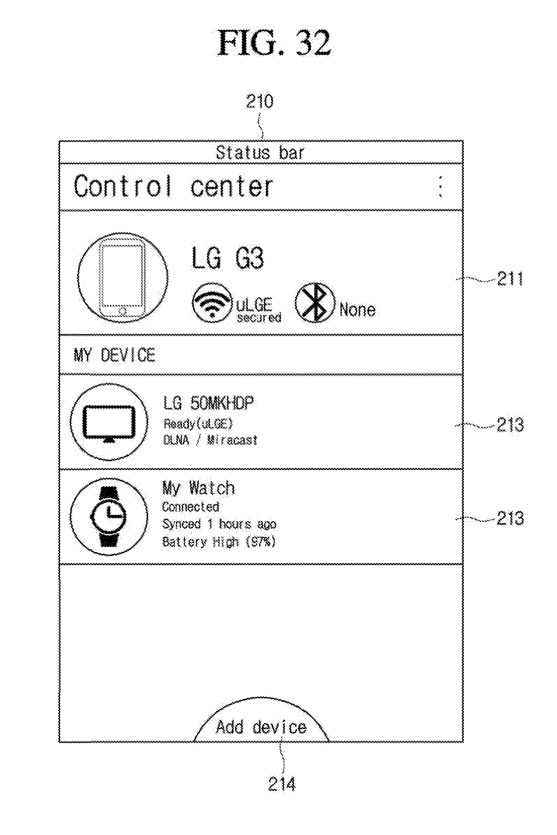

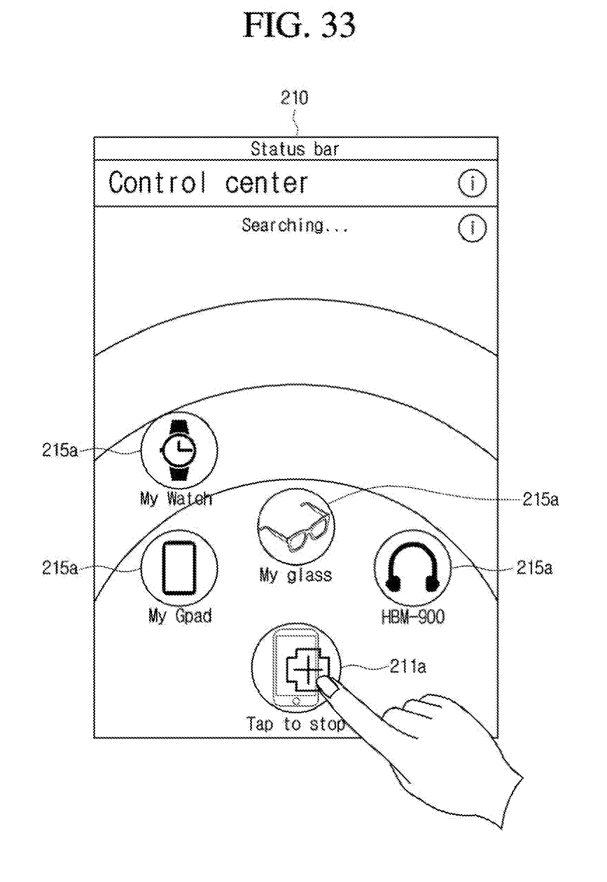

Referring to FIGS. 33 and 34, when a user touches the my device object 211a again, search is stopped and as shown in FIG. 32, the my device area 211, the external terminal area 213, and the search area 214 are displayed. At this point, unlike FIG. 27, it is checked that a watch that is a newly found external device is added to the external terminal area 213.

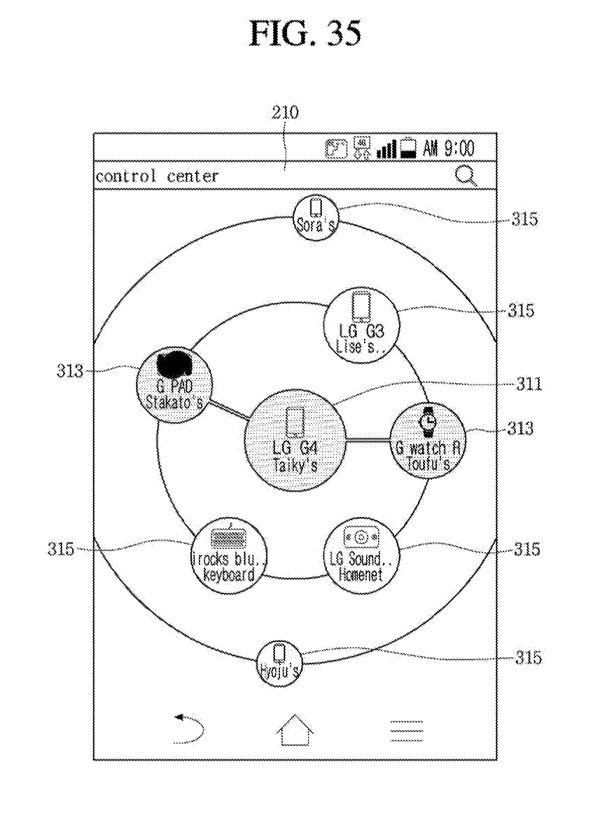

FIGS. 35 to 56 are views illustrating the execution of a control center in a mobile terminal and a control method thereof according to an embodiment of the present invention.

FIG. 35 is a view illustrating a control center in a mobile terminal and a control method thereof according to an embodiment of the present invention.

Referring to FIG. 35, the control center 210 includes a plurality of objects disposed at the center of a concentric circle and on concentric circles. As the control center 210 is executed, the controller 180 performs a control to display a plurality of objects on the display unit 151.

The plurality of objects include a my device object 311 corresponding to my device that is a mobile terminal currently in use and disposed at the center of the concentric circle, an external terminal object 313 corresponding to an external terminal that is connected to the mobile terminal through wireless communication, and a connectable external terminal object 315 that is not connected to the mobile terminal through wireless communication and corresponds to a connectable external terminal.

The connectable external terminal object 315 may include an object corresponding to an external terminal that has a history of being connected to a mobile terminal that is my device and is found but is not currently connected, an object corresponding to an external terminal that has a connected history and is not currently found but found later, and an object corresponding to a found external terminal having no connected history.

The control center 210 provides an interface through which a communication connection setting and a function setting of a connected external terminal or a connectable external terminal are possible based on my device that is the mobile terminal 100 currently in use.

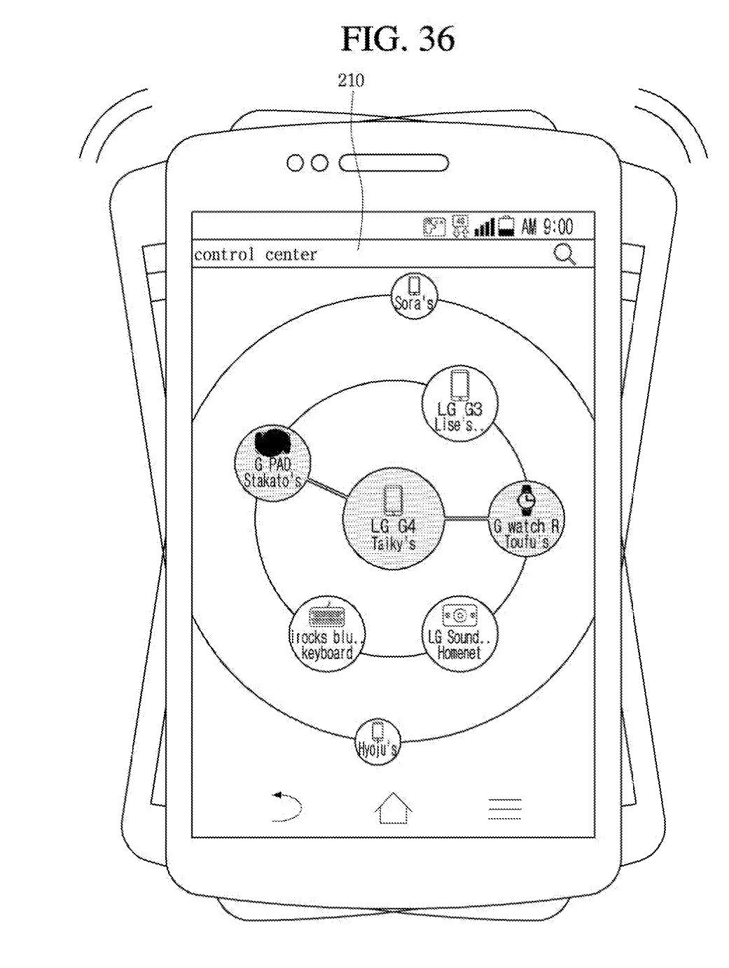

FIGS. 36 to 38 are views illustrating searching external terminals through a control center in a mobile terminal and a control method thereof according to an embodiment of the present invention.

Referring to FIG. 36, when shaking the mobile terminal 100, the acceleration sensor of the sensing unit 140 may detect a movement of the mobile terminal 100 and the controller 180 may search for a surrounding external terminal according to a predetermined setting. According to a search result, a plurality of objects may be rearranged on the control center 210.

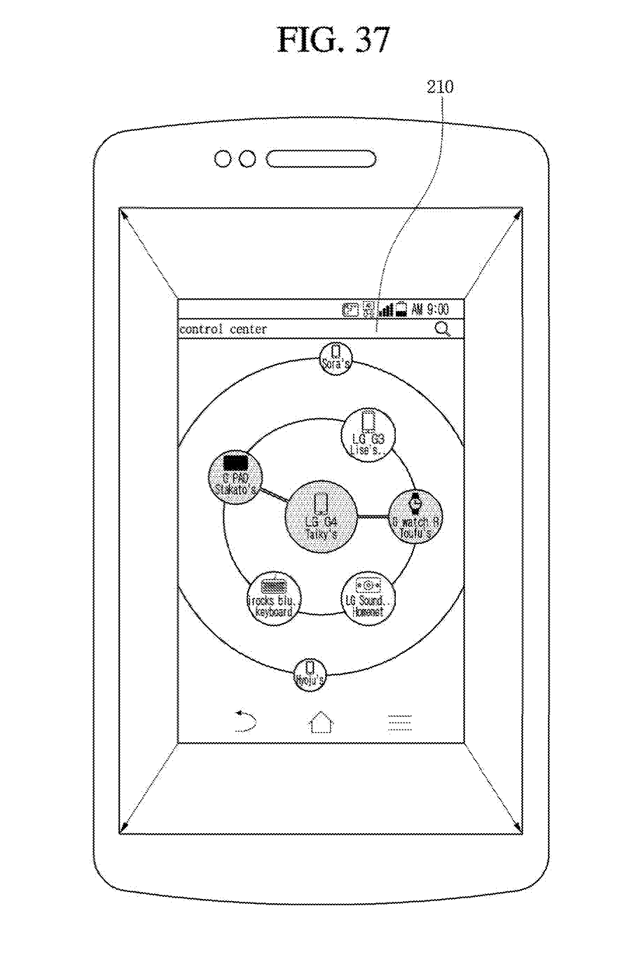

Referring to FIG. 37, when a user executes the control center 210 of the mobile terminal 100, surrounding external terminals may be searched for automatically at the same time. According to a search result, a plurality of objects may be disposed on the control center 210.

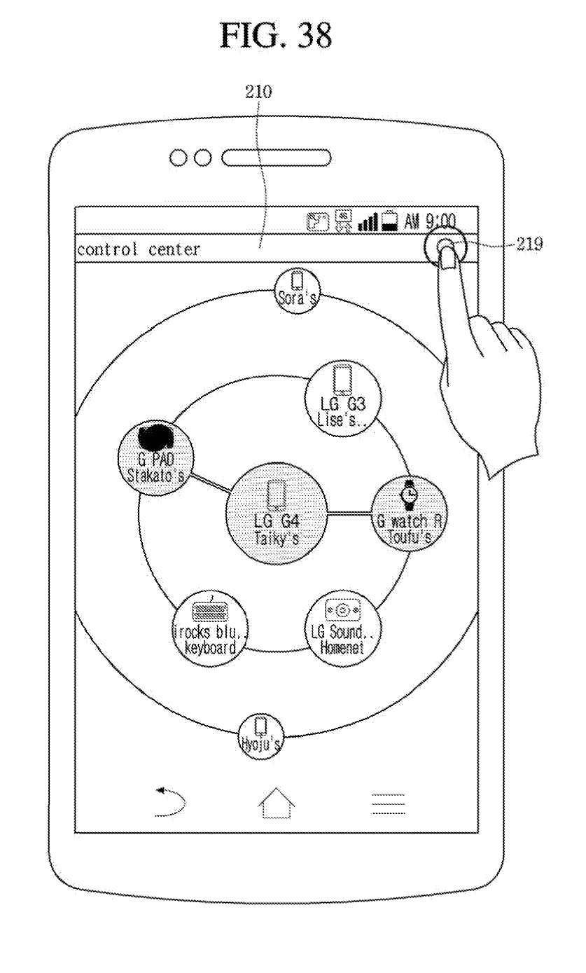

Referring to FIG. 38, after a user executes the control center 210 of the mobile terminal 100, surrounding external terminals may be searched for by touching a surrounding external terminal search key 219 disposed at one side of the control center 210. According to a search result, a plurality of objects may be rearranged on the control center 210.

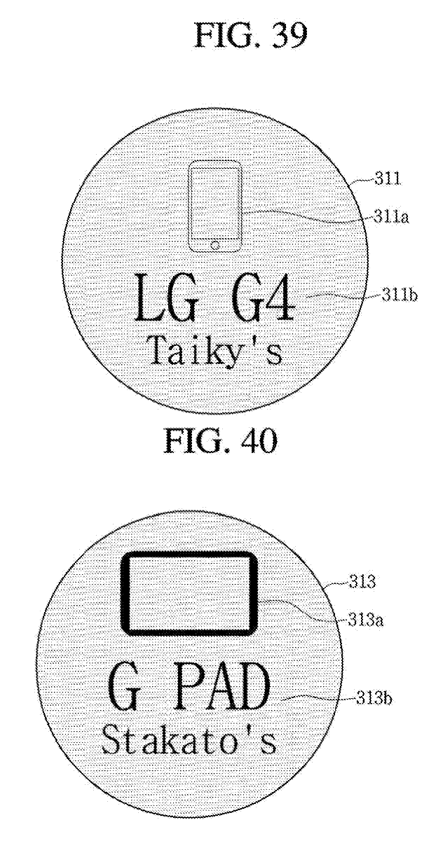

FIGS. 39 to 41 are views illustrating a plurality of objects in a mobile terminal and a control method thereof according to an embodiment of the present invention.

Referring to FIG. 39, a my device object 311 corresponding to my device that is the mobile terminal 100 that a user uses currently displays an image 311a corresponding to my device within the frame of a form without edges, for example, a circular form, and information 311b of my device including the model and name of my device below the image 311a. According to another embodiment of the invention, only the image 311a corresponding to the my device may be displayed within the frame of the circular form and the information 311b of the my device may be displayed below the frame of the circular form.

In relation to the my device object 311, the space within the frame of a circular form may be filled with a specific color. As shown in FIG. 39, the image 311a of a mobile terminal that is my device and information 311b of my device including G4 as a model and Taiky's as a name may be displayed.

Referring to FIG. 40, an external terminal object 313 corresponding to an external terminal that is connected through wireless communication to the mobile terminal 100 that a user uses currently displays an image 313a corresponding to an external device within the frame of a circular form in the same way as the my device object 311 and information 313b of an external terminal including the model and name of an external terminal below the image 313a. According to another embodiment of the present invention, only the image 313a corresponding to the external device may be displayed within the frame of the circular form and the information 313b of the external device may be displayed below the frame of the circular form.

In relation to the external device object 313, the space within the frame of a circular form may be filled with a specific color. For example, in relation to the external terminal object 313 corresponding to an external terminal connected to the mobile terminal 100 through wireless communication, in order for a user to intuitively know being connected through wireless communication, the space within the frame of a circular form may be filled with a specific color and this may be the same color as the my device object 311. As shown in FIG. 40, the image 313a of a tablet that is an external terminal and information 313b of an external terminal including G pad as a model and Stakato' as a name may be displayed.

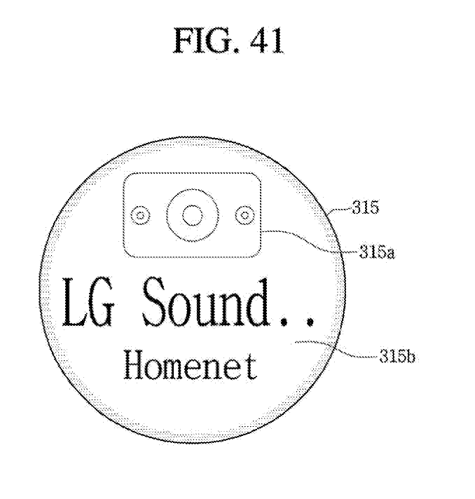

Referring to FIG. 41, the connectable external terminal object 315 that is not connected through wireless communication to the mobile terminal 100 that a user currently uses and corresponds to a connectable external terminal may include an object corresponding to an external terminal that has a history of being connected to the mobile terminal 100 (that is, my device) but is not connected currently, an object corresponding to a connectable external terminal that has a connected history and is not currently found but found later, and an object corresponding to a found external terminal having no connected history. In relation to the connectable external terminal object 315, the color of the frame or the color of the frame inside may vary according to whether search is possible or whether there is a connected history.

As shown in FIG. 41, an object 315 corresponding to an external terminal that has a connected history and is found but not connected currently is displayed.

The connectable external terminal object 315 corresponding to the connectable external terminal displays an image 315a corresponding to an external device within the frame of a circular form in the same way as the my device object 315 and information 315b of an external terminal including the model and name of an external terminal below the image 315a. According to another embodiment of the present invention, only the image 315a corresponding to the external device may be displayed within the frame of the circular form and the information 315b of the external device may be displayed below the frame of the circular form.

In relation to the connectable external terminal object 315, only the frame of a circular form may be filled with a specific color. For example, in relation to the external terminal object 315 corresponding to a connectable external terminal not connected to the mobile terminal 100 through wireless communication, in order for a user to intuitively know not being connected through wireless communication, only the frame of a circular form may be filled with a specific color and the frame inside may not be filled with a specific color. The color of the circular frame may be the same as the my device object 311. As shown in FIG. 41, the image 315a of a speaker that is an external terminal and information 315b of an external terminal including LG SOUND as a model and Homenet as a name may be displayed.

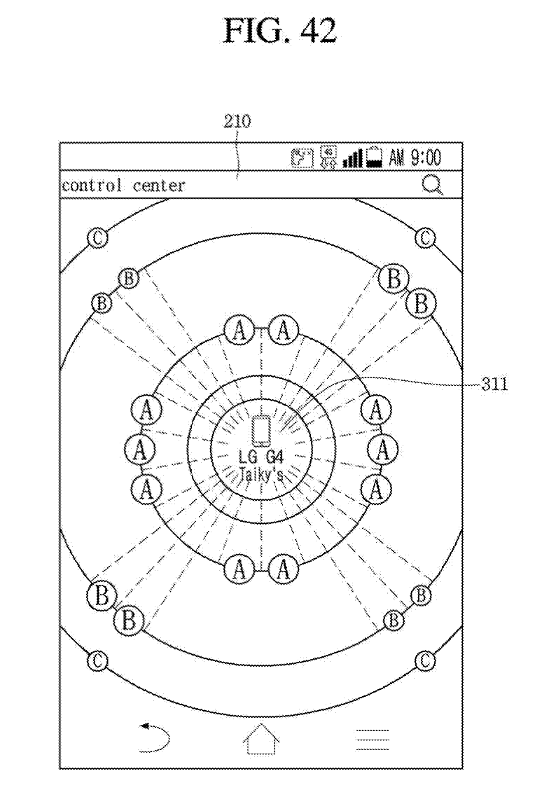

FIG. 42 is a view when a plurality of objects are displayed on a control center in a mobile terminal and a control method thereof according to an embodiment of the present invention.

Referring to FIG. 42, a plurality of objects are displayed on the control center 210. A plurality of objects are disposed on a plurality of concentric circles and a my device object 311 corresponding to my device is displayed at the center of the plurality of concentric circles. The plurality of objects are displayed in A, B, and C for convenience as shown in FIG. 42.

The plurality of objects are respectively disposed on the plurality of concentric circles based on the my device object 311. At this point, an object corresponding to an external terminal having a higher priority is closer to the my device object 311. When there are a plurality of external terminals, an external terminal connected to the mobile terminal 100 that is my device through wireless communication has the highest priority; then, an external terminal that has a history of being connected to the mobile terminal 100 that is my device through wireless communication and is found but is not currently connected has the next higher priority; then, an external terminal that has a history of being connected to the mobile terminal 100 that is my device through wireless communication and is connectable when not found currently but found later has the next higher priority; and lastly, an external terminal having no history of being connected has the lowest priority.

For example, the object A shown in FIG. 42 may be an object corresponding to an external terminal connected to the mobile terminal 100 that is my device through wireless communication or an object corresponding to an external terminal that has a history of being connected to the mobile terminal 100 that is my device through wireless communication and is found but is not connected currently. Additionally, the object B shown in FIG. 42 may be an object that has a history of being connected to the mobile terminal 100 that is my device through wireless communication and is connectable when not currently found but found later. Additionally, the object C shown in FIG. 42 may be an object corresponding to an external terminal having no history of being connected to the mobile terminal 100 that is my device through wireless communication.

The positions of the objects may be set by angles on the concentric circle instead of X and Y coordinates. That is, the objects A may be disposed on a concentric circle based on the my device object 311 and the objects B may be disposed to directly face the my device object 311. That is, the objects A are not disposed between the objects B and the my device object 311. That is, the objects A and B are disposed, only each one within a specific angle range. Herein, a specific angle range may vary depending on the number and arrangement of the objects A and B and may be a plurality of different angle ranges. Unlike what is shown, in the case of the object C, only each one may be disposed within a specific angle range not to overlap the objects A and B.

Since only each of the objects A, B, C is disposed within a specific angle range based on the my device object 311, it is possible for a user to input drag touch to a desired object in the my device object 311 by using a finger. In this case, an object connected to the my device object 311 through drag touch is connected through wireless communication.

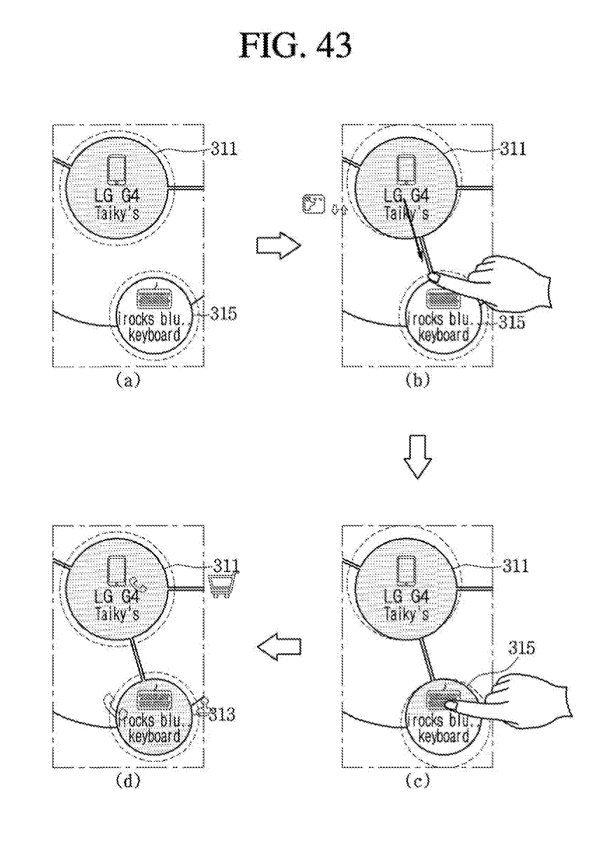

FIGS. 43 to 45 are views of connecting a my device object with a connectable external terminal object through wireless communication in a mobile terminal and a control method thereof according to an embodiment of the present invention.

Referring to FIG. 43, as shown in FIG. 43A, a my device object 311 and a connectable external terminal object 315 disposed on a concentric circle based on the my device object 311 are displayed. The my device object 311 is set to be movable within a circular movement limit range indicated by a dotted line therearound and in the same manner, the connectable external terminal object 315 is set to be movable within a circular movement limit range indicated by a dotted line therearound. The circular movement limit range may be displayed invisible to a user.

As shown in FIG. 43B, a user may input a drag touch from the my device object 311 to the connectable external terminal object 315. At this point, the my device object 311 moving within a movement limit range along a user's drag touch input (move) direction is displayed. In this case, a movement distance of the my device object 311 may be shorter than a movement distance of a user's drag touch input and the movement speed of the my device object 311 may be slower.

As shown in FIG. 43C, when a user's drag touch approaches the connectable external terminal object 315, the connectable external terminal object 315 moves within a movement limit range in a direction that the my device object 311 is disposed, that is, the opposite direction of a drag touch input (move) direction. Then, as a line extending from the my device object 311 according to drag touch is connected, the circular frame inside of the connectable external terminal object 315 is gradually filled with the same color as the my device object 311 and displayed. Through this, a user may intuitively know that a process of connecting wireless communication between the my device object 311 and the connectable external terminal object 315 is in progress.

As shown in FIG. 43D, when the user's drag touch input is terminated, the connectable external terminal object 315 becomes the external terminal object 313 as connected to the my device object 311. The circular frame insides of the my device object 311 and the external terminal object 313 are filled with the same color and the my device object 311 and the external terminal object 313 are disposed at the center of a circular movement limit range.

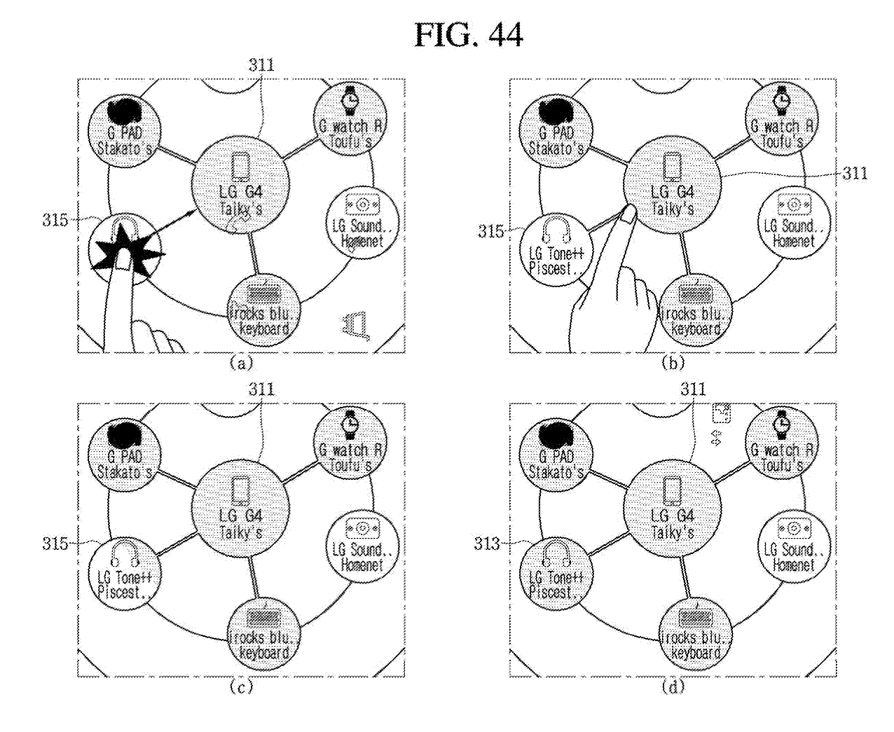

Referring to FIG. 44, in a manner similar to that described with reference to FIG. 43, as shown in FIG. 44A, a user inputs a drag touch from the connectable external terminal object 315 to the my device object 311. As shown in FIG. 44B, a line is connected from the connectable external terminal object 315 to the my device object 311. As shown in FIG. 44C, the circular frame inside of the connectable external terminal object 315 is filled with the same color as the my device object 311. As shown in FIG. 44D, when the user's drag touch input is terminated, the connectable external terminal object 315 becomes the external terminal object 313 as connected to the my device object 311. The circular frame insides of the my device object 311 and the external terminal object 313 are filled with the same color.

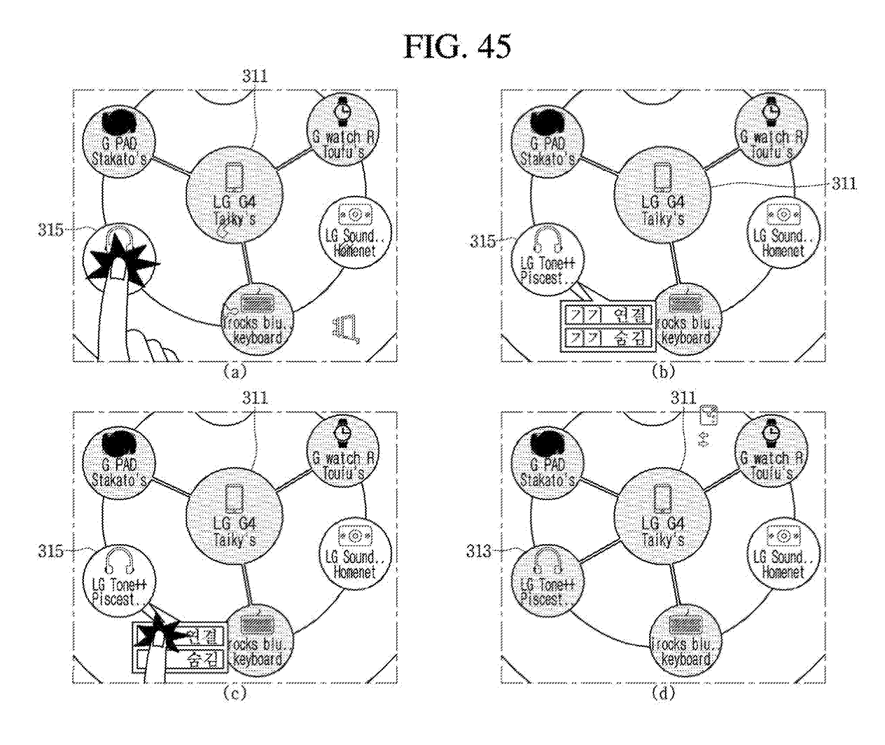

Referring to FIG. 45, when a user inputs a touch to the connectable external terminal object 315 for a predetermined time as shown in FIG. 45A, an executable option item for the connectable external terminal object 315 is displayed as shown in FIG. 45B. For example, the executable option item may be device connection and device hide. The device connection refers to being connected to the my device object 311 and the device hide refers to being invisible from the control center 210. As shown in FIG. 45C, when a user selects the device connection and inputs a touch, the connectable external terminal object 315 becomes the connectable external terminal object 313 and is connected to the my device object 311 as shown in FIG. 45D.

Moreover, as shown in FIGS. 43 to 45, when a user's touch is input through the control center 210 and while the control center 21 is displayed, the controller 180 may perform a control on the wireless communication unit 110 to be connected to an external terminal corresponding to the connectable external terminal object 315 through wireless communication.

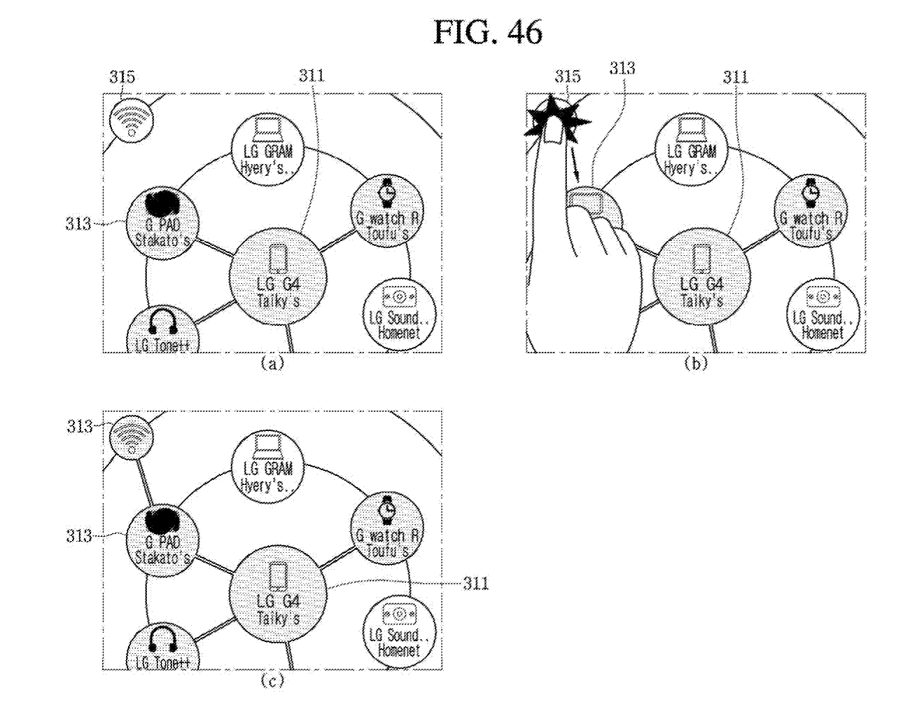

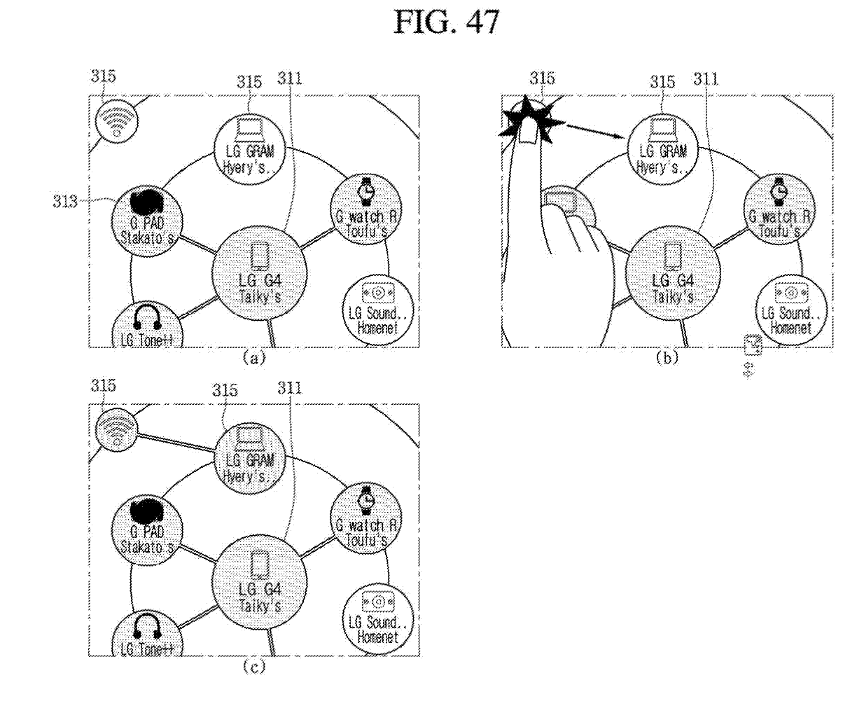

FIGS. 46 and 47 are views illustrating performing a control to connect external terminal objects each other through wireless communication in a mobile terminal and a control method thereof according to an embodiment of the present invention.

Referring to FIG. 46, as shown in FIG. 46A, a my device object 311 and a connectable external terminal object 315 are connected through wireless communication and a connectable external terminal object 315 corresponding to a WiFi device is not connected to the my device object 311 or the external terminal object 313.

As shown in FIG. 46B, when a user inputs a drag touch to connect the connectable external terminal object 315 corresponding to a WiFi device to the external terminal object 313 corresponding to G PAD, as shown in FIG. 46C, the connectable external terminal object 315 is connected to and becomes the external terminal object 313.

That is, as shown in FIG. 46, a user may connect an external terminal connected to the mobile terminal 100 that is my device to another external terminal by using the control center 210. That is, the external terminal object 313 and the connectable external terminal object 315 may be connected to each other through the control center 210. Moreover, while the control center 210 is displayed, as the controller 180 transmits a control command to a G PAD that is the connected external terminal to access the WiFi device through the wireless communication unit 110 and then the G PAD device accesses the WiFi device, the controller 180 allows a wireless communication connection between the G PAD device and the WiFi device actually.

Referring to FIG. 47, as shown in FIG. 47A, the my device object 311 and the external terminal object 313 are connected through wireless communication, and the connectable external terminal object 315 corresponding to a WiFi device and the connectable external terminal object 315 corresponding to a notebook device are not connected to the my device object 311 or the external terminal object 313.

As shown in FIG. 47B, when a user inputs a drag touch to connect the connectable external terminal object 315 corresponding to a WiFi device to the connectable external terminal object 315 corresponding to a notebook device, as shown in FIG. 47C, the connectable external terminal object 315 corresponding to a WiFi device and the connectable external terminal object 315 corresponding to a notebook device are connected to each other.

That is, as shown in FIG. 47, a user may connect the mobile terminal 100 that is my device and an external terminal (for example, a WiFi device) that is not connected through wireless communication to another external terminal (for example, a notebook device) that is not connected to the mobile terminal 100 that is my device.

Moreover, while a user's touch is input through the control center 210 and the control center 210 is displayed, the controller 180 transmits a control command through the wireless communication unit 110 to be connected to the notebook device and allow the notebook device to access the WiFi device. Then, when the notebook device accesses and connects to the WiFi device, the controller 180 may release a wireless connection with the notebook device through the wireless communication unit 110. That is, in order to connect the notebook device and the WiFi device through wireless communication, after temporarily connecting the mobile terminal 100 and the notebook device, once a wireless communication is connected between the notebook device and the WiFi device, the controller 180 disconnects the connection between the mobile terminal 100 and the notebook again.

In this case, the control center 210 may display that the my device object 311 and the connectable external terminal object 315 corresponding to a notebook device are temporarily connected through wireless communication and disconnected. Additionally, the control center 210 may display that the my device object 311 and the connectable external terminal object 315 corresponding to a notebook device are not connected to each other through wireless communication.

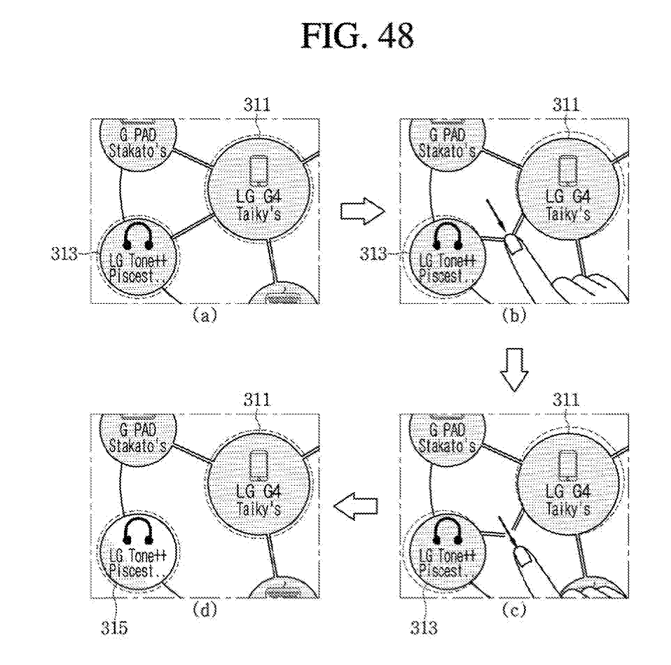

FIGS. 48 to 50 are views of disconnecting a connection through wireless communication between a my device object and an external terminal object in a mobile terminal and a control method thereof according to an embodiment of the present invention.

Referring to FIG. 48, as shown in FIG. 48A, a my device object 311 and an external terminal object 313 disposed on a concentric circle based on the my device object 311 are displayed. The my device object 311 is set to be movable within a circular movement limit range indicated by a dotted line therearound and in the same manner, the external terminal object 313 is set to be movable within a circular movement limit range indicated by a dotted line therearound.

As shown in FIG. 48B, when a user tries to disconnect a communication connection between the mobile terminal 100 corresponding to the my device object 311 and a headset device corresponding to the external terminal object 313, drag touch is input as an operation for cutting off a line connected between the my device object 311 and the external terminal object 313. That is, drag touch is input to cross a line connected between the my device object 311 and the external terminal object 313.

At this point, it is displayed that the my device object 311 and the external terminal object 313 are moved within a movement limit range along a direction that a line is drawn by a user's drag touch input. In this case, movement distances of the my device object 311 and the external terminal object 313 may be shorter than a movement distance of a user's drag touch input and their movement speeds may be slower.

As shown in FIG. 48C, when a line between the my device object 311 and the external terminal object 313 is drawn more than a predetermined range by a user's drag touch, the line is cut off. Through this, a user may intuitively know that a process of disconnecting a connection through wireless communication between the my device object 311 and the external terminal object 313 is in progress.

As shown in FIG. 48D, when the user's drag touch input is terminated, the external terminal object 315 is disconnected from the my device object 311 and becomes the connectable external terminal object 315. The color of the circular frame inside of the connectable external terminal object 315 disappears and the connectable external terminal object 315 is disposed at the center of the circular movement limit range.

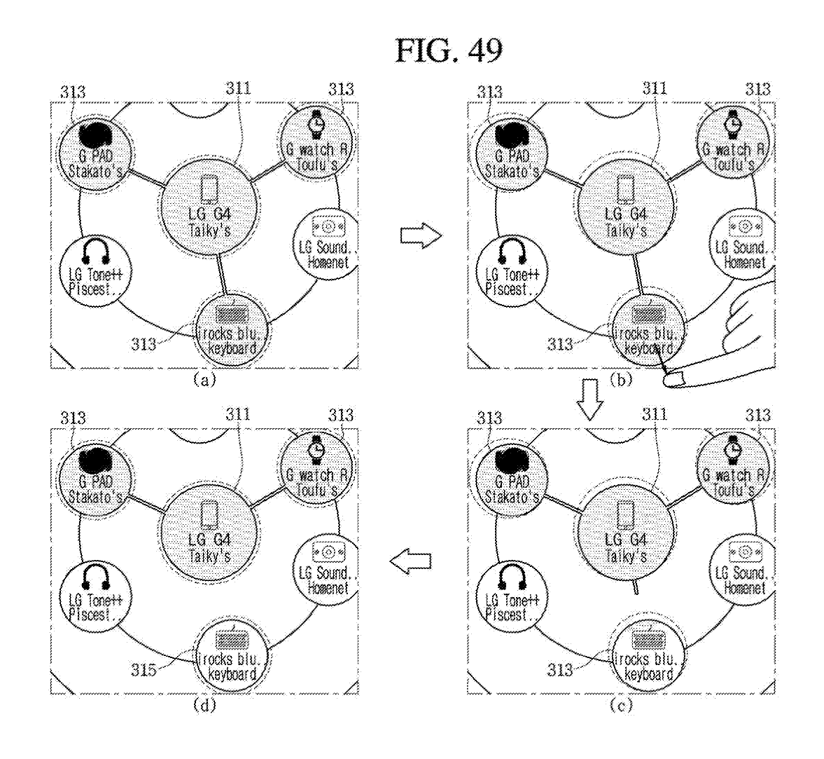

Referring to FIG. 49, as shown in FIG. 48A, a my device object 311 and a plurality of external terminal object 313s disposed on a concentric circle based on the my device object 311 are displayed. The my device object 311 is set to be movable within a circular movement limit range indicated by a dotted line therearound and in the same manner, the external terminal object 313 is set to be movable within a circular movement limit range indicated by a dotted line therearound.

As shown in FIG. 49B, when a user inputs a drag touch for the external terminal object 313 corresponding to a keyboard device that is one of the plurality of external terminal objects 313, the external terminal object 313 corresponding to the keyboard device is drawn along the input direction of drag touch is drawn, and the my device object 311 and the plurality of external terminal objects 313 connected to the external terminal object 313 corresponding to the keyboard through a line are drawn together.

As shown in FIG. 49C, when a line between the my device object 311 and the external terminal object 313 is drawn more than a predetermined range by a user's drag touch, the line is cut off. Through this, a user may intuitively know that a process of disconnecting a connection through wireless communication between the my device object 311 and the external terminal object 313 is in progress.

As shown in FIG. 49D, when the user's drag touch input is terminated, the external terminal object 313 is disconnected from the my device object 311 and becomes the connectable external terminal object 315. The color of the circular frame inside of the connectable external terminal object 315 disappears and the connectable external terminal object 315 is disposed at the center of the circular movement limit range.

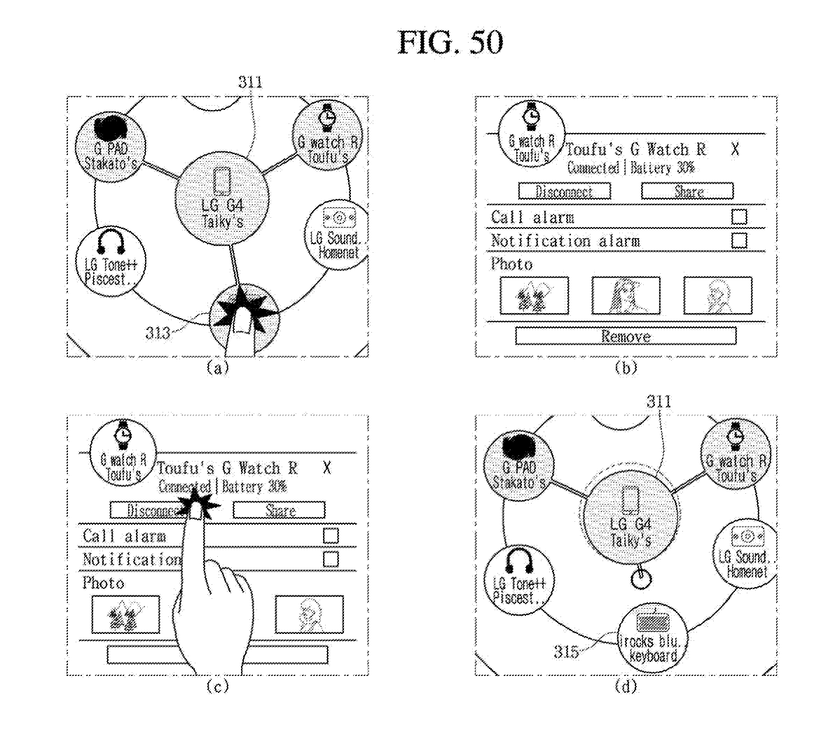

Referring to FIG. 50, when a user inputs a touch to the external terminal object 313 for a predetermined time as shown in FIG. 50A, an executable option item for the external terminal object 313 is displayed as shown in FIG. 50B. For example, the executable option item may be disconnect and share. As shown in FIG. 50C, when a user selects disconnect and inputs a touch, as shown in FIG. 50D, the external terminal object 313 becomes the connectable external terminal object 313 and is disconnected from the my device object 311.

Moreover, as shown in FIGS. 48 to 50, when a user's touch is input through the control center 210 and while the control center 21 is displayed, the controller 180 may perform a control on the wireless communication unit 110 to disconnect a wireless communication connection with an external terminal corresponding to the external terminal object 313.

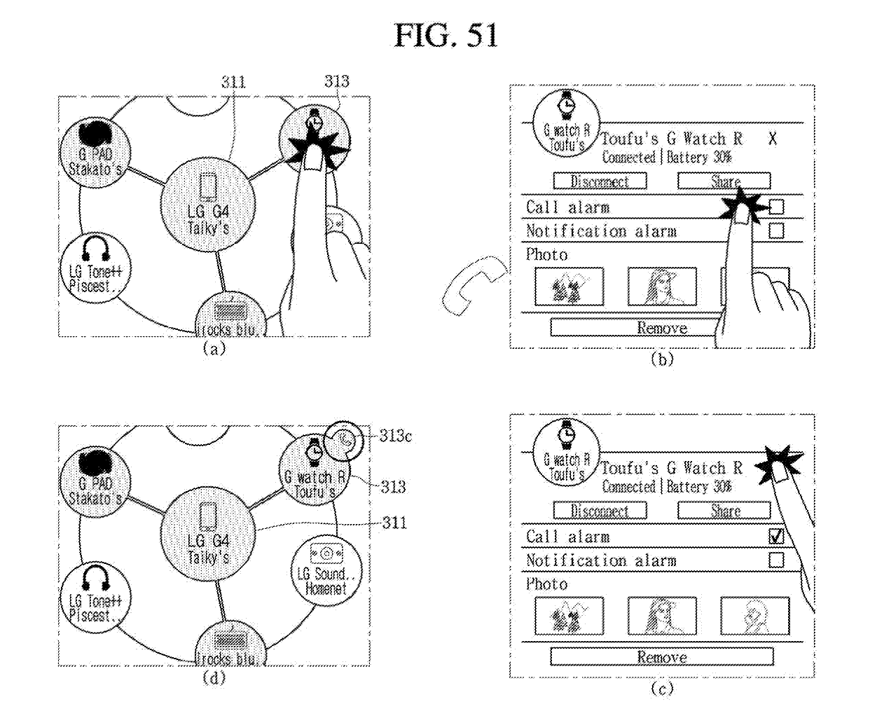

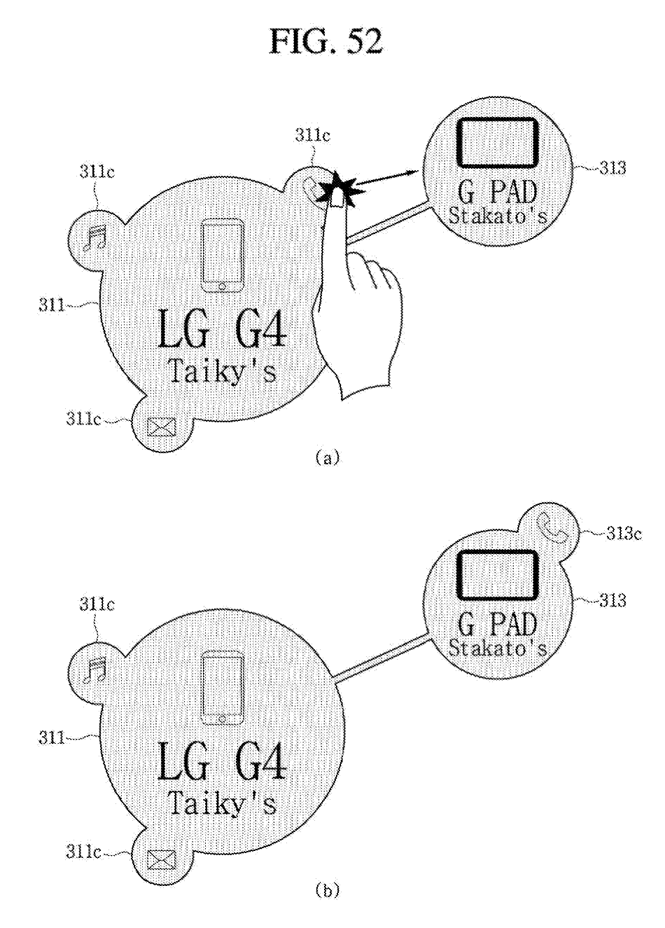

FIGS. 51 and 52 are views of transferring some functions of a mobile terminal that is my device to an external terminal in a mobile terminal and a control method thereof according to an embodiment of the present invention.

Referring to FIG. 51, when a user inputs a touch to the external terminal object 313 for a predetermined time as shown in FIG. 51A, a transferable function item for the external terminal object 313 is displayed as shown in FIG. 51B. For example, the transferable function item may be call alarm and notification alarm. When a user selects call alarm and inputs a touch and closes a screen where the transferable function item is displayed as shown in FIG. 51C, a transferable function display 313c is displayed on the external terminal object 313 as shown in FIG. 51D. That is, when a phone call is received through the mobile terminal 100, call alarm that is a function of the mobile terminal 100 is transferred to a G watch device corresponding to the external terminal object 313 and is executed in the G watch device. That is, when a phone call is received through the mobile terminal 100, the controller 180 may perform a control to transmit call alarm to the G watch device connected to the mobile terminal 100 through wireless communication by controlling the wireless communication unit 110.

Referring to FIG. 52, in a manner different from that described with reference to FIG. 51, as shown in FIG. 52A, when a drag touch is input from one among a plurality of transferable function displays 311c formed on the my device object 311 to the external terminal object 313, as shown in FIG. 52B, the transferable function display 311c formed on the my device object 311 disappears and is formed on the external terminal object 313 as the transferable function display 313c.

As shown in FIG. 52, the my device object 311, as the transferable function display 311c, has call alarm, message alarm, and music playback functions and the call alarm function is transferred to the external terminal object 313. That is, when a phone call is received through the mobile terminal 100, call alarm that is a function of the mobile terminal 100 is transferred to a G PAD device corresponding to the external terminal object 313 and is executed in the G PAD device. That is, when a phone call is received through the mobile terminal 100, the controller 180 may perform a control to transmit call alarm to the G PAD device connected to the mobile terminal 100 through wireless communication by controlling the wireless communication unit 110.

Moreover, as shown in FIGS. 51 and 52, when a user's touch is input through the control center 210 and while the control center 21 is displayed, the controller 180 may set an external terminal corresponding to the external terminal object 313 to execute the selected transferable function by controlling the wireless communication unit 110.

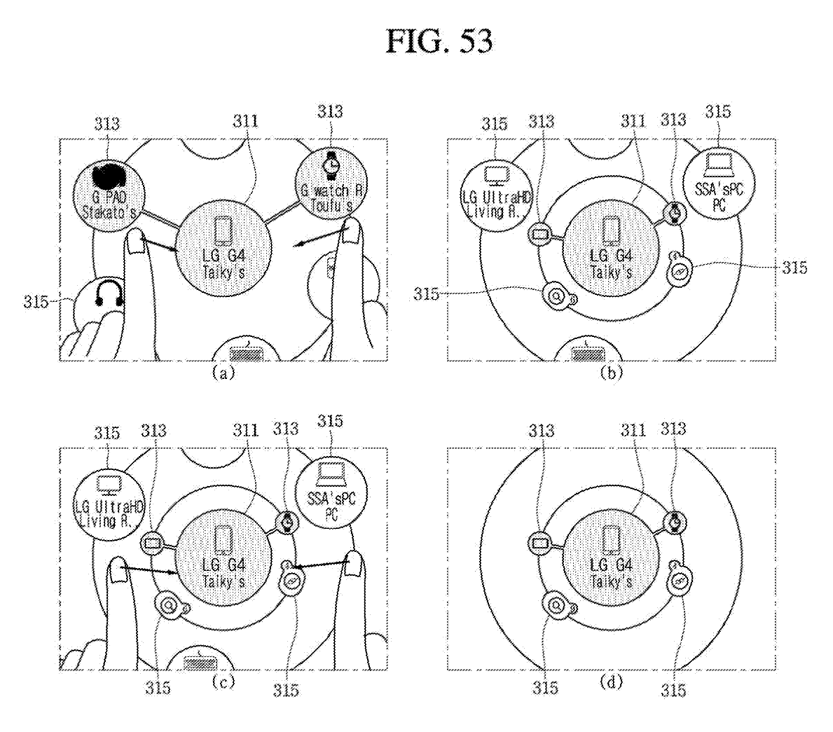

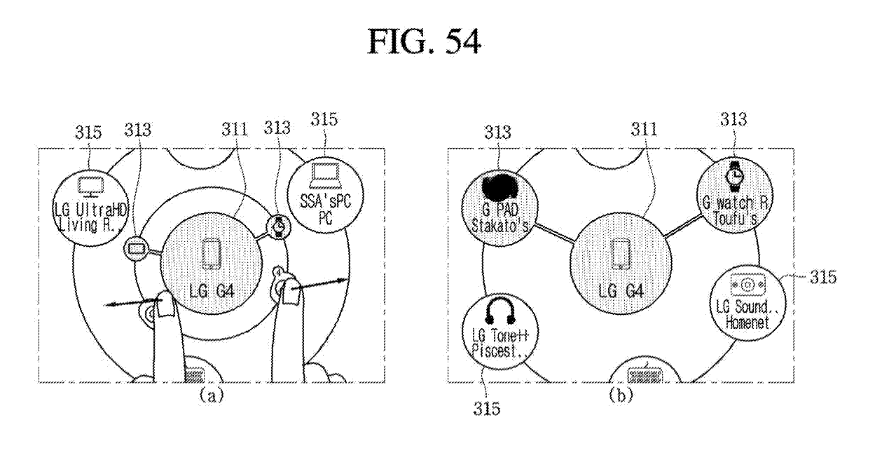

FIGS. 53 and 54 are views illustrating pinch-in touch input and pinch-out touch input through a control center in a mobile terminal and a control method thereof according to an embodiment of the present invention.

Referring to FIG. 53, as shown in FIG. 53A, a plurality of objects are displayed on the control center 210. The plurality of objects include a my device object 311 corresponding to my device that is a mobile terminal currently in use and disposed at the center of the concentric circle, an external terminal object 313 corresponding to an external terminal that is connected to the mobile terminal through wireless communication, and a connectable external terminal object 315 that is not connected to the mobile terminal through wireless communication and corresponds to a connectable external terminal. When a user inputs pinch-in touch to the control center 210, as shown in FIG. 53B, as the control center 210 is reduced based on the my device object 311, the external terminal object 313 and the connectable external terminal object 315, which are disposed on a concentric circle that is the most adjacent to the my device object 311, are reduced and displayed.

Since the external terminal object 313 is connected to the my device object 311, an image corresponding to each external terminal may be displayed and the connectable external terminal object 315 may be classified according to whether search is possible and whether a connection history is included so that its total number is displayed in number.

For example, the connectable external terminal object 315 may be divided into an object corresponding to an external terminal that has a history of being connected to a mobile terminal that is my device and is found but is not currently connected and an object corresponding to an external terminal that has a connected history and is connectable if not currently found but found later and then bundled to be displayed.

As shown in FIG. 53C, when a user inputs pinch-in touch again to the control center 210, as shown in FIG. 53D, as the control center 210 is reduced based on the my device object 311, the connectable external terminal object 315, which is disposed on a concentric circle, is reduced and displayed at the my device object 311.

In this case, an object corresponding to a found external terminal having no connected history and an object corresponding to a connectable external terminal that has a connected history and is not found currently but is found later are bundled together and displayed.

Although not shown in the drawings, when a user inputs pinch-in touch to the control center 210 again, it returns to an original state shown in FIG. 53A and is displayed.

As shown in FIG. 54A, when a user inputs pinch-out touch to the control center 210 in a state of FIG. 53C, it returns to an initial state as shown in FIG. 54B and the external terminal object 313 and the connectable external terminal object 315, which are disposed on a concentric circle that is the most adjacent to the my device object 311, are displayed again.

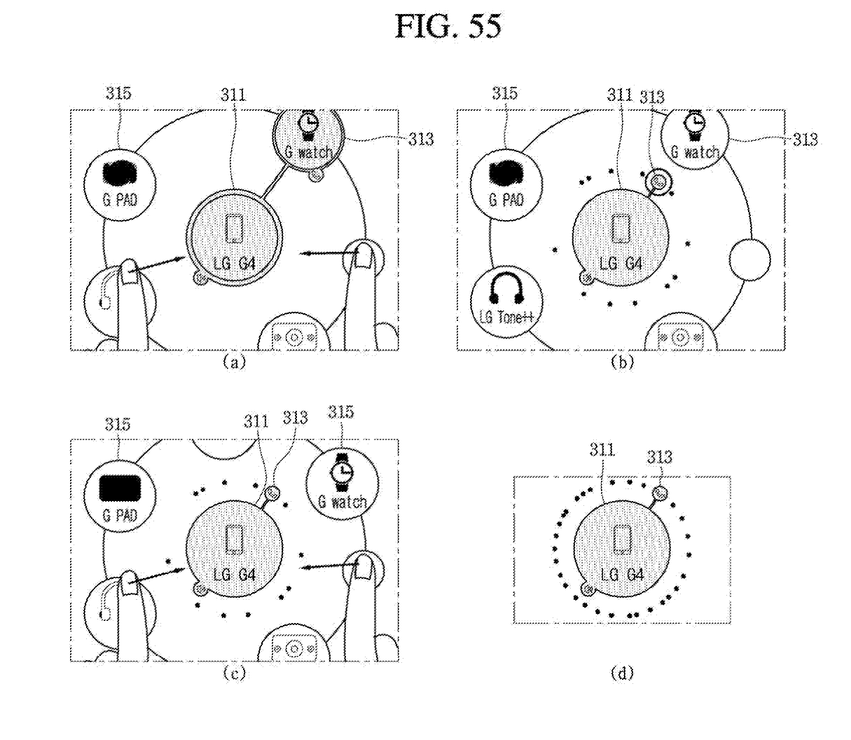

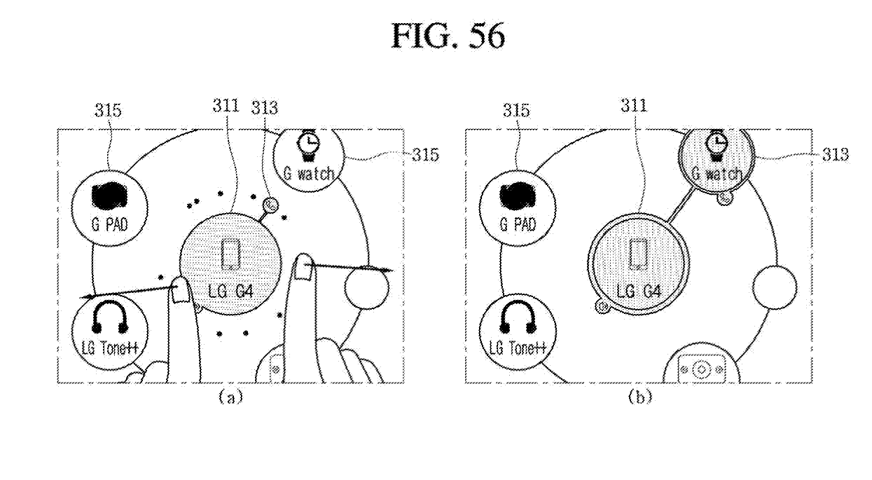

FIGS. 55 and 56 are views illustrating pinch-in touch input and pinch-out touch input through a control center in a mobile terminal and a control method thereof according to another embodiment of the present invention.

Referring to FIG. 55, as shown in FIG. 55A, a plurality of objects are displayed on the control center 210. The plurality of objects include a my device object 311 corresponding to my device that is a mobile terminal currently in use and disposed at the center of the concentric circle, an external terminal object 313 corresponding to an external terminal that is connected to the mobile terminal through wireless communication, and a connectable external terminal object 315 that is not connected to the mobile terminal through wireless communication and corresponds to a connectable external terminal. When a user inputs pinch-in touch to the control center 210, as shown in FIG. 55B, as the control center 210 is reduced based on the my device object 311, the external terminal object 313 and the connectable external terminal object 315, which are disposed on a concentric circle that is the most adjacent to the my device object 311, are reduced and displayed.

Since the external terminal object 313 is connected to the my device object 311, an image corresponding to an external terminal may be displayed and the connectable external terminal object 315 may be displayed as a dot or a small circle.

As shown in FIG. 55C, when a user inputs pinch-in touch again to the control center 210, as shown in FIG. 55D, as the control center 210 is reduced again based on the my device object 311, the connectable external terminal object 315, which are disposed on a concentric circle, is reduced and displayed at the my device object 311 as a dot or a small circle.

Although not shown in the drawings, when a user inputs pinch-in touch to the control center 210 again, it may return to an original state shown in FIG. 55A and may be displayed.

As shown in FIG. 56A, when a user inputs pinch-out touch to the control center 210 in a state of FIG. 55C, it returns to an initial state as shown in FIG. 56B and the external terminal object 313 and the connectable external terminal object 315, which are disposed on a concentric circle that is the most adjacent to the my device object 311, are displayed again.

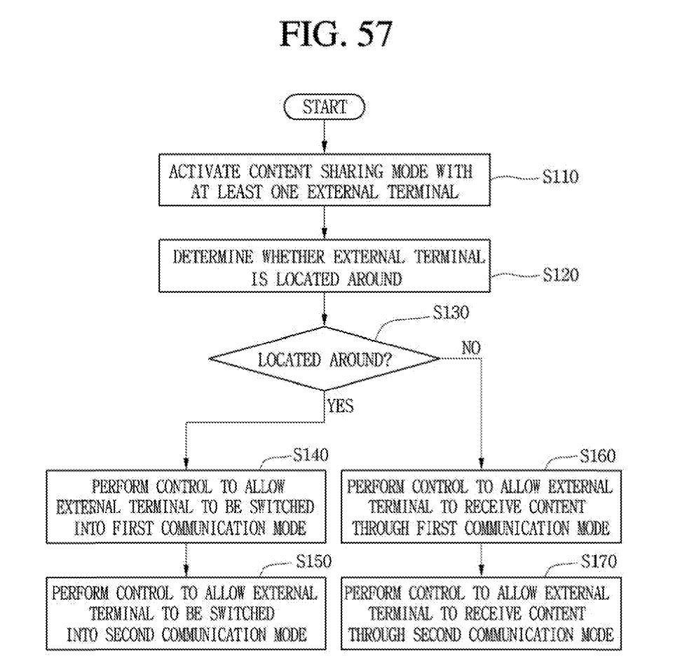

FIG. 57 is a flowchart illustrating a control process of a mobile terminal according to an embodiment of the present invention.

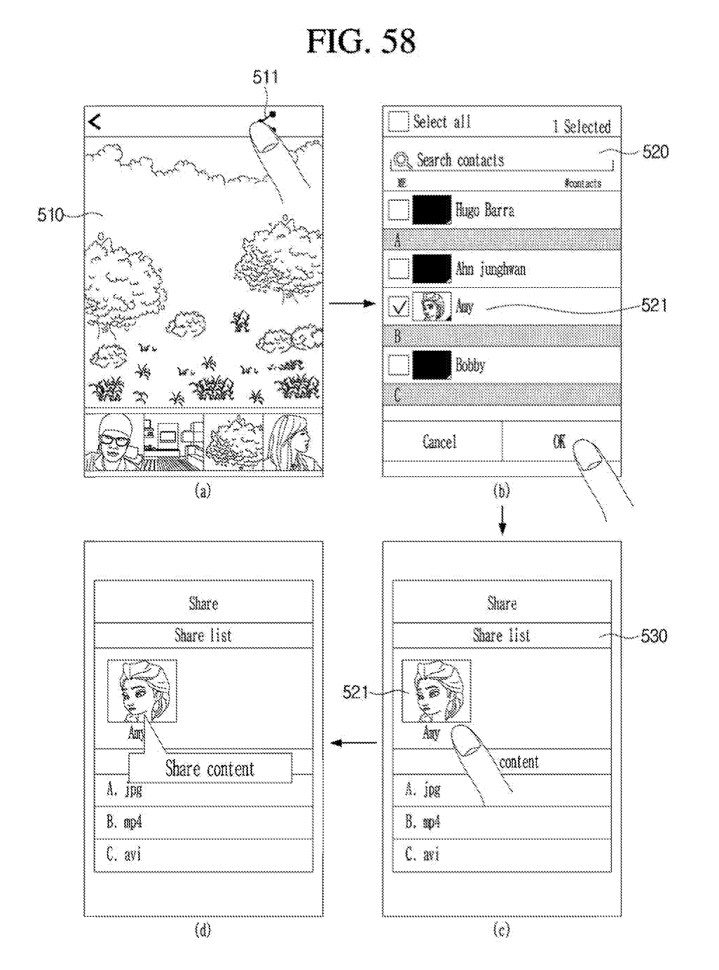

FIGS. 58 to 74 are views illustrating a control process of a mobile terminal according to an embodiment of the present invention.

Referring to FIGS. 57 to 74, when activating a sharing mode for sharing at least one content with at least one external terminal in operation S110, the controller 180 of the mobile terminal 100 determines whether the external terminal is located around the mobile terminal 100 by using the wireless communication unit 110 in operation S120.

In more detail, in operation S120, the controller 180 may determine an external terminal that satisfies the following conditions as an external terminal located around the mobile terminal 100.

1. at least one external terminal disposed with a predetermined radius: at this point, when a user sets the predetermined radius by using at least one of a specific distance (for example, within 10 m) and an address (Gasan-dong), the controller 180 may determine at least one external terminal disposed within the predetermined radius as an external terminal located around the mobile terminal 100.

2. at least one Bluetooth connectable external terminal: the controller 180 may determine at least one Bluetooth connectable external terminal supported through the short range communication module 114 as an external terminal located around the mobile terminal 100.

That is, once Bluetooth is activated, the controller 180 may search for at least one external terminal around the mobile terminal 100 through the short range communication module 114 and may determine the at least one found external terminal as an external terminal located around the mobile terminal 100. At this point, the controller may designate an external terminal selected by a user from the found external terminals or registered in a contact as a terminal sharing content with the mobile terminal 100.

At this point, according to an embodiment of the present invention, the mobile terminal 100 and the external terminal may include the Bluetooth 4.0 version with low energy consumption (Bluetooth Low Energy) and the mobile terminal 100 and the external terminal may activate Bluetooth at all times in order for the mobile terminal 100 to detect whether the external terminal is located around at all times.

Additionally, according to an embodiment of the present invention, the Bluetooth becomes a communication channel through which the mobile terminal 100 transmits signals for controlling operations to the external terminal and receives information representing the current state of the external terminal from the external terminal.

3. at least one WiFi connectable external terminal: the controller 180 may determine at least one WiFi Direct connectable external terminal through the wireless internet module 113 or the short range communication module 114 as an external terminal located around the mobile terminal 100.

4. at least one external terminal accessing the same wireless AP: the controller 180 may determine at least one external terminal accessing the same wireless AP as the mobile terminal 100 through the wireless internet module 113 as an external terminal located around the mobile terminal 100.

5. at least one external terminal accessing a home network system: the controller 180 may determine at least one external terminal accessing the same home network system (for example, DLNA) as the mobile terminal 100 through the wireless internet module 113 or the short range communication module 114 as an external terminal located around the mobile terminal 100.

6. at least one external terminal connected through ultra short range communication: the controller 180 may determine at least one external terminal connected to the mobile terminal 100 through ultra short range communication with ultra close or in contact as an external terminal located around the mobile terminal 100. As one example, as a communication method using NFC as the ultra short range communication, when recognizing the NFC module of the external terminal through NFC in the short range communication module 114, the controller 180 may determine that the external terminal is located around the mobile terminal 100.

Moreover, the controller 180 may receive the location information of the external terminal through the wireless communication unit 110 and if the external terminal is disposed within a predetermined radius based on the current location obtained through the location information module 115, may determine that the external terminal is located around the mobile terminal 100.

Moreover, the content may include all data executable on the mobile terminal 100, providing a specific function to a user, selectable by a user, or providing specific information.

In more detail, the content may include at least one of a contact item, a contact list containing contact items, a call/message transmission/reception history, an application, a video file, a sound file, a document file, an image file, a bulletin registered on a webpage, a widget, a menu, a folder, and a multimedia.

Moreover, when the sharing mode is activated, the controller 180 may receive a setting for at least one external terminal sharing at least one content from a user.

In more detail, when the sharing mode is activated, the controller 180 may display a contact list and may set an external terminal corresponding to at least one contact selected from the contact list as a sharing target of the content.

Additionally, when the sharing mode is activated, the controller 180 may display a list including at least one external terminal that shares content previously and may at least one external terminal selected from the list as a sharing target of the content.

Additionally, when the sharing mode is activated, the controller 180 may display a list including at least one external terminal that is communicatively and previously connected to at least one of Bluetooth, WiFi Direct, NFC, the same wireless AP as a sharing target of the content as a sharing target of the content.

Additionally, the controller 180 may set at least one external terminal selected by a user from at least one external terminal registered in a contact, at least one predetermined external terminal, at least one external terminal belonging to a predetermined group, at least one external terminal having a recent short range communication connection history, at least one external terminal having a recent content sharing history, and at least one external terminal set as a preferred target as a sharing target of the content.

At this point, the controller 180 may perform an operation for recommending an external terminal not performing any operation at a location close to the mobile terminal 100, a WiFi Direct connectable external terminal at a close location, an external terminal having a recent content sharing history at a close location, or an external terminal registered in a contact list of the mobile terminal 100 at a close location, as the optimized sharing target. In this case, the controller 180 may display at least one external terminal recommended as the optimized sharing target as an item form on a screen or may display the at least one external terminal in a corresponding list distinctively.

As mentioned above, when it is determined in operation S130 that the external terminal is located around, the controller 180 performs a control to allow the external terminal to switch its communication mode into a first communication mode in operation S140 and after the external terminal is switched into the first communication mode, performs a control to transmit content to be shared and allow the external terminal to receive the content through the switched first communication mode in operation S150.

Additionally, when it is determined in operation S130 that the external terminal is not located around, the controller 180 performs a control to allow the external terminal to switch its communication mode into a second communication mode in operation S160 and after the external terminal is switched into the second communication mode, performs a control to transmit content to be shared and allow the external terminal to receive the content through the switched second communication mode in operation S170.

Moreover, the controller 180 may command the external terminal to switch the current communication mode into the first or second communication mode by using a BLE signal of the Bluetooth 4.0 version.

In more detail, when the external terminal is located around, the controller 180 transmits BLE signals including a syntax for requesting the activation of the first communication mode to the external terminal through the short range communication module 114, and when receiving BLE signals including a syntax for notifying the activation of the first communication mode from the external terminal, transmits content to be shared to the external terminal through the first communication mode.

In more detail, when the external terminal is not located around, the controller 180 uploads the content to be shared to a cloud server through a user account and transmits BLE signals including the download URL address information of the uploaded content to the external terminal. Then, the external terminal downloads the content from the cloud server based on the content download URL address information in the received BLE signals.

As one example, FIG. 58 illustrates a process for setting an external terminal sharing content.

That is, as shown in FIG. 58A, while specific content 510 is displayed on a screen, if an icon 511 allocated for a sharing mode activation function is selected, the controller 180 activates a sharing mode, and as shown in FIG. 58B, displays a contact list 520. If at least one contact 521 is selected from the contact list, as shown in FIG. 58C, the controller 180 sets an external terminal corresponding to the selected contact 521 as a sharing target of the content and displays an item of the selected contact 521 in a sharing target list 530.

Then, when an item of the contact 521 is selected, as shown in FIG. 58D, the controller 180 performs a control to allow an external terminal to receive the content 510 according to whether the external terminal corresponding to the contact 521 is close.

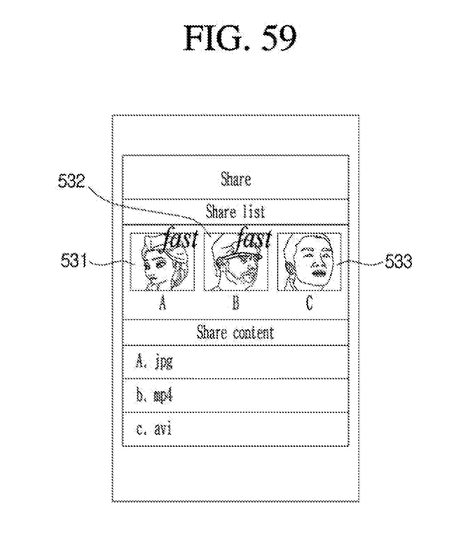

On the other hand, as shown in FIG. 59, when two or more external terminals 531, 532, and 533 are registered in the sharing target list 530, the controller 180 may arrange and display the external terminals in the sharing target list 530 preferentially in the order of at least one of a proximity ranking, a recent short range communication connection frequency, and a recent content sharing history frequency.

Additionally, the controller 180 may display an external terminal disposed at a short distance distinctively from the remaining in the sharing target list 530 and as one example, it is displayed in FIG. 59 that the first and second external terminals 531 and 532 are disposed close to the mobile terminal 100 and a text “fast” is disposed on items of the first and second external terminals 531 and 532.

Additionally, the controller 180 may delete at least one external terminal selected by a user among the external terminals 531, 532, and 533 from the sharing target list 530. Additionally, the controller 180 may change at least one of the representative image, icon form, and name of at least one external terminal selected by a user among the external terminals 531, 532, and 533 according to a user's setting.

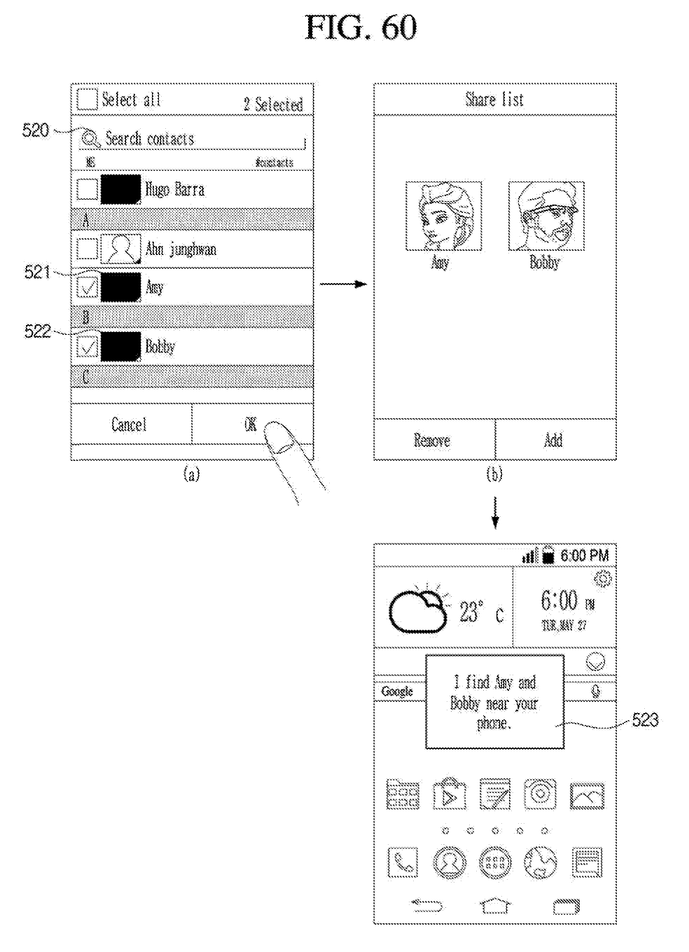

Then, as shown in FIG. 60, when an external terminal set as a sharing target is located around, the controller 180 may notify this to a user.

As shown in FIG. 60A, when contacts 521 and 522 are selected from the contact list 520, as shown in FIG. 60B, the controller 180 sets external terminals corresponding to the selected contacts 521 and 522 as a sharing target of the content and displays items representing external terminals corresponding to the selected contacts 521 and 522 in a sharing target list.

Then, as shown in FIG. 60C, when receiving BLE signals from at least one external terminal among the external terminals registered in the sharing target list, the controller 180 recognizes that an external terminal transmitting the BLE signals is located around the mobile terminal 100 and displays information 523 representing that the external terminal transmitting the BLE signals is located around the mobile terminal 100.

As one example, when children's contacts are registered in the sharing target list and children are close to a user (for example, a house), the user may recognize that the children are coming to the surrounding of the user through the information 523.

As another example, after meeting people are registered in the sharing target list during a meeting, if the meeting people are coming to near a meeting place of a user, the user may recognize that the meeting people are near the meeting place currently through the information 523.

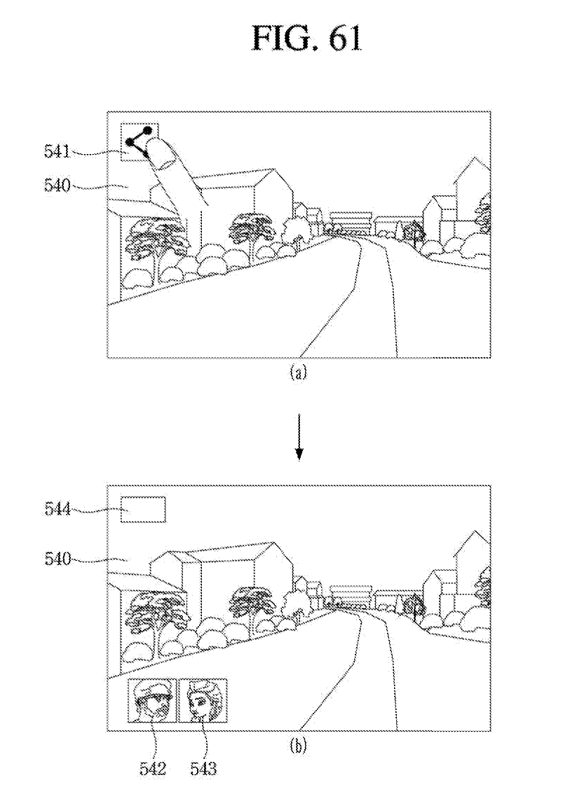

Then, as shown in FIG. 61, the controller 180 may share a preview image of a camera with at least one external terminal.

That is, as shown in FIG. 61A, while the camera 121 is activated and a preview image 540 received through the camera 121 is displayed, if an icon 541 allocated for a sharing mode activation function is selected, the controller 180 activates a sharing mode, and as shown in FIG. 61B, searches for the external terminals 542 and 543 located around the mobile terminal 100 among external terminals corresponding to contacts registered in a contact list and displays items of the found external terminals 542 and 543.

Then, when one of the items of the external terminals 542 and 543 is selected, an external terminal corresponding to the selected item requests to activate the first communication mode and then, when the external terminal activates the first communication mode, a preview image 540 received in real time through the camera 121 is transmitted in a streaming form to the external terminal in real time and the external terminal receives and displays the real-time transmitted preview image.

Additionally, regardless of the selection operation of the icon 541, when the camera 121 is activated and the preview image 540 is received and displayed, the controller 180 may automatically searches for the external terminals 542 and 543 located around the mobile terminal 100 and then may display items of the found external terminals 542 and 543.

Then, when each of the mobile terminal 100 and the selected external terminal is activated in the first communication mode, the controller 180 may display a send button 544 distinctively in order for a user to press the send button 544 displayed in the preview image 540, and when the send button 544 is pressed, transmit the preview image 540 received in real time through the camera 121 to the selected external terminal in real time in a streaming form.

Additionally, after the preview image 540 displayed when the icon 541 is selected is captured as a picture, if one of the items of the external terminals 542 and 543 is selected, the controller 180 requests an external terminal corresponding to the selected item to activate the WiFi Direct communication mode, and when the external terminal activates the WiFi Direct communication mode, transmits the captured picture to the external terminal through the WiFi Direct communication mode.

Additionally, when each of the mobile terminal 100 and the external terminal is activated in the WiFi Direct communication mode and at least one image is captured from the preview image 540, the controller 180 may display the send button 544 distinctively in order for a user to press the send button 544 displayed in the preview image 540, and when the send button 544 is pressed, transmit the captured image to the external terminal in real time. At this point, before the send button 544 is pressed, the controller 180 may display the captured image in a thumbnail form of preview on the preview image 540.

Additionally, when each of the mobile terminal 100 and the external terminal is activated in the WiFi Direct communication mode and two or more images are captured from the preview image 540 through the burst shoot of the camera 121, the controller 180 may integrate the captured images and display the send button 544 distinctively in order for a user to press the send button 544 displayed in the preview image 540, and when the send button 544 is pressed, transmit the integrated image to the external terminal in real time. At this point, before the send button 544 is pressed, the controller 180 may display the integrated image in a thumbnail form of preview on the preview image 540.

Additionally, without the selection of the icon 541, when the camera 121 is activated, the controller 180 may recognize at least one external terminal located around the current mobile terminal 100 among external terminals registered in a contact as a sharing target and may display the items 542 and 543 of the at least one external terminal, or may recognize at least one external terminal having a history of sharing content at least once with the mobile terminal 100 among external terminals located around the current mobile terminal 100 in the same application (for example, “camera” in FIG. 61) as a sharing target and display the items 542 and 543 of the at least one external terminal.

At this point, when one of the items 542 and 543 is selected, the controller 180 may capture a preview image displayed when the item is selected, as an image and transmit the captured image to an external terminal corresponding to the selected item.

Additionally, when one of the items 542 and 543 is selected and capturing for a preview image progresses by a user and a capturing state for the current preview image satisfies a predetermined condition, the controller 180 may capture an image from a preview image and request an external terminal corresponding to the selected item to activate the first communication mode, and when the external terminal activates the first communication mode, transmit the captured picture to the external terminal through the first communication mode.

As one example, the predetermined condition includes a capturing target change and when a capturing target is changed into a second subject by a user while a first subject is captured continuously, the controller 180 may capture an image including the changed capturing subject and transmit the captured picture to the external terminal through the first communication mode.

As another example, the predetermined condition includes a capturing position change and when it is detected through the location information module 115 that a capturing position is changed from a first location where continuous capturing is performed into a second location by a user, the controller 180 may capture an image from a preview image at the changed second location and transmit the captured picture to the external terminal through the first communication mode. At this point, the second location may include a place preset by a user. Additionally, the first and second locations may include locations corresponding indoor or outdoor (or the opposite) and in this instance, it is detected whether the current location is indoor or outdoor based on an ambient illumination detected through the illumination sensor 142.

As another example, the predetermined condition includes a motion change of the mobile terminal 100, and while a picture is captured by a user, if a predetermined motion gesture is detected through a motion sensor in the sensing unit 140, or if a motion gesture is detected more than a predetermined motion amount, or if a speed of more than a predetermined speed amount is detected through an acceleration sensor in the sensing unit 140, the controller 180 may capture an image from a preview image and transmit the captured picture to the external terminal through the first communication mode.

As another example, the predetermined condition includes a screen state change of the mobile terminal 100, and while a picture is captured by a user, if a key (for example, a home key, a cancel key, and so on) for turning off the preview screen is input or if the preview screen is turned off automatically because there is no operation for a predetermined time, the controller 180 may capture an image from a preview image right before the preview screen is turned off and transmit the captured picture to the external terminal through the first communication mode.

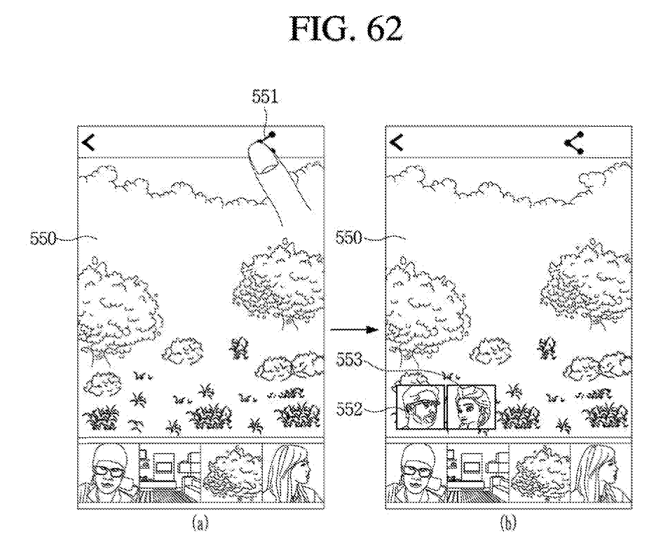

Then, as shown in FIG. 62, the controller 180 may share a specific image displayed in a gallery screen with at least one external terminal.

That is, as shown in FIG. 62A, when a gallery function is activated, the controller 180 displays an image 550 selected by a user among images stored in the mobile terminal 100 in a gallery screen, and when an icon 551 allocated for a sharing mode activation function is selected, activates a sharing mode, and as shown in FIG. 62B, searches for the external terminals 552 and 553 located around the mobile terminal 100 among external terminals corresponding to contacts registered in a contact list and displays items of the found external terminals 552 and 553.

At this point, without the selection of the icon 551, when the gallery function is activated, the controller 180 may recognize at least one external terminal located around the current mobile terminal 100 among external terminals registered in a contact as a sharing target and may display the items 552 and 553 of the at least one external terminal, or may recognize at least one external terminal having a history of sharing content at least once with the mobile terminal 100 among external terminals located around the current mobile terminal 100 in the same application (for example, “gallery” in FIG. 62) as a sharing target and display the items 552 and 553 of the at least one external terminal.

Then, when one of the items of the external terminals 552 and 553 is selected, an external terminal corresponding to the selected item requests to activate the first communication mode and then, when the external terminal activates the first communication mode, the image 550 is transmitted to the external terminal through the first communication mode.

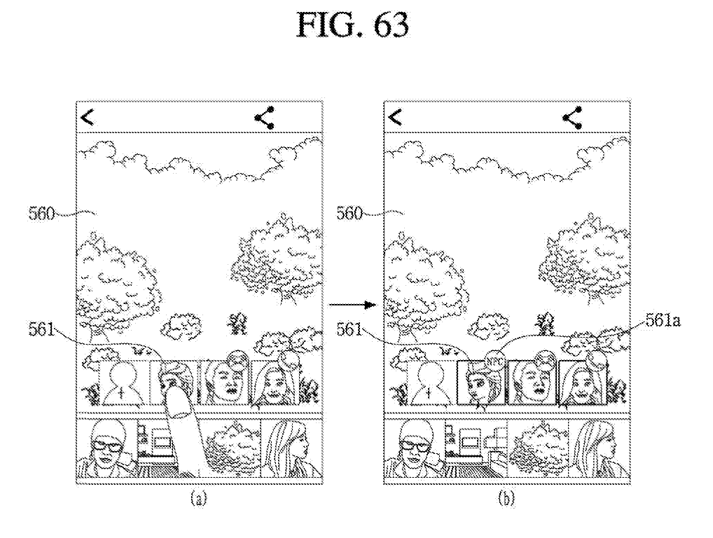

Then, as shown in FIG. 63, the controller 180 may transmit a specific image displayed in a gallery screen to at least one external terminal through NFC.

As shown in FIG. 63A, the controller 180 displays specific content 560, and searches for at least one external terminal located around the mobile terminal 100 among external terminals corresponding to contacts registered in a contact list and displays the found external terminals.

At this point, when one 561 is selected from items of the external terminals, the controller 180 activates an NFC module in the short range communication module 114 and requests an external terminal corresponding to the selected item 561 to activate the NFC module, and when the external terminal activates the NFC module, as shown in FIG. 63B, displays information 561A representing the NFC module is activated on the item 561 and transmits the content 560 to the NFC module of the external terminal through the NFC module.

In more detail, the controller 180 transmits BLE signals including a syntax for requesting the activation of the NFC module of the external terminal to the external terminal and when BLE signals including a syntax for notifying the activation of the NFC module of the external terminal is received from the external terminal and it is detected that an NFC module between the mobile terminal 100 and the external terminal is tagged within a ultra short distance, transmits the image 560 to the NFC module of the external terminal through the NFC module.

On the other hand, without the selection operation of the external terminal, when BLE signals including a syntax for notifying the activation of the NFC module of a specific external terminal is received from the specific external terminal where the NFC module is activated among the external terminals, the controller 180 activates the NFC module in the short range communication module 114 and when it is detected that an NFC module between the mobile terminal 100 and the external terminal is tagged within a ultra short distance (for example, within 10 cm), transmits the image 560 that is content displayed on the current screen to the NFC module of the external terminal through the NFC module.

At this point, when the content is received by the external terminal through the NFC module, the controller 180 may perform a control to allow the external terminal to output or execute the received content on a screen immediately.

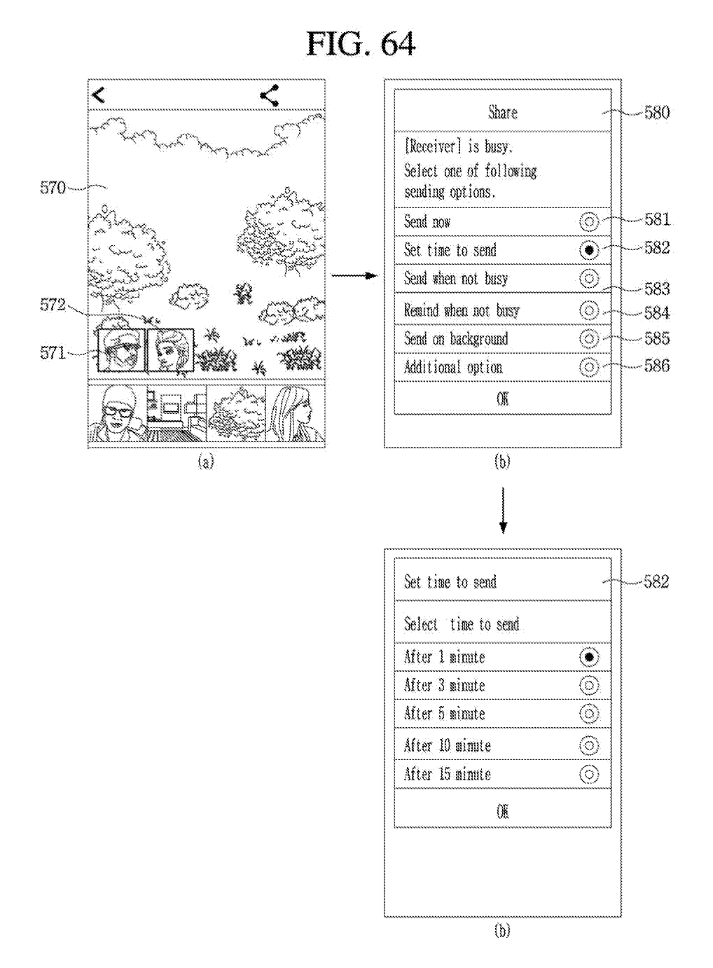

Then, as shown in FIG. 64, the controller 180 may determine a transmission method of content in consideration of the current operating state of the external terminal.

As shown in FIG. 64A, when specific content 570 is displayed and an item of a specific external terminal 571 is selected, the controller 180 transmits to, the external terminal 571, BLE signals including a syntax for inquiring the current operating state of the external terminal 571 and when BLE signals including a syntax for notifying that no task is performed currently, that is, a standby mode, are received from the external terminal, transmits the content 570 to the external terminal through the WiFi Direct communication mode.

In the description below, a state where the external terminal 571 performs a specific task when the mobile terminal 100 transmits content to be shared to the external terminal 571 is referred to as a busy mode and described.

As shown in FIG. 64B, when the external terminal 571 is in a busy mode, the controller 180 may perform a control to display a menu 580 for setting the content transmission method and allow the external terminal 571 to receive the content through a transmission method set through the menu 580.

In more detail, the menu 580 includes first to sixth sub menus 581, 582, 583, 584, 585, and 586.

That is, when the first sub menu 580 is selected, the controller 180 performs a control to allow the external terminal 571 to receive the content 570 regardless of whether the current tack of the external terminal 571 is performed.

Additionally, when the second sub menu 582 is selected, as shown in FIG. 64C, the controller 180 performs a control to display a setting window for setting a specific time after the current time and allow the external terminal 571 to receive the content 570 at the time of setting through the setting window. At this point, the controller 180 may display the set time on the item of the external terminal 571 of the screen and display an item for counting the set time.

Additionally, when the third sub menu 583 is selected, the controller 180 performs a control to allow the external terminal 571 to receive the content 570 after a task being performed by the external terminal 571 is terminated.

In more detail, when the third sub menu 583 is selected, the controller 180 may perform a control to transmit to, the external terminal 571, BLE signals including a syntax for requesting expected termination time information of a task in execution currently, and receive BLE signals including the expected termination time information of the task from the external terminal 571, and allow the external terminal 571 to receive the content 570 after the task is terminated based on the received expected termination time information.

Then, when the fourth sub menu 584 is selected, the controller performs a control to hold the transmission of the content before BLE signals including a syntax for notifying the termination of a task being currently performed by the external terminal 571 are received from the external terminal 571 and when the BLE signals are received, allow the external terminal 571 to receive the content 570.

Then, when the fifth sub menu 585 is selected, the controller 180 transmits the content 570 to the external terminal 571 as background without any notification to a user.

Then, when the sixth sub menu 586, as an additional option menu, is a menu for allowing the external terminal 571 to receive the content 570 when the external terminal is busy or in a sleep mode.

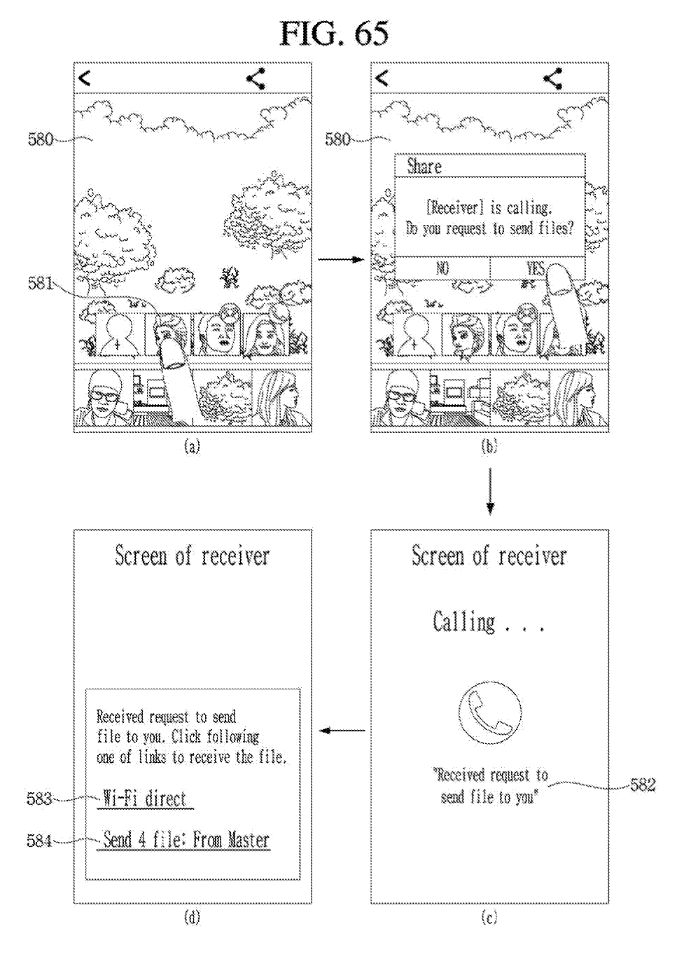

That is, as shown in FIG. 65A, when specific content 580 is displayed and an item of a specific external terminal 581 is selected, the controller 180 transmits BLE signals including a syntax for inquiring the current operating state of the external terminal 581 to the selected external terminal 581.

Then, when BLE signals including a syntax for notifying “currently busy” are received from the external terminal 581, as shown in FIG. 65B, the controller 180 notifies a user that the external terminal 581 is currently busy and displays a first inquiry window for inquiring the external terminal 581 whether to receive the content 580 during the call, and when whether to receive the content 580 is set through the first inquiry window, as shown in FIG. 65C, transmits BLE signals including a syntax for outputting a sound 582 that notifies the reception request of the content 580 to the external terminal 581 in order to allow the external terminal 581 to output the sound 582 during the call.

Then, as shown in FIG. 65D, when BLE signals including a syntax for notifying that the current call is terminated are received from the external terminal 581, the controller 180 transmits BLE signals including a syntax for providing a command to display a second inquiry window for inquiring whether to receive the content to the external terminal 581 to allow the external terminal 581 to display the second inquiry window.

At this point, when a user of the external terminal 581 selects a first link 583 included in the second inquiry window, the current communication mode is changed into the first communication mode and BLE signals including a syntax for requesting the transmission of the content 580 are transmitted to the mobile terminal 100 through the first communication mode, and when the BLE signals are received, the mobile terminal 100 changes the current communication mode into the first communication mode and transmits the content 580 to the external terminal 581 through the first communication mode.

Additionally, when a user of the external terminal 581 selects a second link 584 included in the second inquiry window, as the second communication mode, the content 580 that the mobile terminal 100 uploads into a remote server previously is downloaded through the download URL address of the content 580 included in the second link 584.

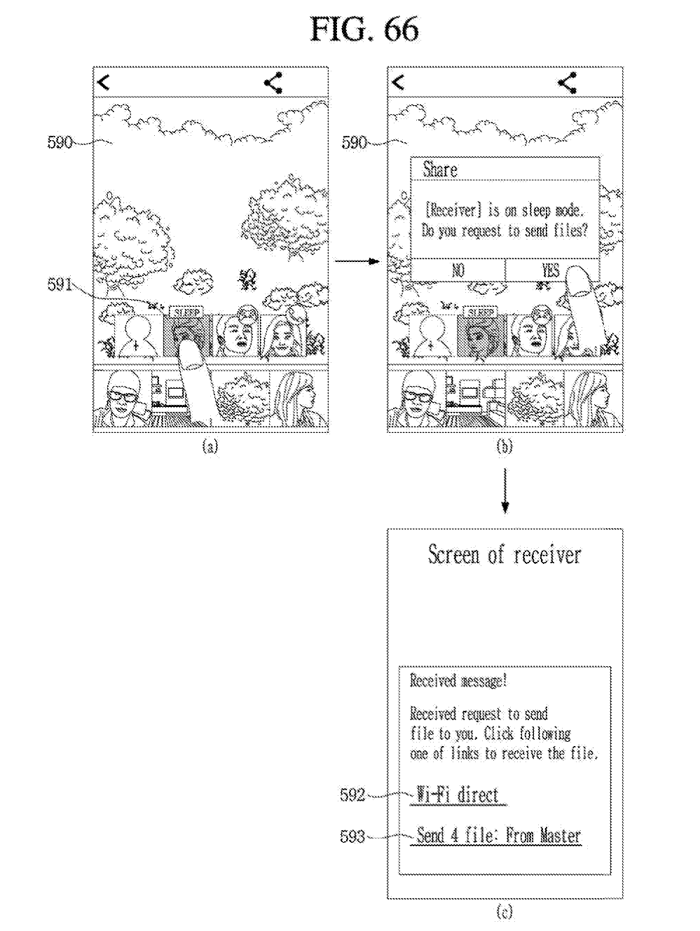

Then, as shown in FIG. 66A, when specific content 590 is displayed and an item of a specific external terminal 591 is selected, the controller 180 transmits BLE signals including a syntax for inquiring the current operating state of the external terminal 591 to the selected external terminal 591.

Then, when BLE signals including a syntax for notifying the current sleep mode are received from the external terminal 591, the controller 180 displays information representing that the external terminal 591 is in a sleep mode on the item of the external terminal 591 and as shown in FIG. 66B, displays a first inquiry window for inquiring whether the content 590 is received by the external terminal 591 during the sleep mode.

Then, as shown in FIG. 65D, when the inquiry on whether to receive the content 590 is set through the first inquiry window, as shown in FIG. 66C, the controller 180 transmits BLE signals including a syntax for providing a command to display a second inquiry window for inquiring whether to receive the content 590 to the external terminal 591 in order to allow the external terminal 591 to display the second inquiry window.

At this point, when a user of the external terminal 581 selects a first link 592 included in the second inquiry window, the current communication mode is changed into the first communication mode and BLE signals including a syntax for requesting the transmission of the content 590 are transmitted to the mobile terminal 100 through the first communication mode, and when the BLE signals are received, the mobile terminal 100 changes the current communication mode into the first communication mode and transmits the content 590 to the external terminal 581 through the first communication mode.

That is, the external terminal 591 is in a state where the screen is turned off in a sleep mode state, and in this instance, when the external terminal 591 receives the content 590, the controller 180 may perform a control to turn on the screen.

Additionally, when a user of the external terminal 591 selects a second link 593 included in the second inquiry window, as the second communication mode, the content 590 that the mobile terminal 100 uploads into a remote server previously is downloaded through the download URL address of the content 590 included in the second link 593.

Additionally, when the external terminal is in a sleep mode, the controller 180 may transmit the content immediately through the first communication mode without providing the first and second inquiry windows of FIG. 66.

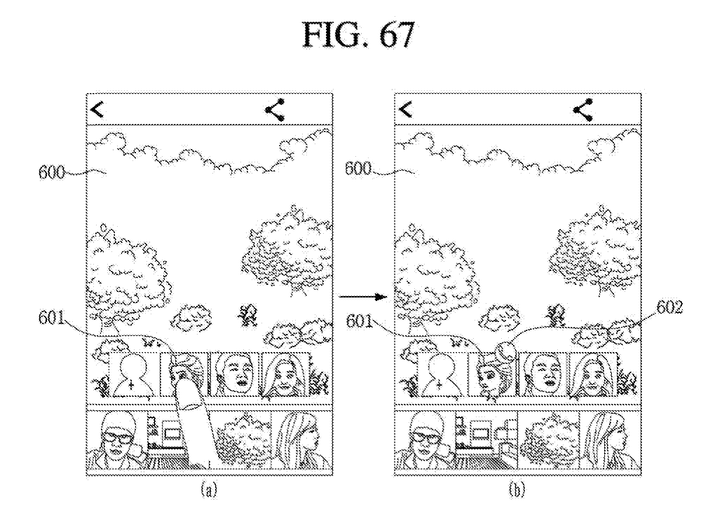

Then, as shown in FIG. 67A, when specific content 600 is displayed and an item of a specific external terminal 601 is selected, the controller 180 transmits BLE signals including a syntax for inquiring the current operating state of the external terminal 591 to the selected external terminal 601.

Then, when BLE signals including a syntax for notifying the current operating state are received from the external terminal 601, as shown in FIG. 67B, the controller 180 may display information 602 representing the current operating state of the external terminal 601 on the item of the external terminal 601.

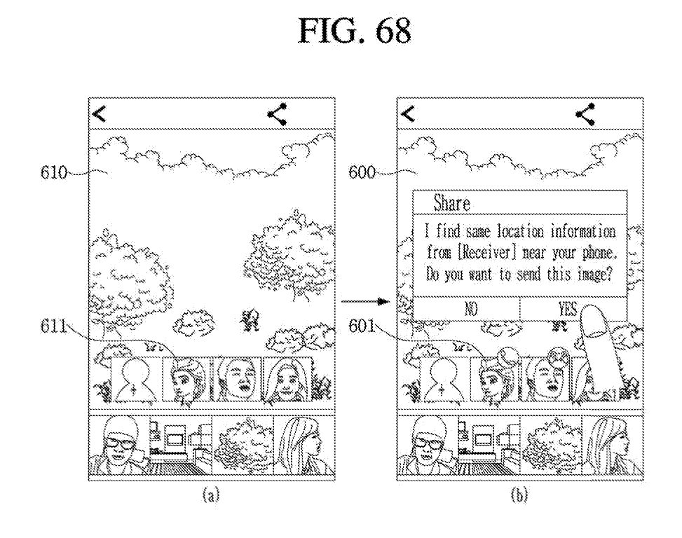

As one example, FIG. 68 illustrates that the current operating state of the external terminal is busy and a call icon 602 representing “busy” is displayed on the item of the external terminal 601.

Additionally, when an operating state of the external terminal is a state where the screen of the external terminal is turned on but no operation is performed, as shown in FIG. 66, the controller 180 may transmit the content immediately through the first communication mode without providing the first and second inquiry windows.

That is, when BLE signals including a syntax for notifying that the current screen is turned on but no operation is performed are received from the external terminal, the controller 180 transmits the content to the external terminal immediately through the first communication mode.

Additionally, if the operating state of the external terminal is a state where the screen is turned off but a specific task is performed in background, the controller 180 may display a first transmission menu for transmitting the content immediately and a second transmission menu for transmitting the content after the operation of the external terminal is completed. That is, when BLE signals including a syntax for notifying that the current screen is turned on but a specific task is performed currently are received from the external terminal, the controller 180 displays the first and second transmission menus.

At this point, the specific task may include at least one task of the update or download for at least one of a specific application and widget, the playback of specific media (including at least one of video, picture, sound, music, and broadcast), and the execution of specific content.

Then, when the first transmission menu is selected, the controller 180 may transmit the content to the external terminal immediately through the first communication mode regardless of whether the specific task is completed. On the other hand, when the second transmission menu is selected, after BLE signals including a syntax for notifying that the specific task is completed are received from the external terminal, the controller 180 may transmit the content to the external terminal through the first communication mode. At this point, when the external terminal completes the specific task based on the BLE signals, the controller 180 may perform a control to output vibration or sound notifying that the specific task is completed.

Additionally, when an operating state of the external terminal is a state where the screen is turned off and a specific task is being performed currently, the controller 180 may vary the transmission point of the content according to a specific task being performed in the external terminal.

As one example, if it is detected through the BLE signals that the external terminal is in an operating state for displaying the playback screen of media (including at least one of videos, pictures, sound, music, broadcast, and e-book) or in an operating state for writing text message, since this is a situation where a user of the external terminal wants to continuously use the media playback screen or the text message writing screen without interference, the controller 180 may transmit the content to the external terminal through the first communication mode as the external terminal detects through the BLE signals that the media playback or the text message writing is completed. Of course, the controller may display a first transmission menu for transmitting the content immediately and a second transmission menu for transmitting the content after the media playback or text message writing of the external terminal is completed, and may transmit the content immediately through the first communication mode or transmit the content after the media playback or text message writing of the external terminal is completed, according to a selection of the first and second transmission menus.

As another example, when it is detected through the BLE signals that the current screen is turned on and a task that could be paused or held temporarily is being performed, for example, a chatting task such as SNS, the controller 180 may transmit the content to the external terminal immediately through the first communication mode regardless of whether a task being performed currently is completed. Of course, the controller may display a first transmission menu for transmitting the content immediately and a second transmission menu for transmitting the content after a task being performed currently is completed, and may transmit the content immediately through the first communication mode or transmit the content after the task being performed currently in the external terminal is completed, according to a selection of the first and second transmission menus.

Then, as shown in FIG. 68A, while a specific content 610 is displayed and items of two or more external terminals for sharing the content 610 are displayed, as shown in FIG. 68B, if at least one external terminal close to a place relating to the content 610 among the two or more external terminals is detected, the controller 180 may transmit the content 610 to the detected external terminal.

As one example, when the content 610 is an image where location information is registered in meta information, the controller 180 transmits BLE signals including a syntax for requesting the location of the external terminals to each of the external terminals, receives BLE signals including the location information of each of the external terminals from the external terminals, and transmits the image to at least one external terminal disposed at a location identical or close to the location of the image based on the location information of each of the external terminals.

As another example, when the content 610 is a preview image that is currently received through the camera 121 and displayed, the controller 180 recognizes the location of the current mobile terminal through the location information module 115, transmits BLE signals including a syntax for requesting the location of the external terminals to each of the external terminals, receives BLE signals including the location information of each of the external terminals from the external terminals, and transmits the preview image in real time, or captures and transmits the preview image to at least one external terminal disposed at a location identical or close to the location of the current mobile terminal 100 based on the location information of each of the external terminals.

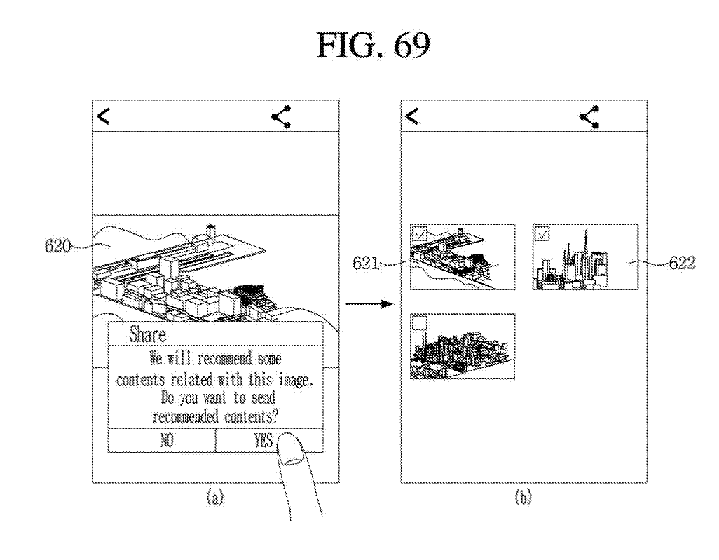

Then, as shown in FIG. 69A, after transmitting specific content 620 to at least one external terminal, the controller 180 may search for at least one content 621, 622, and 623 relating to the transmitted specific content 620 in the mobile terminal 100, and as shown in FIG. 69B, by displaying the at least one found content 621, 622, and 623, may recommend the at least one found content 621, 622, and 623 as content to be shared with the external terminal.

As one example, the content 620 includes an image and as at least one content 621, 622, and 623 relating to the specific content 620, the controller 180 may search for contents identical or relating to at least one of a date, a time, and a place at which the specific content 620 is created among contents provided to the mobile terminal 100, and may recommend the found contents as contents to be shared with the external terminal.

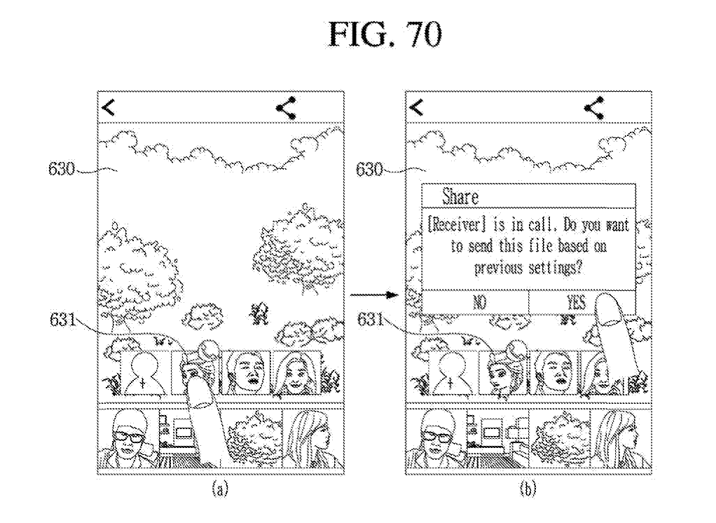

Then, as shown in FIG. 70A, when specific content 630 is displayed and an item of the specific external terminal 631 is selected and there is a history of transmitting content to the external terminal 631 previously and an operating state of the current external terminal 631 is identical to an operating state at the time of the transmitting of the content previously, as shown in FIG. 70B, the controller 180 may transmit the content 630 to the external terminal 631 in the same manner as the transmission method (described with FIG. 64) at the time of the transmitting of the content previously.

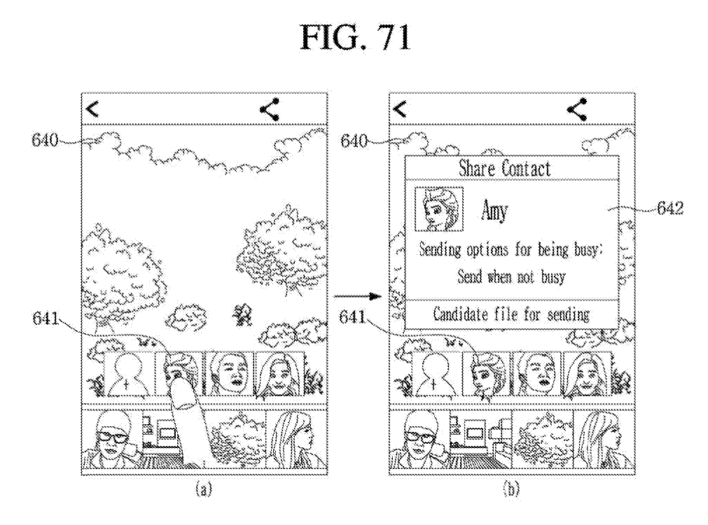

Then, as shown in FIG. 71A, when specific content 640 is displayed and an item of a specific external terminal 641 is selected and a transmission method (for example, the transmission method of FIG. 64) of content to be shared for the external terminal 641 is set, as shown in FIG. 71B, the controller 180 displays detailed information 642 representing a transmission method set in the external terminal 641.

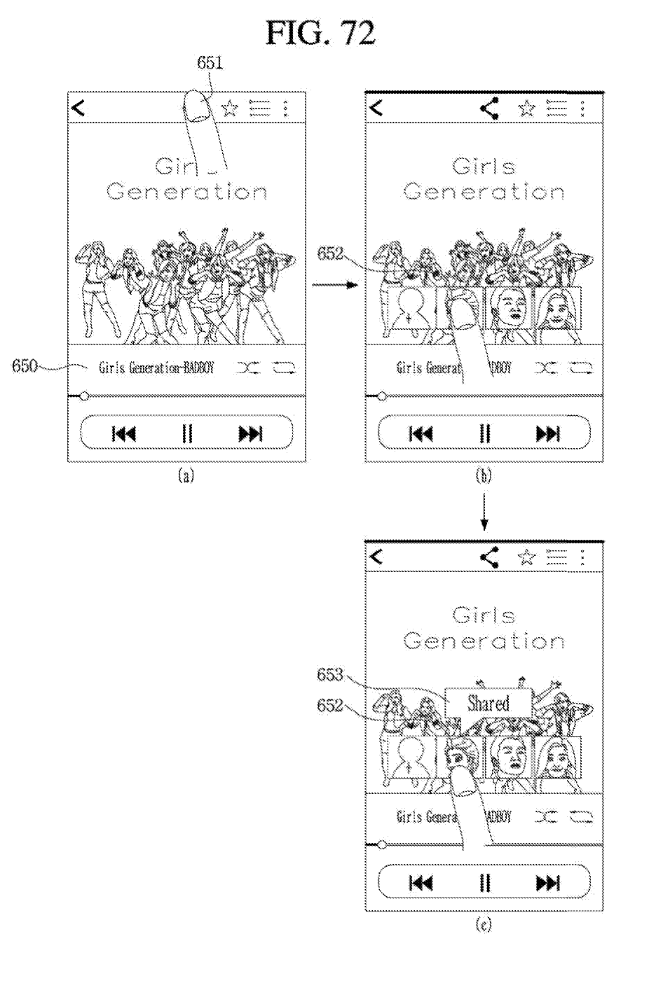

Then, as shown in FIGS. 72 to 74, the controller 180 may share media in playback currently with at least one external terminal or may request the sharing of media being played in the external terminal currently from the external terminal.

At this point, the media may include at least one of video, broadcast, sound, and music and may include e-book, document, and webpage in some cases.

First, as shown in FIG. 72A, if a media playback application is activated and a sharing mode activation icon 651 is selected during the playing of specific content 650 through the media playback application, the controller 180 activates a sharing mode, and as shown in FIG. 72B, searches for at least one external terminal located around the mobile terminal 100 among external terminals corresponding to contacts registered in a contact list and displays items of the found external terminals.

At this point, without the selection of the icon 651, when the media playback application is activated, the controller 180 may recognize at least one external terminal located around the current mobile terminal 100 among external terminals registered in a contact as a sharing target and may display an item of the at least one external terminal, or may recognize at least one external terminal having a history of sharing media at least once with the mobile terminal 100 among external terminals located around the current mobile terminal 100 in the same application (for example, “media playback application” in FIG. 72) as a sharing target and display the item of the at least one external terminal.

Then, when one 652 of the items of the external terminals is selected, a request is made to allow an external terminal corresponding to the selected item 652 to activate the first communication mode and then, when the external terminal activates the first communication mode, the media in playback is transmitted in a streaming form to the external terminal in real time and it is controlled to allow the external terminal to play the received media in real time.

At this point, as information of the media playback application and the media are transmitted together to the external terminal, the controller 180 may perform a control to activate the same media playback application as the mobile terminal 100 and play the received media in real time through the activated media playback application.

Additionally, when the external terminal activates the first communication mode, the controller 180 may transmit the file itself of the media in playback to the external terminal.

Then, when BLE signals including a syntax for notifying that the media is being played are received from the external terminal, as shown in FIG. 72C, the controller 180 may display information 653 representing that the media 650 being played in the mobile terminal 100 is being shared with the external terminal, on the item 652 representing the external terminal.

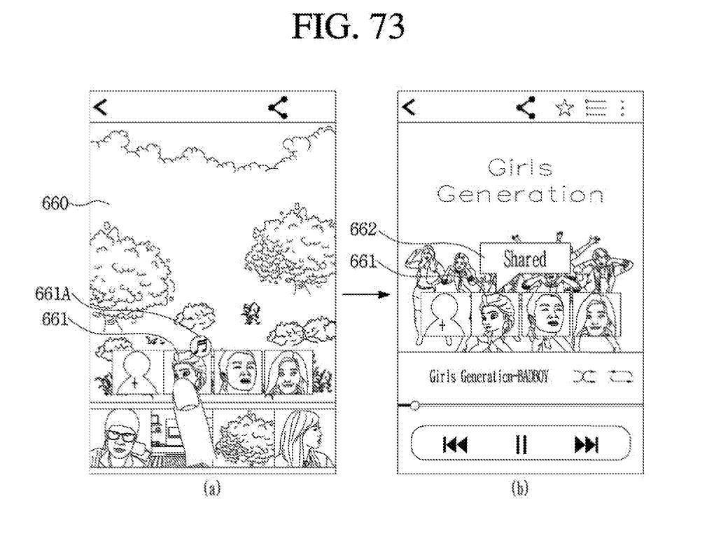

Then, as shown in FIG. 73A, as one example, while specific content 660 is displayed and an item representing at least one external terminal located around the mobile terminal 100 is displayed, if BLE signals including a syntax for notifying that specific media is being played are received from a specific external terminal, the controller 180 displays information 661A representing that the external terminal is playing media, on the item 661 representing the external terminal. As one example, FIG. 73A represents a state where the external terminal is playing specific music.

Then, when the item 661 is selected, the controller 180 transmits BLE signals including a syntax for requesting the sharing of media being played in the external terminal to the external terminal and activates the first communication mode.

Then, when media being played in the external terminal is received in a streaming form from the external terminal through the first communication mode, the controller 180 outputs the received media in real time.

At this point, when information of a media playback application used for playing the current media in the external terminal and the media are received together, the controller 180 activates the same media playback application as the external terminal based on the information of the received media playback application, and outputs the received media in real time through the activated media playback application.

Then, as shown in FIG. 73B, when playing the received media, the controller 180 may display information 662 representing that media in playback currently is shared in the external terminal, on the item 661 representing the external terminal.

Additionally, when a process for searching for external terminals located around is omitted and the media is being played through the media playback application, if the sharing mode activation icon 651 is selected and it is detected that the mobile terminal 100 is tagged with at least one another external terminal at a ultra close location or they are in contact, the controller 180 connects ultra short range communication with the other external terminal and provides a request to allow the other external terminal to activate the first communication mode, and when the other external terminals activates the first communication mode, performs a control to transmit the media in playback in a streaming form to the other external terminal in real time and allow the other external terminal to play the received media in real time.

As one example, the controller 180 detects whether the mobile terminal 100 is tagged with at least one another external terminal at a ultra close location or they are in contact through the NFC module, and when it is detected that the mobile terminal 100 is tagged with at least one another external terminal at a ultra close location or they are in contact, provides a request to allow the other external terminal to activate the first communication mode through the NFC module.

At this point, as information of the media playback application and the media are transmitted together to the external terminal, if the same media playback application as that of the mobile terminal 100 is activated as the external terminal refers to the information of the received media playback application, the controller may perform a control to play the received media in real time through the activated media playback application in the same state as a media playback environment of the mobile terminal 100, and if the external terminal is in a state where the same media playback application as that of the mobile terminal 100 is not activated, may perform a control to activate the same media playback application as that of the mobile terminal 100 to play the received media in real time. Additionally, when the external terminal activates the first communication mode, the controller 180 may transmit the file itself of the media in playback to the external terminal.

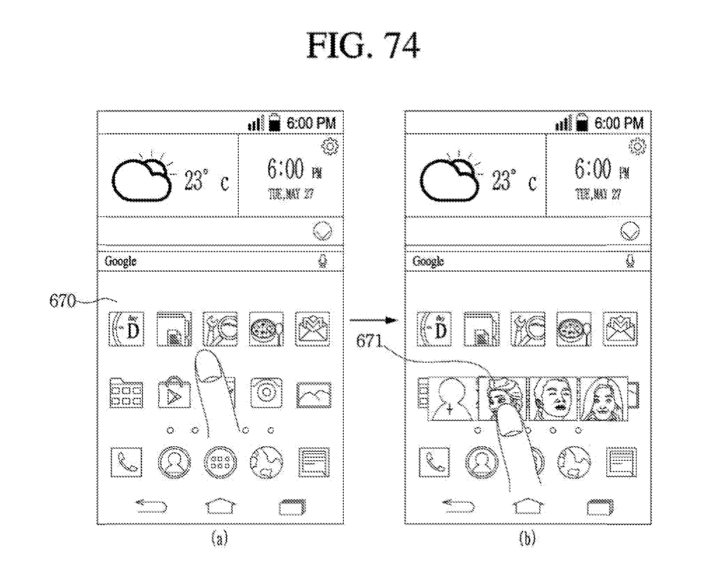

Lastly, as shown in FIG. 74A, when a predetermined touch gesture is input on a screen 670 in any operating mode, as shown in FIG. 74B, the controller 180 displays items representing at least one external terminal located around the mobile terminal 100 and when a specific item 671 is selected from the items, as shown in the operations of FIGS. 72 and 73, may share media in playback currently with a corresponding external terminal or may request the sharing of media being played in an external terminal corresponding to the item 671 from the external terminal.

As one example, referring to FIG. 74, the screen 670 in any operating mode is a home screen and the predetermined touch gesture is a double touch for touching the screen 670 two times continuously.

In such a way, according to an embodiment of the present invention, a user may easily connect the mobile terminal 100 to an external terminal through a wireless communication method by using the control center 210.

Additionally, according to an embodiment of the present invention, a state of a plurality of external terminals connected to a mobile terminal through a wireless communication method may be easily checked or controlled through the control center 210.

Additionally, according to an embodiment of the present invention, a state of the mobile terminal 100 may be easily checked or controlled through the control center 210.

Additionally, the prevent invention provides a mobile terminal configured to connect one external terminal and another external terminal by using the mobile terminal through a wireless communication method.

Additionally, the present invention provides a mobile terminal and a control method thereof configured to easily set a function of the mobile terminal and an external terminal in order to allow one function of the mobile terminal to be executed in the external terminal.

Additionally, according to an embodiment of the present invention, it is possible to easily select and set an external terminal for vicariously performing a function performed by the mobile terminal through the control center; a user easily selects content stored in an external terminal connected to the mobile terminal 100 and store it in the mobile terminal 100; and a task performed in an external terminal connected to the mobile terminal 100 is continuously performed in the mobile terminal 100.

According to at least one embodiment of the present invention, depending on the proximity of an external terminal that is to share content, it is guided that the external terminal downloads the content at an efficient download speed.

Effects of a mobile terminal according to the present invention are described as follows.

According to at least one of the embodiments of the present invention, a mobile terminal and an external terminal are easily connected to each other through a wireless communication method by using a control center.

Additionally, according to at least one of the embodiment of the present invention, a state of a plurality of external terminals connected to a mobile terminal through a wireless communication method may be easily checked or controlled through the control center.

Additionally, the prevent invention provides a mobile terminal configured to connect one external terminal and another external terminal by using the mobile terminal through a wireless communication method.

Additionally, the present invention provides a mobile terminal and a control method thereof configured to easily set a function of the mobile terminal and an external terminal in order to allow one function of the mobile terminal to be executed in the external terminal.

According to at least one embodiment of the present invention, depending on the proximity of an external terminal that is to share content, it is guided that the external terminal downloads the content at an efficient download speed.

The invention can also be embodied as computer readable codes on a computer readable recording medium. The computer readable recording medium is any data storage device that can store data which can be thereafter read by a computer system. Examples of the computer readable recording medium include magnetic storage media (e.g., ROM, floppy disks, hard disks, etc.) and optical recording media (e.g., CD-ROMs, or DVDs) and carrier waves (e.g., transmission through the Internet). Additionally, the computer may include the controller 180 of a terminal. Accordingly, the detailed description is not construed as being limited in all aspects and should be considered as illustrative. The scope of the invention should be determined by reasonable interpretation of the appended claims, and all modifications within equivalent ranges of the present invention are included in the scope of the present invention.

What is claimed is:

1. A mobile terminal comprising:
a display unit;
a wireless communication unit; and
a controller configured:
to display a my device object corresponding to the mobile terminal, at least one first external device object corresponding to at least one first external device, and at least one connectable second external device object corresponding to at least one second external device, the at least one first external device connected to the mobile terminal through the wireless communication unit and the at least one second external device connectable to the mobile terminal through the wireless communication unit,
to display a line indicating that wireless communication is connected between the my device object and the first external device object when the mobile terminal and the first external device are connected to each other through wireless communication, and
to perform a control to allow a line connected between the my device object and the first external device object to be drawn and cut off and then disappear when a drag touch is input in a specific direction and to perform a control to disconnect wireless communication between the mobile terminal and the external device.

2. The mobile terminal of claim 1, wherein the specific direction is a direction crossing the line between the my device object and the first external device object.

3. The mobile terminal of claim 1, wherein the specific direction is a direction going apart from the first external device object on the first external device object.

4. The mobile terminal of claim 1, wherein when a drag touch is input between the first external device object and the second external device object, the controller transmits a control command to the first external device to allow the second external device to be connected to the first external device through wireless communication.

5. The mobile terminal of claim 1, wherein when the first external device and the second external device are connected to each other through wireless communication, the controller performs a control to disconnect a wireless communication connection with the first external device.

6. The mobile terminal of claim 5, wherein when a wireless communication connection between the mobile terminal and the first external device is disconnected, the controller performs a control not to display the line connected between the mobile terminal and the first external device

7. The mobile terminal of claim 1, wherein the controller performs a control to display the my device object, the first external device object, and the second external device object on a control center.

8. The mobile terminal of claim 7, wherein when a pinch-in touch is input to the control center, the controller performs a control to reduce and display the first external device object and the second external device object based on the my device object.

9. The mobile terminal of claim 8, wherein the controller performs a control to display an image corresponding to the first external device on the first external device object, and classify the second external device object according properties including whether search is possible or whether there is a connection history and display a total number of the second external device object in number, or display the second external device object as a dot or a circle.

10. The mobile terminal of claim 1, wherein the controller performs a control to display the first and second external device objects on a concentric circle and display the my device object in a concentric circle.

11. The mobile terminal of claim 10, wherein the first and second objects are arranged not to overlap each other in a center direction of the concentric circle.

12. The mobile terminal of claim 10, wherein the first and second objects are arranged one at a time within a specific angle range based on a center of the concentric circle.

13. The mobile terminal of claim 1, wherein when one of at least one function of the mobile terminal is transferred to an external device connected to the mobile terminal through wireless communication, the controller performs a control to display a function display corresponding to the function on an external device object corresponding to an external device connected to the mobile terminal through wireless communication.

14. The mobile terminal of claim 13, wherein the controller performs a control to display a transferable function display corresponding to a transferable function on the my device object, and when a drag touch is input to an external device object connected to the mobile terminal through wireless communication on the transferable function display, performs a control to move a transferable function display displayed on the my device object to an external device object connected to the mobile terminal through wireless communication to be displayed.

15. A mobile terminal comprising:
a display unit;
a wireless communication unit; and
a controller configured:
to display a control center including a search area,
when a touch gesture for the search area is input, to display a my device object and at least one external device object available for a wireless communication connection through the wireless communication unit, and
when a drag gesture is input from a specific external device object among the at least one external device object to the my device object, to connect the mobile terminal and the specific external object through wireless communication and display a line connecting the my device object and the specific external device object.

16. The mobile terminal of claim 15, wherein the controller performs a control to allow the at least one external device object to be disposed on concentric circles having different diameters based on the my device object.

17. The mobile terminal of claim 15, wherein when a gesture for shaking the mobile terminal is input, the controller re-searches for an external device located around the mobile terminal and rearranges the re-searched external terminals on the concentric circles.

18. The mobile terminal of claim 15, wherein the controller re-searches for an external device located around the mobile terminal in response to an execution of the control center and rearranges the re-searched external device on the concentric circles.

19. The mobile terminal of claim 15, wherein the controller arranges an external device object corresponding to an external device having a high priority to be closer to the my device object than an external device object corresponding to an external device having a low priority.

20. The mobile terminal of claim 19, wherein the priority becomes higher in the order of an external device having no history of being connected through wireless communication in the past, an external device having a history of being connected through wireless communication in the past but not found currently and found later, an external device having a history of being connected through wireless communication in the past and currently found but not connected currently through wireless communication, and an external device currently connected through wireless communication.
